(19) United States
(12) Patent Application Publication
(10) Pub. No.: US 2026/0239522 A1
(43) Pub. Date: Aug. 13, 2026

(54) DIELECTRIC BARRIER DISCHARGE DEVICE

(71) Applicant: Daphne Technology SA, Ecublens (CH)

(72) Inventors: William Jamieson Ramsay, Ecublens (CH); Juan Mario Michan, Ecublens (CH); Anders Olsson, Ecublens (CH); Seyedehbehnaz Varandili, Ecublens (CH); Anastasios Charitopoulos, Ecublens (CH)

(73) Assignee: Daphne Technology SA, Ecublens (CH)

(21) Appl. No.: 19/154,676

(22) PCT Filed: Feb. 7, 2024
(86) PCT No.: PCT/EP2024/053023

§ 371 Date: Aug. 7, 2025

(30) Foreign Application Priority Data
Feb. 8, 2023 (EP) 23386010.5

(51) Int. Cl. H05H 1/24

(52) U.S. Cl. CPC H05H 1/2431; H05H 2245/10

(57) ABSTRACT

There is provided a dielectric barrier discharge (DBD) device for removing constituents of a gas. The DBD device comprises a first electrode and a second electrode with a dielectric barrier therebetween, an electric field being establishable between the first and second electrodes in use; and a gas flow path passing between the first and second electrodes, at least one of the electrodes having one or more discharge nodes positioned along the gas flow path. Each location along the gas flow path at which at least one discharge node is positioned is an ionisation region and has an adjacent recombination region downstream of the respective ionisation region.

### FIELD OF THE INVENTION

The present disclosure relates to devices and methods for reduction of the quantity of constituents in a gas using dielectric barrier discharge. Typically this is achieved by managing temperature and/or ionisation parameters.

### BACKGROUND

There is increasing concern regarding pollutant emissions from the use of fossil fuels and other processes, which contribute to poor air quality, environmental damage, and harm to human health. This has caused increased focus on air quality and emissions regulations and a need to provide means to eliminate or reduce the concentration of pollutant emissions into the atmosphere.

Hydrocarbons represent one pollutant where it is desirable to minimise or eliminate release into the atmosphere. In particular, there is a desire to minimise methane (CH4, CH₄) emissions because methane is a potent greenhouse gas and, as such, is of concern due to its contribution to rising global temperatures.

Liquefied natural gas (LNG), which has methane as its main component, has attracted attention as an alternative fuel to petroleum and light oil and has been used as a fuel to power engines, for example, on ships. From an air quality perspective, LNG fuel has many advantages compared to traditional (marine) fuels. The emissions of sulphur dioxide (SO2, SO₂) are low due to low or non-existing sulphur content of the gas. The low sulphur content and the absence of fuel aromatics also contribute to low particulate formation levels. Further, the most widely used marine LNG engines have significantly less emissions of nitrogen oxides (NOx, NOₓ) than traditional marine diesel engines.

The use of LNG as a marine fuel has increased significantly since the start of the 21st century. However, many LNG engines that are produced today have problems with unburned methane passing through the engine and being emitted with exhaust gases. This is called “methane slip”. As such, due to the impact of methane slip on the environment, climate, and human health, removing methane from LNG engine exhaust upstream of release into the atmosphere is desirable.

There is on-going development by engine manufacturers to reduce methane slip from LNG engines. This has been moderately successful, but there appears to be a limit for slip reduction by engine design measures. Thus, other post-engine methods are needed to eliminate methane slip.

Typically, hydrocarbons (including methane) are removed from gas using catalysts such as platinum, palladium, or rhodium at high temperatures or by adsorption methods. Methane is a relatively stable molecule, so typically requires temperatures of at least 400 degrees Celsius (C) over a precious metal-based catalyst to oxidise. There are means for the removal of methane from exhaust gases at temperatures under 400° C. using catalysts with high loadings of platinum and palladium. However, palladium-based catalysts are sensitive to SO2 and deactivate at very low concentrations of SO2 in an exhaust stream. High concentrations of CO2 and H2O in exhaust gases also limit activity of (methane) oxidation catalysts. There, therefore, remains a need for methane slip removal processes that circumvents limitations of precious metal-based catalyst materials.

A catalyst-free technology used for treatment of flue emissions from fossil fuel burning facilities (such as power stations) and municipal solid waste burning incinerators is electron beam flue gas treatment (EBFGT). EBFGT removes sulphur oxides (SOx, SOₓ) and NOx from stack gases (i.e. gases passing through an exhaust stack) at a low energy cost. This is achieved by conversion with ammonia (NH3, NH₃) to non-noxious ammonium sulphate-nitrate, which is usable as an agricultural fertilizer. This technique involves humidified flue gases passing through an electron beam reactor where high-energy electrons bombard nitrogen, water and oxygen to create strong reagents that react with the sulphur oxides and nitrogen oxides to form sulphuric and nitric acids.

In EBFGT, the electron beam reactor is formed by a bank of electron beam accelerators, specifically double-grid tetrode electrode guns in which the cathode housing is located in a vacuum housing. Free electrons are produced in an ultra-clean environment (referred to as ultra-high vacuum) where the pressure is around 12 orders of magnitude lower than atmospheric pressure. The electrons are then accelerated and sent through an aluminium or titanium membrane that separates the ultra-high vacuum environment from the flue stack were the pollutant gases are flowing. The electrons that get through the aluminium membrane collide with the gas molecules and start a chemical chain reaction that removes the pollutants.

Implementations of such EBFGT systems require very large capital costs due to the electron accelerator installation. The electron accelerators also require frequent maintenance and extreme safety requirements, which is undesirable or not possible in the location in which the reactor is installed. Further, multiple accelerators must be implemented for redundancy purposes. The need for the ultra-high vacuum adds expense and can contribute to accelerator failures. Additionally, using this technology for mobile applications is undesirable because the radiation shielding needed to protect against at least X-ray emission and ionization radiation is heavy.

The use of EBFGT is therefore not a desirable replacement for catalyst-based methane slip removal. As such, a practical means for exhaust gas purification capable of favourably oxidising unburned components (such as methane) of a fuel (such as LNG) is needed.

Dielectric barrier discharge (DBD) devices are known to be usable to remove unwanted components of a gas. These typically take the form of parallel plate electrodes or coaxial cylinder or rod electrodes with a dielectric barrier located between electrodes. When an electric field is applied between the electrodes with a strength above a gas breakdown threshold, a plasma is formed by electrical discharge between the electrodes. The generation of the plasma drives reactions in the gas to remove various components.

It has been the intention to try to provide uniformly distributed discharge within a DBD device to achieve a homogeneous plasma density to allow chemical reactions to be driven throughout the volume between the electrodes. This is difficult to achieve satisfactorily due to even slight imperfections in electrodes focusing the electric field disrupting the distribution of discharge and negatively affecting the homogeneity of the plasma density. This limits the value of DBD in removing unwanted components of a gas to a suitable level of efficiency.

### SUMMARY OF INVENTION

According to a first aspect, there is provided a dielectric barrier discharge device for (i.e. suitable for) removing constituents of a gas, comprising: a first electrode and a second electrode with a dielectric barrier therebetween, an electric field being establishable between the first and second electrodes in use; and a gas flow path passing between the first and second electrodes, at least one of the electrodes having one or more discharge nodes positioned along the gas flow path, each location along the gas flow path at which at least one discharge node is positioned being an ionisation region and having an adjacent recombination region downstream of the respective ionisation region.

Instead of seeking to further improve uniformity of plasma density, the DBD device according to the first aspect enhances the concentration of active species in the partially ionised gas. By enhancing the concentration of active species, the removal efficiency of constituents of a gas is increased. Accordingly, while using the same, or similar, amount of energy to a standard DBD device with a uniform electric field, a larger quantity of constituents is removed from the gas than is achievable using known DBD devices.

It is intended that, in response to the presence of the electric field between the first and second electrodes, electrical discharge is establishable between the one or more discharge nodes (and thereby at least one electrode) and the other electrode. Due to the arrangement of the first and second electrodes and dielectric barrier, this discharge may be establishable between the one or more discharge nodes (and thereby at least one electrode) and the dielectric barrier. Such discharge, also referred to as electrical discharge, typically produces electrons. Such electrons produced during electric discharge in a gas are known to interact with that gas to yield active species. These active species are commonly in the form of free radicals and ions (as well as additional electrons through electron impact ionization, excitation, and ionization of background gas molecules). These active species oxidise, reduce, or decompose constituents of a gas, including pollutant molecules, such as CH4, SOx and NOx, that may be present in the gas.

In known electric discharge devices, there is a uniform (i.e., homogeneous) volumetric distribution of electrical discharges that produce electrons with a distribution of energy typically between 1 and 10 electron Volts (eV). In contrast, the DBD device according to the first aspect is a form of “staged” dielectric barrier discharge device. This is because it provides one or more locations, in the form of the one or more discharge nodes, and therefore stages, along a length at which discharge occurs in use, and intervening locations where discharge has a lower probability of occurring.

Other forms of staged DBD devices may be provided, and, as such, at its most general, there is provided a staged DBD device. Such a staged DBD device May exclude one or more features referred to above in relation to the first aspect. This may be achieved while still providing an ability to generate discharge at one or more locations along a path gas or another fluid is able to pass in use. This would therefore provide the above advantages of the DBD device according to the first aspect.

By the term “discharge”, we intend to mean electrical discharge of some form, such as plasma-generating discharge. Typically, this means release and transmission of electricity in an applied electric field through a medium such as a gas. A flow of electrons in the form of a filament passing from one location to another or between two points typically achieves this. The flow of electrons is typically a transient flow of electrons in the form of a filament. By this, we intend to mean that the flow of electrons in a microdischarge or filament during electrical discharge lasts for only a short time per individual discharge ignition event. There may of course be many filaments over time if suitable conditions are maintained. The electrical discharge allows transmission of electricity in an applied electric field through gas.

By the use of “recombination region” it is intended to mean that there is a region in which ionisation that occurs in the ionisation region reduces. This may be due to ion recombination of ion generated in the ionisation region or plasma dissipation of plasma generated in the ionisation region. This may be achieved through reaction of the plasma or ions with itself/themselves and/or other matter present, such as with gas constituents.

The electrical discharge may be for use in removing CH4 by converting CH4 into one or more other substances. The high-energy electrons generated during the staged discharge have been found to remove CH4 from gases containing CH4. This provides an enhanced process by which CH4 is able to be removed from a gas over known techniques. The process reduces the amount of CH4 present in the gas after having been processed. The CH4 may be up to 10,000 ppmv, up to 5,000 ppmv, up to 2,500 ppmv or up to 2,000 ppmv, and may be more than 100 ppmv or 1,250 ppmv before removal commences.

Any form of electrical discharge may be suitable for removing CH4 from a gas, such as pulse, corona, electron beam, radio frequency, microwave, ultraviolet light radiation electrical discharge, brush, electric glow, electric arc, electrostatic, partial, streamer, vacuum arc, Townsend, field emission of electrons, or electric discharge in gases, leader (or spark), St. Elmo's fire or lightning. Typically however, the electrical discharge may be barrier electrical discharge. We have found that barrier electrical discharge is able to be used to reduce CH4 content in gas, and thereby allowing it to be used to reduce CH4 from air and/or point sources (such as exhaust gases). The presence of the dielectric does not allow arcs or sparks to occur (i.e. discharge that generates sustained current between the electrodes). Instead, it only allows microdischarges to occur, which typically only last for microseconds. This provides the necessary energy and components to contribute to the chemical reaction pathway by which CH4 is able to be broken down while limiting the amount of power needed to provide sustained discharge.

Each discharge node may include, or may be, a recess, recess edge, edge, corner, tip, point, or textured treated portion of a respective electrode. Typically, each discharge node is at least one projection, such as a plurality of projections, from the respective electrode with (each projection having) at least a component orientated towards the other electrode. By the discharge node being (or including) a projection (or a plurality of projections) the distance between electrodes is reduced, decreasing the field strength requirements of the electric field for discharge to occur. This thereby reducing stress on electrical components, making them less likely to fail and extending their life. Further, each projection provides an asymmetry in the electric field, which encourages electric breakdown at that point. This is typically because each projection may be tapered to, or has a taper to, a point or tip.

There may be up to 12 projections, the number of projections may be a multiple of 3, and typically there may be 6 projections. When each discharge node has a plurality of projections, in addition to the above advantage of at least one projection, the plurality of projections has advantages corresponding to those set out below in relation to the second aspect.

By the phrase “towards the other electrode”, it is intended to mean that, should the first electrode has the at least one projection, the projection is orientated with a component towards the second electrode. Correspondingly, should the second electrode have the at least one projection, the projection is orientated with a component towards the first electrode.

The at least one projection may be a projection from the first electrode and/or second electrode.

There may be (only) a single discharge node. Typically however, the one or more discharge nodes is a plurality of discharge nodes positioned along the gas flow path. We have found that as the number of discharge nodes increases, the amount of removal of gas constituents increases. A limiting factor may be the length of the electrode on which the discharge nodes are located. As such, the at least one electrode may have discharge nodes positioned along a discharge length of the electrode, the discharge length being the length of the electrode over which discharge is to be established in use when the electric field strength is at or above a threshold strength.

Each recombination region may separate the respective ionisation region from a downstream ionisation region (or from an electrode end).

The distribution of discharge nodes may be even, asymmetric, symmetric, bunched/grouped or random. We have found that an even distribution (i.e. there being a consistent separation between adjacent discharge nodes) provides suitable gas constituent removal. Regardless of the distribution, typically, adjacent discharge nodes are separated from each other by a distance corresponding to at least 60% of the height of the at least one projection and/or up to 150% of the height of the at least one projection.

The separation could be at least 80% of the height of the at least one projection, or could be at least 85% of the height of the at least one projection. Further or alternatively, the separation could be up to 130% of the height of the at least one projection, up to 110% of the height of the at least one projection or up to 90%.

By height of the projection, it is intended to mean the distance from a base of the projection at the electrode to an opposing end of the projection.

We have found that by providing this separation of discharge nodes within these criteria removal of constituents of a gas is enhanced.

The first electrode and a proximal side of a dielectric barrier may be separated by a first distance. Additionally or alternatively, the second electrode may be abutting a distal side of the dielectric barrier to the first electrode.

Each projection may have a height of between 10% and 50% of the first distance. The height of each projection could be at least 11% of the first distance, at least 12% of the first distance, or at least 13% of the first distance. The height of each projection could by up to 45% of the first distance or up to 40% of the first distance.

The height of each projection affects the field strength needed to provide discharge and back pressure on gas passing along the gas flow path. We have found that each projection having a height in the stated ranges provides an optimum balance between field strength and back pressure along the gas flow path protecting the electronics by limiting stress applied to them and minimising the number of devices needed to remove constituents from a quantity of gas.

Each discharge node may take any suitable form. Typically, each discharge node is a structure for electric field intensification for (i.e. suitable for) use in a dielectric barrier discharge device.

By the term “structure” here, we intend to mean a chosen form, such as a deliberate and/or repeatable, predetermined, or specific form. This is intended to be instead of simply a form that is not repeatable in an identical (within manufacturing tolerances) form or that only produces a random form, such as a roughened surface on which a roughness or texture is provided either naturally or by the use of, for instance, sandpaper. This means that, in some circumstances, a discharge node being a structure is a more specific form of discharge node. In some forms, a discharge node may simply be a point, area, region, feature, portion, location or element which is more preferential for the occurrence of discharge or at which discharge occurs more, more reliably/repeatably, or only occurs at relative to where there is not a discharge node. In such a form this may be natural or may have been prepared.

The structure may comprise: a ring including at least one tip, the tip extending along a first radial axis passing through the centre of the ring, wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

Independent of the first aspect, according to a second aspect, there is provided a structure for electric field intensification for (i.e. suitable for) use in a dielectric barrier discharge device, the structure comprising: a ring including at least one tip, the tip extending along a first radial axis passing through the centre of the ring, wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

Whether the structure for electric field intensification is provided as part of the first aspect or as a second aspect, the provided structure for electric field intensification provides various benefits in terms of increasing the rate at which a discharge device, for example, a dielectric discharge device, removes pollutants from exhaust gas. In use, the ring, and by extension, the structure is arranged around a first electrode in such a way that a gap is formed between an opposing electrode and the structure. The presence of the structure introduces asymmetry in an electric field applied between the first and opposing electrodes. This leads to a higher concentration of active species near the structure relative to a conventional discharge device. The structure, therefore, promotes oxidation of a gas passing through the discharge device in use. Specifically, the radially extending tip reduces the gap between the structure and the opposing electrode at the location of the tip. This concentrates the applied electric field at the tip. This increases the production of active species at the tip, and so gas in the vicinity of the tip is therefore more likely to be oxidised.

Further, because of the inherent geometry of the tip, that is, because the tip typically terminates in a sharp point, the tip assists in the formation of plasma streamers when a pollutant is passed through a discharge device in use.

It has been observed that in use, a discharge device including such a structure removed pollutants at a higher efficiency compared to a similar device without the structure.

All of these benefits are achieved without the need to provide any extra energy. That is, the electric field usually applied to a conventional discharge device can be applied to a staged device with a structure to provide an improved efficiency of pollutant removal.

Furthermore, the presence of a catalyst is not necessarily required to achieve an improved rate of pollutant removal. If a catalyst were to be used, this would still provide a further improvement, but a catalyst is not required. In combination with the electrical discharge, if the option of using a catalyst is implemented. This would assist with the existing ability to scrub gases such as air and flue emissions from combustion engines, e.g. in ships and other vehicles, power plants and incinerators.

In a further optional example, the electric field intensifying structure further comprises a channel extending from the centre of the ring to the exterior of the ring along a second radial axis, wherein the second radial axis is not aligned with the first radial axis.

A width of the channel may be 1 millimetre (mm) in some optional examples.

The presence of a channel facilitates easy installation and removal of the structure around the first electrode. This effectively makes it easier to replace a structure, for example, if it becomes faulty. The width of the channel also provides room for the structure to expand and contract, for example, due to being heated up by the gas flowing through the discharge device in use. This further improves the reliability of the structure.

In some examples, the ring has a main body, and the at least one tip is connected to the main body.

In some advantageous examples, the main body may have a radial thickness of 3.6 mm.

The radial thickness of the ring increases the structural integrity of the structure. For example, the structure is less likely to be bent out of shape.

The ring having a radial thickness of 3.6 mm provides an optimum trade-off between structural strength and ensuring that the structure is not overly large.

The electric field intensifying structure of any preceding claim, wherein the at least one tip comprises two sides meeting at a point, a first angle being formed between the two sides to form the tip.

Additionally, the first angle may be 69 degrees.

This is optimal for pollutant removal, such as methane, in use. Further, this angle ensures that the tip has a minimum level of structural integrity. A tip with a first angle of at least 69 degrees is less susceptible to breaking than a sharper tip. The specified first angle may also allow the tip to be easily and repeatably manufactured with a high level of accuracy and precision.

In advantageous examples, the at least one tip of the electric field intensifying structure comprises a plurality of tips, each tip in the plurality of tips being arranged on the outer edge of the ring.

A plurality of tips may provide further improvements to the rate of pollutant removal in use. That is, a plurality of tips provides additional sites for electric breakdown of gas to occur. This means that more gas can be treated compared to if the structure has a single tip.

In some further examples, the plurality of tips may each extend along a respective radial axis not aligned with the second radial axis.

This effectively means that each of the plurality of tips extends along a different radial direction. This is intended to mean that the tips will be distributed to some extent on the outer edge of the ring. The effect of the tips is therefore less likely to overlap with each other, and therefore the tips complement each other. That is, in use, the tips each encounter a different part of the gas flowing through the discharge device.

Moreover, it is advantageous for the plurality of tips to be uniformly distributed on the outer edge of the ring in some examples.

A uniform distribution of the tips provides further improvements to the efficiency of pollutant removal in use. By requiring a plurality of uniformly distributed tips, it is ensured that each part of the gas flowing through the discharge device in use has some chance to be treated.

Note that by uniformly distributed we intend to mean that the tips are uniformly distributed around the material of the ring, rather than the full 360 degrees of the structure. For example, a channel may provide a break in the ring.

In some examples, the plurality of tips may comprise 3 tips.

In other examples, the plurality of tips may comprise 21 tips.

A particular number of tips may be effective for removing a pollutant in use.

The plurality of tips may typically comprise 6 tips in certain advantageous examples.

The plurality of tips may also consist of 6 tips (i.e. 6 tips only).

A structure with 6 tips has been found to be optimal for removal of a pollutant, such as methane, from gas flowing through the discharge device in use.

The second radial axis may bisect a second angle between two adjacent tips on either side of the channel, the first angle being measured between adjacent sides of the two tips.

The electric field intensifying structure of claim 11, wherein the second angle is 135.6 degrees.

This further specifies the construction of the structure. The channel bisects two adjacent channels and is therefore intended to be arranged in the middle of two adjacent tips. This may further increase the usefulness of the channel for easy replacement of the structure.

In some optional examples, the adjacent tips in the plurality of tips other than the two adjacent tips on either side of the channel may be separated by a third angle measured between adjacent sides of the adjacent tips preferably wherein the third angle is 127.6 degrees.

The construction of the structure is therefore further specified. The aforementioned arrangement of the plurality of tips may be especially effective for removal of pollutants such as methane in use. The specified angle between the tips may also improve structural integrity, and ensure that the tips can be repeatably manufactured to a high degree of precision.

The axial thickness of the structure may be 1 mm in certain useful examples.

The axial thickness of the structure ensures that the structural integrity of the structure is not easily compromised. A minimum axial thickness of 1 mm makes it more difficult to bend the structure out of shape.

The arrangement of the first and second electrodes may be any of a number of arrangements, such as a parallel plate arrangement with each of the first and second electrodes being plates, the plates being at least partially aligned with each other and having at least a component parallel to each other. Alternatively, the first electrode and second electrode are arranged concentrically with parallel longitudinal axes, the second electrode being located at least partially around the first electrode. In some forms, the concentric arrangement may be such that the longitudinal axis of each of the first electrode and the second electrode are coaxial. We have found that by providing a concentric arrangement, there is more even discharge distribution along the length of the electrodes, causing more even heat distribution and driving reactions to remove gas constituents more consistently throughout the region in which the electric field is applied in us (e.g. in the discharge length).

It is intended by “at least partially around” that, in at least or only one plane, the second electrode encircles partially or fully the first electrode. Typically, the second electrode is located fully (i.e. completely) around the first electrode, by which it is intended the second electrode fully encircles the first electrode in at least one plane (and typically only in a single plane, which may be perpendicular to a longitudinal axis of the first and/or second electrode).

The dielectric barrier may be a coating on one of the electrodes, or may be located independently from (i.e. with a separation or gap between it and) the first electrode and/or second electrode. Typically, the dielectric barrier is arranged concentrically with the first and second electrode and has a longitudinal axis parallel to the longitudinal axis of each of (i.e. the axes of) the first electrode and second electrode, the second electrode being mounted on a distal side of the dielectric barrier to the first electrode and at least partially encircles the dielectric barrier around its circumference. This minimises structural rigidity needed for the second electrode and provides structure to the DBD device, which simplifies the construction and fabrication of the device.

The second electrode may pass around the whole of the circumference of the dielectric barrier, thereby fully encircling the dielectric barrier around its circumference.

The dielectric barrier may have a thickness of between about 0.1 millimetres (mm) and 10 mm, such as about 2 mm.

The dielectric barrier may be one or more of mica, quartz, fused silica, alumina, titania, barium titanate, fused silica, titania silicate, silicon nitride, hafnium oxide, polymer or a ceramic. By the phrase “one or more of”, in this case, we intend to mean a combination of two or more of the named materials when two or more of these are used.

Typically, the dielectric barrier is (glass) quartz. This is because quartz is readily available, low cost, can be processed in large quantities and can have a high resistance to thermal stress. The dielectric barrier may alternatively be mica. Mica is beneficial because it has a slightly higher dielectric constant than other dielectric materials, such as glass.

The second electrode may be a foil, such as a ground foil of a solid sheet. This allows minimal material use and minimal complexity to the second electrode. Alternatively, the second electrode may be a thicker sheet, mesh, rod(s), coating, cast or moulded fitting. We have found that a coating is not reliable for long-term use and a mesh has inefficiencies in relation to plasma handling. The second electrode being a foil may be applied when the second electrode is located or mounted on the dielectric barrier.

Typically, the second electrode is steel, such as stainless steel, for example, SS 316L. Alternatively, the second electrode may be aluminium. Each of these materials allows the second electrode to be electrically conductive.

The second electrode may be held in place on the dielectric barrier by one or more constant force springs. This allows for a simple design and avoids piercing the electrode (and so the foil of which the electrode may be formed) being required. Alternative fixings, such as an adhesive, bonding or coating may be provided instead.

There may be five constant force springs. While there can be more or less constant force springs, if there are more this makes the total weight of the spring overly heavy, and makes the device difficult to manufacture. If there were less constant force springs the second electrode may move or shift over time.

There may be a separation between an axial end of the second electrode and an axial end of the dielectric barrier. In other words, each end of the second electrode may have an axial offset from respective ends of the dielectric barrier. This helps minimise voltage creep by providing a region in which discharge is less likely to occur at end regions of the DBD device.

There may be an axial offset between the or each discharge node and a proximal axial end of the dielectric barrier. This also minimises voltage creep for the same reasons.

The axial offset between an end of the second electrode and/or the or each discharge node and a respective axial end of the dielectric barrier may be at least 4% of the axial length of the dielectric barrier, such as at least 5% of the axial length, 6% of the axial length of the dielectric barrier and/or 7% of the axial length of the dielectric barrier.

The first electrode is typically a rod, but may be a sheet, foil, such as ground foil, mesh, coating, cast or moulded fitting. The rod may have a diameter between 5 mm and 10 mm, such as 8 mm. Typically, the first electrode is steel, such as stainless steel, for example, SS 316L. The combination or the first electrode being a rod of the stated material and stated diameter limits the bend radius of the first electrode to within mechanical tolerances of the device over a length, such as a length of about 800 mm or longer. This means the first electrode will not bend in use thereby avoiding disruption of unwanted concentration of discharge due to alterations in an applied electric field caused by bending of the first electrode.

The dielectric barrier may be a cylinder having an externally orientated collar offset from an end of the cylinder, an end of the second electrode abutting the collar in use. The externally orientated collar prevents passage of the second electrode past the collar to (help) stop the electrode sliding relative to the dielectric barrier when orientated with the collar gravitationally below the electrode.

It is intended “externally orientated” means outwardly facing or outwardly orientated, such as on an external surface of the cylinder. In arrangements where the second electrode is mounted on a distal surface of the dielectric barrier relative to the position of the first electrode, the externally orientated collar is located on the same, distal, side of the dielectric barrier. The phrase “offset from an end of the cylinder” is intended to mean that the collar is located near, but set back from an end of the cylinder, such as at a distance from the end of the cylinder of up to 10%, 8% or 7% of the length of the cylinder.

The first electrode may be held apart from the second electrode and dielectric barrier. This may be achieved by connectors, the connectors providing an insulated connection to the dielectric barrier and second electrode, the connectors being located at opposing ends of the dielectric barrier and the gas flow path passing through the connectors. This suspends the first electrode in the space between it and the second electrode, keeping joins along the length of the first electrode to a minimum. This also allows the first electrode to be centred within the second electrode and dielectric barrier.

The connectors may each include three spokes extending between a rim and a hub of each connector. This is the most structurally solid configuration whilst maximising passage of gas along the gas flow path. While fewer spokes could be used, using, for example, two spokes has been found to be less favourable due to vibrations occurring in the spokes leading to structural failure.

These connectors, also referred to herein as “end cups”, may be any suitable (e.g. insulating) material. Typically, they are alumina, such as green alumina.

Each connector may be moulded, extruded or machined. Typically, each connector is machined, then sintered. All or part of the surface of each connector may then be glazed. Green alumina is the state of the material before sintering, consisting of alumina sand with a bonding agent that allows for machining. The bonding agent is typically burned away after sintering. Being made of alumina allows the thermal expansion of each connector to be similar to or match the thermal expansion of the dielectric battier.

Each connector may have a minimum thickness of between 1 mm and 5 mm, such as 2 mm. This a is a balance of size against fragility. At a minimum thickness of 2 mm, each connector would become too fragile.

A join between the first electrode and at least one connector is provided by a spring. The spring allows for thermal expansion and contraction of the first electrode while retaining structural integrity of the device. The spring may be a compression spring, but could be a tension spring.

The first electrode may be arranged, in use, to be a cathode, and the second electrode is arranged to be an anode. The first and second electrodes may be a cathode-anode pair in relation to each other. As such, the first electrode may be an anode in a different cathode-anode pair, and/or the second electrode may be a cathode in a further cathode-anode pair. The second electrode being the anode causes discharge to pass inwardly, which is safer and reduces shielding needs of the device.

The gas may be air or gas from any local, remote, ambient, environmental or man-made source. While the gas may be any gas from any source or may simply be gas available locally, such as air, the gas typically may be a waste gas. The gas may be a gas from an engine.

Additionally or alternatively, the gas may be a gas containing CH4. This allows the electrical discharge to be used to reduce CH4 in air and in exhaust gases, such as flue emissions, from combustion engines, for example in ships and other vehicles, power plants and incinerators.

In place of the gas flow path, a fluid flow path may be provided, typically providing a flow path for a gas, but may provide a flow path for another type of fluid, such as a liquid.

The first electrode and second electrode may be any suitable material for providing electrodes that allows an electrical field to be established therebetween. Typically, the electrodes may be made of an electrically conductive metal.

Each discharge node may be any form of suitably sized structure. Typically, each discharge node provides a point, such as being shaped to form a point, pointed structure or tapers to a point, such as, for example, a cone or triangle. This intensifies the electric field at the apex or vertex forming a point, thereby increasing probability of discharge occurring at that location compared to when a flat or blunt geometry is used instead of this sharp geometry.

There may be a power supply connected to each of the first electrode and second electrode and arranged in use to establish the electric field between the first and second electrodes.

The power supply may be further arranged to provide an adjustable amount of real power to the fluid to be present between the first and second electrodes in use. By the phrase “real power”, we intend to mean the instantaneous power (p(t)) provided to the DBD device averaged over a period (for example, T0) of the applied voltage, where the period is typically a period from a start of an excitation or start of a power supply window to the start of the next power supply window. Real power (P) can be calculated as shown in Eq. 1:

$$P = \frac{1}{T 0} {\int }_{t 0}^{t 0 + T 0} p ( t ) dt \qquad Eq . 1$$

where “t” is time and “t0” is the time at the start of an excitation or the start of a power supply window.

By real power, we also intend to mean the rate of generating high energy electrons in the fluid to be present between the first and second electrodes and the unwanted losses involved in this process. We intend for this to provide a conversion of electrical energy (for example, from the drive circuit) to chemical energy (for example, in the fluid between the electrodes during use). An intention overall is to minimise losses to have a maximal rate of production of high-energy electrons.

When there is a plurality of discharge nodes, the discharge nodes may be connected to at least one of the first and second electrodes, and/or the dielectric barrier. By this, we intend to mean that at least one discharge node is connected to at least one of the first or second electrodes or the dielectric barrier. This means that more than one of the first and second electrodes and/or the dielectric barrier may have one or more discharge nodes connected thereto. There may of course be a plurality of discharge nodes, each discharge node being connected to one of the first or second electrodes or the dielectric barrier, such as all the discharge nodes being connected to only one of the first or second electrodes or only the dielectric barrier; or one or both of the first and second electrodes and/or the dielectric barrier having one or more discharge nodes connected thereto. It is intended that when a discharge node is connected to an electrode or the dielectric barrier, that discharge node is only connected to that respective electrode or the dielectric portion, and not also connected to an, or another, electrode or the dielectric portion (when connected to an electrode).

The power supply may maintain real power through any suitable means, such as by providing a constant supply of power at a set amount, from a DC power supply of some form, or by providing a constant or modulated AC power supply or continuous supply of power in a sinusoidal waveform at a predetermined frequency.

The power supply may be the drive circuit detailed in WO 2022/106622, which is incorporated herein by reference. This may be a drive circuit for (i.e. suitable for) a dielectric barrier discharge device, the drive circuit comprising: a power supply connectable in use across a dielectric discharge gap, the dielectric discharge gap providing a capacitance; and an inductance between the power supply and the dielectric discharge gap when connected thereby establishing a resonant tank in use, wherein power is provided in use to the tank in pulse-trains and only during a pulse-train, a pulse frequency of each pulse-train being tuneable in use to a resonant frequency of the tank, power provided by each pulse-train charging and maintaining the tank to a threshold at which discharge ignition occurs (at the dielectric discharge gap), discharge ignition events per pulse-train (such as discharge ignition events occurring during the period of any one pulse-train) being limited to a maximum number based on the drive circuit being arranged in use to prohibit each pulse-train transferring power to the resonant tank after the maximum number has occurred.

By providing pulse-trains of power to the resonant tank, the amount of energy stored in the resonant tank increases, also referred to as “charging” the resonant tank, over the duration of each pulse-train. Dielectric barrier electrical discharge occurs across the dielectric discharge gap when the potential difference across the gap reaches a threshold (Vth). By tuning the pulse frequency (by which we intend to mean the reciprocal of the period between individual pulses or cycle period of pulses within a pulse-train) of the pulse-trains to a resonant frequency of the tank the charging process causes a rapid increase in the amplitude of the potential difference. This increases the potential difference amplitude to the threshold over, for example, less than ten cycles, to reach a threshold at which dielectric barrier electrical discharge occurs (which can also be referred to as an “ignition threshold”).

A limitation on current imposed stress is provided by using the described drive circuit. Limitation on current imposed stress is achieved using such a device by the build-up to the potential difference to the threshold occurring over several cycles (i.e. individual pulses) during the pulse-train by means of the resonant tank voltage gain resulting in reduced power losses in the driving circuit. In conventional pulsed-plasma systems, plasma discharge is provided by use of a single pulse, requiring a high step-up transformer, resulting in a higher current, and thereby raising current imposed stress on the primary winding side.

Further, the power supply is protected from short-circuits without needing overcurrent detection. This is due to the inductance of the resonant tank providing enough impedance to limit currents if the output terminal of the power supply is shorted, for example, due to a short circuit failure at the dielectric barrier.

Additionally, by limiting the number of discharge ignition events, there is a reduction in dissipation of energy simply to heat or to generation of less reactive species. Indeed, we have found that by implementing such a hybrid of resonant AC and limited pulse excitation effective pollutant reduction is providable while also having high power conversion efficiency.

Accordingly, overall, by using the described drive circuit, power transfer in the DBD device with a high efficiency is achieved (due to the resonance operation) while also limiting current imposed stress and protecting against short-circuits so as to protect circuit components.

A separation between the first electrode and the second electrode may provide a dielectric discharge gap. The dielectric discharge gap is intended to be a gap between electrodes of the DBD device. When an electric field is established between the first electrode and second electrode, this typically provides a capacitance due to the gap, with a further capacitance being provided by the dielectric barrier. Of course, when the power supply is connected across the discharge gap, since the edges/sides of this gap are provided by the electrodes, it is intended the power supply is connected (i.e. electrically connected) to at least the electrodes in a manner that allows the power supply to provide current to the electrodes and establish a potential difference across the electrodes. In various examples, the power supply may still be connected across the dielectric discharge gap by being connected to wires or cabling connected to the electrodes that form a closed circuit that includes the power supply and dielectric discharge gap.

The cycle period of power being supplied by the resonant tank is intended to refer to the period taken for the current and/or voltage to pass through a single oscillation cycle (only) as determined by the frequency. In other words, this is intended to be the time taken for the current and/or voltage to pass through a single wavelength (only).

The presence of the dielectric barrier at the dielectric discharge gap typically does not allow arcs or sparks to occur (i.e. discharge that generates sustained current between the electrodes). Instead, it typically only allows microdischarges to occur, which typically only last for microseconds. This provides the necessary energy and components to contribute to a chemical reaction pathway to break down compounds in the medium through which the discharge is passing, while limiting the amount of power needed to provide sustained discharge.

A process by which discharge caused by a power supply can be thought of as there initially being an absence of discharge occurring before an ignition threshold is reached. This means gas in the discharge gap (such as between electrodes) has not been ionized, and there is no electric discharge, and, of particular relevance, power is not delivered to the gas. Once the threshold is reached discharge occurs, however, which can be referred to as a “discharge ignition event”. This results, from a single point (such as some form of discharge node on the surface of an electrode defining a side of the discharge gap), in transient filaments (each representing a micro-discharge) being formed. Each filament's lifetime (i.e. the period of time during which a respective filament exists) is of the order of tens of nanoseconds. It is only during the lifetime of these transient micro-discharges that high-energy electrons are formed in the discharge gap. The electrons acquire kinetic energy when accelerated by the applied electric field. Then the electrons transfer this energy through collisions that can be elastic (kinetic energy conservation) or inelastic (transfer to the internal energy of the molecule and reaction). The energy delivered by high-energy electrons that are generated is able to initiate pollutant breakdown due to the energy levels being of a sufficient amount to initiate chemical reactions.

Maintaining a discharge gap at the voltage threshold indefinitely causes charge accumulation on the surface of the electrodes and dielectric barrier of a dielectric discharge gap of a DBD device. This can be avoided by the use of pulses. Pulses can be thought of, due to the alternating polarity provided by pulses, as limiting the amount of time the instantaneous voltage at the discharge gap is maintained at the ignition threshold to a period in the order of a few microseconds. This means that transient filaments are only able to be produced for this period. As such, the period in which microdischarges can occur can be thought of as limited to the amount of time the instantaneous voltage at the discharge gap is maintained at the ignition threshold, and the summation of those transient filaments may be considered to be a “macro-discharge” or “discharge event”.

The term “discharge ignition event” is therefore intended to be the start of a macro-discharge or discharge event; or, in other words, the start of the period during which micro-discharges in the form of transient filaments are able to occur, which is when a threshold is reached. This threshold is typically a voltage threshold, such as a voltage threshold at the dielectric discharge gap, for example in the form of a potential difference (e.g. change or difference in voltage, ΔV) across the electrodes/dielectric layer and electrode delimiting the gap. Strictly speaking, in fact, we mean an electric field threshold, with a voltage threshold being determined by the electric field strength and electrode separation.

The pulse frequency of the pulse-train being tuneable in use to a resonant frequency (also able to be referred to as a “resonance frequency”) of the tank, is intended to mean that the pulse frequency may be tuned to one or more of a number of frequencies that is able to be considered the resonant frequency. These include the theoretical resonant frequency (i.e. the frequency that would be calculated as being the resonant frequency when not accounting for real-world effects), or a practically applicable resonant frequency, such as a frequency that takes account of real-world effects, which may include one or more of inductance and/or resistance in wiring and/or other components, damping or impedance. As such, as detailed further below, a zero voltage switching frequency.

The maximum number of discharge ignition events may typically be between one and five events, such as between one and three events, including (only) one event, two events or three events. By limiting to so few discharge events, we have found this produces the most energy efficient and effective breakdown of pollutants. This is due to the energy transfer that occurs due to the discharge ignition event(s) limiting transfer to the medium in the discharge gap, and thereby directing a higher proportion of the energy to cause breakdown of compounds in the medium.

The drive circuit may further comprise a phase meter in communication with the tank and arranged in use to identify (such as by monitoring) a phase shift in power provided to the tank during each pulse-train, the phase shift corresponding to occurrence of discharge ignition events, and wherein the drive circuit may be further arranged in use to determine when the maximum number of discharge ignition events has occurred based on the number of pulses in the respective pulse-train since each respective discharge ignition event.

We have found that such a phase shift represents the start of discharge, and, as such, it is possible to identify the number of discharge ignition events that occur from that point (such as by counting or being aware of the number of pulses in the pulse train from that point onwards). This means it is possible to determine when a maximum number of discharge ignition events has been reached to stop further discharge ignition events occurring. By monitoring a voltage-current phase-shift at, for example, an input to the resonant tank (such as a voltage-current phase-shift measured at the H-bridge terminal, relevance of which H-bridge being detailed further below) a first discharge ignition event may be detected. During charging of the resonant tank (e.g. the rapid voltage built-up) there is typically close to zero phase-shift (excited at resonance). However, once the plasma is ignited as part of the discharge ignition event, there is typically a shift in the resonance frequency because of the increase in capacitance imposed by the “ignited” discharge gap. When monitored, this resonance frequency shift may be detected immediately by monitoring the phase-shift.

Such a phase meter (e.g. a phase detection unit) as mentioned above may be provided by a controller, processor, microprocessor or microcontroller or another such device capable of monitoring phase of at least two signals.

Additionally or alternatively to phase monitoring or using a phase meter, each pulse-train may have a pre-tuned or optimised pulse-number (i.e. number of pulses within the pulse-train). It is typically possible to calculate or model how many pulses will be needed to charge the resonant tank, and typically there is (only) a single discharge ignition event per pulse, or at least it is possible to calculate how many discharge ignition events will be caused per pulse. This allows it to be possible to set the number of pulses in a pulse-train to at least the maximum number of discharge ignition events wanted plus the number pulses needed to charge the tank. If such an approach is used, there may of course be further pulses included in a respective pulse-train, such as when pulses are used to discharge the resonant tank. These may also be included in calculation of how many pulses are needed per pulse-train if this approach is used.

The drive circuit may further comprise a power storage device connected across the power supply arranged in use to accept and store power discharge (i.e. power drained) from the tank after each pulse-train (or after the maximum number of discharge ignition events has occurred). This provides a means for storing/recouping power within the drive circuit that would otherwise be lost due to energy in the resonant tank dissipating. This reduces energy loss between pulse-trains and allows the stored energy to contribute in forming the next high voltage pulse-train, which results in increased efficiency.

Energy or power recuperation is able to be achieved through passive or active means. Typically, an active means is used, such as the drive circuit typically being arranged in use to shift the phase of (pulses in) the pulse-train by 180 degrees (°) after the maximum number of discharge ignition events has occurred. By implementing this mechanism, energy recovery is able to be achieved when passive means for energy recovery (and potentially any other active means) are not possible, such as due to use of a loosely coupled air-core transformer. This thereby allows the efficiency gains achievable from energy recovery to still be achieved. The phase shift may be in place for the same number of pulses as the number of pulses used in the pulse-train to charge the resonant tank to the threshold, although it would be possible to apply the phase shift for a different number of pulses. This maintains similar power flows when charging and discharging the resonant tank.

The drive circuit may further comprise an inverter between the power supply and the tank, the inverter being arranged in use to modulate supply of power to the tank from the power supply. This allows the characteristics and properties of the power provided to the resonant tank to be determined by components within the drive circuit instead of by any input to the drive circuit. This provides a great amount of customisation and alterations to be made than when this is determined by power provided at a circuit input.

The inverter may be any suitable type of inverter. Typically, the inverter is an H-bridge or half bridge. This provides a simple mechanism for providing the inverter functionality while also allowing direct and easy control over the output from the inverter to achieve passive and/or active recuperation of the energy stored in the tank at the end of every pulse-train.

When an H-bridge or half bridge is used, the switches used in the bridge inverter may be any suitable switch, such as a mechanical switch or power transistor switches. Typically each switch of the inverter may be a silicon or silicon carbide (Metal Oxide Semiconductor Field Effect Transistor, MOSFET) switch, a silicon insulated-gate bipolar transistor (IGBT) switch, or a gallium nitride power transistor (FET) switch. A silicon MOSFET switch typically has a blocking voltage of about 650 V; a silicon carbide (SiC) MOSFET switch typically has a blocking voltage of about 1.2 kV; a silicon IGBT switch typically has a blocking voltage of about 650 V or about 1.2 KV; and a gallium nitride FET switch typically has a blocking voltage of about 650 V. It is also possible to use a multi-level bridge-leg with several low-voltage devices connected in series to achieve a high (er) blocking voltage bridge-leg. However, typically a mechanism is needed to make sure that the voltage is shared equally across the switches, which makes things complicated and less rugged. This is why the 2-level H-bridge is typically used in the drive circuit according to the first aspect. The use of the above switches in the inverter also allows the components to be kept simple. Wide bandgap (WBG) semiconductors, such as SiC and GaN, are typically used due to their superior performance over Si based power semiconductors.

The pulse frequency (such as of the frequency of a voltage waveform if provided as a pulse-train) supplied to the resonant tank may be exactly the resonance frequency of the tank, such as the frequency of the first order harmonic (i.e. fundamental frequency or natural frequency), or at around the resonance frequency, such as within a range of the resonance frequency. If a higher order harmonic is used, due to the resonant tank typically having low pass characteristics, higher order harmonics than the first order harmonic are attenuated or damped. This is why the resulting current and voltage across the dielectric discharge gap is almost perfectly sinusoidal even though the excitation is typically provided in a square waveform.

When an inverter using switches, such as an H-bridge or half bridge inverter, is used, the pulse frequency of each pulse-train may be a zero voltage switching (ZVS) frequency. This is typically slightly above the exact resonance frequency of the tank, such as about 5% to about 10% above the exact resonance frequency, and no more than about 10% depending on the Quality (Q) factor of the drive circuit. This reduces losses caused by the switching and reduces electromagnetic interference (EMI) caused by the switching, thereby making the inverter more efficient and reducing noise produced by the inverter.

The drive circuit may further comprise a transformer, secondary windings of which form part of the resonant tank, the transformer being a step-up transformer. This lowers the minimum voltage gain needed in the resonant tank to achieve dielectric barrier electrical discharge voltage levels (i.e. Vₜₕ) by raising the voltage input level. Additionally, the use of a transformer reduces ground currents (currents flowing in the parasitic capacitance between electrodes of the DBD device and any surrounding metallic housing), thereby reducing EMI. While a transformer could be located within the drive circuit with the primary windings forming part of the resonant tank instead of the secondary windings, in the arrangement where the secondary windings form part of the resonant tank, the kilo-Volt-Ampere (KVA) rating of the transformer is able to be reduced. In such a case, a reactive power of the DBD device may be compensated.

When a transformer is used, the drive circuit may be arranged in use to short the primary transformer windings after each pulse-train. When energy is being recovered/recuperated from the tank, the shorting of the primary windings is typically applied after the energy has been recovered, such as after a respective pulse-train has elapsed. Shorting the primary windings reduces ringing that may occur due to the components that make up the resonant tank. When an inverter is used, the shorting of the transformer primary windings may be achieved in use by switching on a low side or high side of the inverter. This avoids the need to include further components in the drive circuit, thereby limiting component count.

The inductance of the resonant tank may be provided or contributed to by one or more components, and may be provided by inductance in wiring or cabling between components within the drive circuit. At least a part of the inductance (such as some or all of the inductance) may be provided by the transformer. This uses a typically undesirable property of a transformer allowing that property to be used as a contribution to the functioning of the drive circuit. Any inductance provided by the transformer may be leakage inductance (also referred to as stray inductance) of the transformer. In some circumstances this can allow the resonant tank to not need to also include an inductor as a specific component.

As set out in more detail below, the transformer may be an air-core transformer. When an air-core transformer is used, this may have up to 60% magnetic coupling between windings. The use of an air-core transformer, such as an air core-transformer with 60% magnetic coupling between windings, enhances the inductance able to be provided by the transformer, reducing the need for the resonant tank to have any further inductance. Additionally, the resonance inductance, and thereby the resonant frequency of the resonant tank, may be tuned by adjusting the distance between the primary windings (also referred to as the transmitting coil) and the secondary windings (also referred to as the receiving coil) when using an air-core transformer. This reduces the need for placement of additional capacitors, as is known to be carried out in existing systems, into the drive circuit, thereby reducing component count. This is achievable due to planar inductive power transfer that occurs when using air-core transformer. Other arrangements that allow an air-core transformer to be implemented are also possible.

Air-core transformer windings have low coupling compared to other transformers (i.e. non-air core or solid core transformers). This allows the secondary (i.e. high voltage) side of the transformer to oscillate freely when no voltage is impressed from the primary side (such as when all switches are off and body diodes not conducting). The means for active energy recovery detailed above (i.e. the 180° phase shift of some pulses) removes these oscillations and avoids power losses when an air-core transformer is used.

The transformer may have a step up ratio of primary transformer windings to secondary transformer winding of about 1:1 to about 1:10, such as about 1:5. By applying this arrangement, the following equation holds (Eq. 2), which it typically does not for known systems:

$$\frac{{V}_{dc}}{n} < \frac{{V}_{th}}{2} \qquad Eq . 2$$

where V_{dc} is the voltage provided by a DC link power source, n is the turns ratio of the transformer (i.e. N₁/N₂, corresponding to the number of primary windings divided by the number of secondary windings), and Vₜₕ is the ignition voltage or discharge threshold of the DBD device. As set out in the next paragraph, this reduces the gain needs.

For a dielectric barrier electrical discharge ignition voltage threshold in a DBD device of about 20 kV, this means that a minimum resonant tank voltage gain of about a factor 5 is needed for a step up ratio of about 1:5 when the input voltage to the drive circuit is about 800 V. This achieves an optimised balance between transformer step-up and resonant tank voltage gain, significantly reducing the currents stress of the drive circuit, compared to a conventional pulsed-power and resonant converter system relying primarily on a high step-up transformer (1:20 or greater) to attain the required discharge voltage levels.

Until the discharge threshold is reached, there is minimal damping in the resonant tank. This is because there is no load (such as power transfer to the medium in the discharge gap) on the resonant tank during charging. As a comparison to known resonant systems, in such systems, there is typically always a load because there is continuous or prolonged discharge, which generates a load.

The lack of load on the resonant tank of a drive circuit according to the first aspect results in very high voltage gains (such as gains with Q values of greater than 50) compared to known systems. Unlike known systems, the achievable voltage gain of the resonant tank, does not depend on the load (as noted, typically corresponding to the power transferred to the gas when dielectric discharge occurs). Instead, it (only) depends on the parasitic resistances of the resonant tank (such as those produced by resistance of the magnetics and electrodes).

Further, due to there being a lack of load, this allows more rapid charging and for the pulse frequency of the pulse-trains to be as close as possible to the true resonance frequency of the tank (such as the theoretical resonance frequency that does not account for damping effects typically present in reality). This is because the amount of damping is so low that minimal account needs to be taken of damping when the pulse frequency is set. This enhances the energy transfer ability, making the drive circuit more efficient.

When there is a transformer, the dimensioning needed of the transformer step-up turns ratio (i.e. the specification set for the transformer step-up turns ratio) also only depends on the parasitic resistances of the resonant tank. Should there be a load to account for as well, dimensioning of the transformer step-up turns ratio would also need to account for this. This allows losses from the transformer to be kept to a minimum thereby reducing the effect of using a transformer on the efficiency of the drive circuit compared to when a load does need to be considered.

Alternatively or additionally to a transformer providing inductance, at least a part of the inductance (such as some or all of the inductance) may be provided by an inductor. This provides a component designed to provide inductance to be used, thereby optimising the drive circuit. In a situation where the inductance is provided partially or wholly by an inductor and a transformer, each contribute to inductance between the power source and the dielectric discharge gap, and thereby to inductance of the resonant tank.

When a separate transformer and inductor are provided, there are several possible arrangements of the drive circuit. One arrangement is for the inductor to be connected to the input to the resonant tank (such as the output of the inverter), this is in turn connected to the primary winding of the transformer; the secondary windings of the transformer are then connected across the dielectric discharge gap. A further arrangement is for the input to the resonant tank to be connected to the primary winding of the transformer; the secondary winding is connected to the inductor, which is connected in series with the dielectric discharge gap. In each of these arrangements, the leakage or stray inductance of the transformer contributes to a resonance inductance value (i.e. the inductance) of the resonant tank. Naturally, if the resonant tank is placed after the transformer, the kVA rating of the transformer is reduced because the oscillating reactive power of the dielectric discharge device is not passing through the transformer.

Another arrangement is for the input to the resonant tank to be connected to the primary winding of the transformer; and the secondary windings of the transformer are connected across the dielectric discharge gap. In this arrangement, since no separate inductor component is provided, the leakage or stray inductance of the transformer would need to be large enough to compensate the load across the dielectric discharge gap at a desired resonance frequency. This can be achieved by means of a transformer with very low coupling between windings as it is the case for an air core transformer (i.e. without magnetic core) as referred to in more detail below.

The device may further comprise a controller connected to the drive circuit, the controller being arranged in use to adjust the power supplied to the tank of the drive circuit based on input provided to the controller. This allows modification of the power provided in use to the resonant tank providing the ability to make alterations when parameters within the system change during use, causing a shift in properties within the system. For example, a change in fluid passing between the electrodes may cause a change in the capacitance of resonant tank, altering the resonant frequency. The controller could then be used to adjust the pulse frequency provided to the resonant tank during a pulse-train.

The controller may be arranged in use to adjust/modulate the pulse frequency (such as the frequency of a voltage waveform or current waveform), and/or the pulse-train frequency (such as the frequency of the pulse-trains, i.e. how often a pulse-train occurs, which is also able to be referred to as pulse-train repetition frequency), and/or the number of pulses in a/each pulse-train, and/or number of pulse-trains (such as the number in a series of electrical pulse-trains). This provides a wide range of adjustments that can be made to allow the power provided to be tailored to provide optimum dielectric barrier electrical discharge occurrence during use of the system.

Input provided to the controller may include one or more relevant parameters. Typically, the input includes voltage and current at an output of the drive circuit, such as at an output of an inverter. This allows phase angle between the supplied voltage and current and a pulse-train averaged phase to be calculated. This can be used to optimise the pulse frequency provided during a pulse-train. As such, the controller may be arranged in use to determine (by which we intend to mean “calculate”) phase difference between the voltage and current. This could of course be determined by a further component.

As noted above, this phase difference can also be used to detect the beginning of the occurrence of dielectric barrier discharges. Detecting this can allow it to be identified when transition the pulse-train from providing energy to, for example, energy recovery after a defined number of discharge ignition events. As also mentioned above, the occurrence of dielectric barrier discharge in the discharge gap increases the effective capacitance. This results in a reduction of the resonance frequency, and hence an increase of the measurable phase difference for a given driving frequency (such as the pulse frequency of the pulse-trains). In view of this, it can be seen that the phase meter of the drive circuit and the controller may be the same component as each other. Alternatively the controller and phase meter may be in communication with each other, or the controller may incorporate the phase meter, such as the phase meter being a component of the controller.

As noted above, the drive circuit may comprise an inverter between a power supply and a resonant tank of the drive circuit. In this case the voltage and current may be being provided from an output of the inverter. This allows a more granular (i.e. more precise) level of control of the output provided to the resonant tank than would be achievable if an AC power supply was simply connected to the resonant tank to supply power due to the higher frequencies achievable using an inverter. Additionally, higher AC frequency, such is achievable using an inverter is able to provide shorter dielectric barrier electrical discharge. This allows simpler limiting of the maximum number of discharge ignition events and faster control than could be exerted if a standard AC power supply were used to maintain the efficiency gains achieved by limiting the number of discharge ignition events.

The controller may be further connected to the dielectric barrier discharge device, the input including one or more properties of fluid passing through the device in use. This allows the properties of the fluid to be taken into account when seeking to optimise performance of the system.

According to a third aspect, there is provided a system for providing dielectric barrier discharge, wherein the system comprises: a plurality of dielectric barrier discharge devices according to the first or second aspects and including the drive circuit according to any combination of features of the drive circuit set out above; and a controller connected to each drive circuit, the controller being arranged in use to adjust the power supplied to the tank of each drive circuit based on input provided to the controller. This allows the system to be scaled to accommodate various volumes of fluid passing through it, such as various sizes of engine passing exhaust gas to be cleaned. Further, this also provides the advantages of the controller set out above.

The controller may be only a single controller. Whether there is a single controller (connected to all the drive circuits) or multiple controllers (each of which is connected to a respective drive circuit), the controller or each controller may provide any combination of features of the controller set out above. For example, the controller may be arranged in use to adjust the pulse frequency, and/or the pulse-train repetition frequency, and/or the number of pulse-trains, and/or the number of pulses in a pulse-train; the input may include voltage and current at an output of each drive circuit; when each drive circuit includes an inverter between the power supply and the tank, the inverter may be arranged in use to modulate supply of power to the tank from the power supply, and wherein the voltage and current are provided from an output of the inverter; the controller may be arranged in use to determine phase difference between the voltage and current; the controller may be further connected to each dielectric barrier discharge device, the input including one or more properties of fluid passing through the device in use; and/or there is only a single power supply arranged in use to provide the power supply for all the drive circuits.

According to a further aspect, there may be provided a method of controlling dielectric barrier electrical discharge in the dielectric barrier discharge device according to the first aspect, according to the second aspect or as part of the system according to the third aspect, the method comprising: providing power to a resonant tank with a series of electrical pulse-trains, the pulse frequency of each pulse-train being tuned to a resonance frequency of the tank, the resonant tank being connected across a gap between the first electrode and second electrode in the dielectric discharge device, a capacitance of the tank being provided by the dielectric discharge device, power provided by each pulse-train charging and maintaining the tank to a threshold at which discharge ignition occurs; providing a maximum number of discharge ignition events per pulse-train by prohibiting each pulse-train transferring power to the resonant tank after the maximum number of discharge ignition events has occurred; and prohibiting power transfer to the tank between pulse-trains.

By the term “prohibiting” we intend to mean either passively or actively prohibiting power transfer to the tank, such as by not providing a path by which power can pass to the tank or by diverting a path to an alternate circuit respectively.

As noted above, the maximum number of discharge ignition events may be between 1 (one) and 5 (five) events.

The method may further comprise identify a phase shift in power provided to the tank during each pulse-train, the phase shift corresponding to occurrence of discharge ignition events; and determining when the maximum number of discharge ignition events has occurred based on the number of pulses in the pulse-train since each respective discharge ignition event. This provides an accurate means to avoid the maximum number of events being exceeded.

Each electrical pulse-train may be a voltage pulse-train. By this we intend to mean that the electrical pulse-train may be provided by a voltage pulse-train, such as a voltage waveform that may be used as an excitation waveform for the resonant tank, and which may induce a current waveform in the resonant tank.

The method may further comprising modulating the pulse frequency, and/or frequency of pulse-trains, and/or number of pulse-trains in the series of electrical pulse-trains, and/or number of pulses in each pulse-train. It is worth noting that the power frequency is able to be modulated by modulating the power or the constituents of the power, such as the voltage and/or current. The frequency of the power is twice the frequency of the voltage waveform (which the frequency the pulse frequency is intended to represent) that contributes to the power, which is the case for power systems in general. If the voltage and current are each sinusoidal waveforms, the power will be the square of a sinusoidal waveform (i.e. Sin \hat{ }2), and the spectral decomposition will show the fundamental frequency at twice the excitation (i.e. voltage) frequency.

The modulation may be based on a phase difference in properties of the power provided to the resonant tank and/or one or more properties of fluid passing through the device.

Power may be provided to the resonant tank via a transformer, the method further comprising shorting the transformer primary winding between repeating pulse-trains. This prevents (i.e. mitigates) unwanted oscillations between the magnetising inductance of the transformer and the capacitance of the DBD reactor.

The pulse frequency of each pulse-train provided to the resonant tank may be set by switching in a circuit between a power supply and the resonant tank.

For each pulse-train, the resonant tank may be discharged (i.e. drained) after the maximum number of discharge ignition events has occurred. This may be achieved by active recuperation or passive recuperation. Under such circumstances, the method may further comprise storing energy passed out of the resonant tank by the discharge. Recovering energy in this manner significantly increases the energy efficiency of the method.

There is typically a temporal difference between the end time of one pulse-train and the start of the next pulse-train. In other word, there may typically be a period of time between the end of one pulse-train and the start of the next pulse-train during which there are no pulses, which allows one pulse-train to be distinguished from the next pulse-train and avoids any concurrent portions or overlap between consecutive pulse-trains.

The first electrode and/or second electrode may be any suitable material for providing electrodes that allow an electrical field to be established therebetween. Typically, the electrodes may be made of an electrically conductive metal.

As noted above, the dielectric barrier may be connected to the second electrode and/or each discharge node may be connected to the first electrode. This allows application of the dielectric barrier and discharge node to the respective electrodes to be independent. This avoids the possibility of the processes for applying the dielectric barrier to the electrode and for applying the discharge node to the electrode, damaging the discharge node or dielectric barrier respectively. Accordingly, this simplifies the process of manufacturing the apparatus and reduces the failure rate in manufacturing.

The dielectric barrier may provide a form of covering of at least part of the or each electrode to which it is connected. The dielectric barrier may be a coating on at least part of a surface of the or each electrode to which the dielectric barrier is connected. For example, the dielectric barrier may coat the entire surface of the or each electrode to which it is connected.

By the dielectric barrier being connected to at least one electrode, we intend to mean that each electrode to which the dielectric barrier is connected to a dielectric barrier independently of each other dielectric barrier and electrode. This means there may be a plurality of dielectric barriers. Each dielectric barrier may be connected to only a single electrode.

Each discharge node may be any form of suitably sized structure that provides a point.

According to a fourth aspect, there is provided a dielectric barrier discharge device, the device being operated at a temperature between 160° C. and 500° C.

This is able to be achieved by using any form of dielectric barrier discharge device without specific features disclosed herein. Typically, the device according to the second aspect may be a device comprising a pair of electrodes (or first and second electrodes) with a dielectric barrier therebetween, an electric field being establishable between the pair of electrodes in use; and a gas flow path passing between the pair of electrodes.

The DBD device may be operated at a temperature of at least 180° C.

The DBD device may be operated at a temperature of up to (e.g. at most) 450° C.

Of course, a dielectric barrier discharge device according to the first aspect may also be a device according to the fourth aspect and vice versa of as forming part of the system according to the third aspect. As such, the device according to the first aspect may be operated at a temperature between 160° C. and 500° C. In other words, the device according to the first aspect may be arranged in use to operate at a temperature between 160 degrees centigrade (° C.) and 500° C.

According to a fifth aspect, there is provided a method of removing constituents of a gas. The method comprises passing a gas with up to 10,000 ppmv of methane along a gas flow path between a first electrode and a second electrode, wherein the first electrode and the second electrode have a dielectric barrier therebetween; and establishing an electric field between the first and second electrodes, at least one of the electrodes having one or more discharge nodes positioned along the gas flow path, each location along the gas flow path at which at least one discharge node is positioned being an ionisation region and having an adjacent recombination region downstream of the respective ionisation region. By establishing the electric field, discharge occurs at the one or more discharge nodes producing ionisation and thereby forming active species/plasma. Constituents of the gas, including the methane, react with the active species/plasma causing recombination in the recombination region and removing pollutants from the gas. The method may be implemented using the device according to the first, second and/or fourth aspect of the system according to the third aspect.

According to a sixth aspect, there may be provided use of the device according to the first aspect to remove methane from a gas. According to a seventh aspect, there may be provided use of the device according to the first aspect to remove methane from a gas, wherein the gas containing up to 10,000 ppmv of methane.

As noted above, the gas referred to in each of the fifth, sixth and/or seventh aspect may contain up to 5,000 ppmv, 2,500 ppmv, 2,000 ppmv of methane and may be at least 100 ppmv or at least 1,250 ppmv.

### BRIEF DESCRIPTION OF DRAWINGS

Example devices and methods are described in detail below with reference to the drawings, in which:

FIGS. 1A, 1B and 1C show a prior art DBD device and corresponding plasma density plot and plot showing active species concentration compared to pollutant concentration according to the prior art;

FIGS. 2A, 2B and 2C show a first example DBD device and corresponding plasma density plot and plot showing active species concentration compared to pollutant concentration;

FIG. 3 shows a schematic view of the first example DBD device;

FIG. 4 shows a cross-section view of the first example DBD device along plane A-A in FIG. 3;

FIG. 5 shows a schematic view of a component of the first example DBD device;

FIG. 6 shows a cross-section view of the first example DBD device along plane B-B in FIGS. 3 and 4;

FIG. 7 shows a schematic view of a further component of the first example DBD device;

FIG. 8 shows an example plot of power and specific energy inputs (SEI) against change in CH4 for different discharge node forms;

FIG. 9 shows an example plot of power against CH4 removal efficiency for different second electrode and dielectric barrier parameters;

FIG. 10 shows an example plot of power against CH4 removal efficiency for different variations of a discharge node;

FIG. 11 shows an example plot of power against CH4 removal and SEI against CH4 removal for different variations of discharge node;

FIG. 12 shows an example plot of power against CH4 removal efficiency for different electrode parameters;

FIGS. 13A and 13B show example plots of power against CH4 removal for different environmental and electrode parameters;

FIG. 14 shows a second example DBD device;

FIG. 15 shows an alternative implementation of the second example DBD device;

FIG. 16 shows an example high voltage electrode of the alternative implementation of the second example DBD device;

FIG. 17 shows an example plot of gap spacing and bar width against reduction in SO2 for the example high voltage electrode;

FIG. 18 shows example plots of voltage and current in a pulse-train according to prior art device;

FIG. 19 shows a schematic illustrating the principle of an electron irradiation and dielectric barrier electrical discharge scrubbing technology in an example dielectric barrier discharge device;

FIG. 20 shows example plots of voltage, current and power applied in an example circuit;

FIG. 21 shows example plots of voltage against time comparing applied gap voltage to output voltage and a corresponding plot with a magnified portion of output current against time;

FIG. 22 shows an example circuit;

FIG. 23 shows a further example circuit;

FIG. 24 shows another example circuit;

FIG. 25 shows an example method of operating an example circuit;

FIG. 26 shows an example plot of switching sequence over time and resulting voltage over time;

FIG. 27 shows example plots for voltage over time for power transfer rates;

FIG. 28 shows an example controller for an example circuit;

FIG. 29 shows a further example plot of voltage and current over time during an example pulse-train;

FIG. 30 shows a further example controller;

FIGS. 31a and 31b show example plots of switching sequence over time and resulting voltage over time;

FIG. 32 shows example plots of resonant tank input voltage and current and resulting DBD device voltage against time without energy recovery; and

FIG. 33 shows example plots of resonant tank input voltage and current and resulting DBD device voltage against time with energy recovery.

### DETAILED DESCRIPTION

The aspects described herein allow for the removal of one or more pollutants or constituents of a gas. This is achieved by the use of dielectric barrier discharge in a DBD device.

In known electric discharge devices, there is a uniform (i.e., homogenous) volumetric distribution of electrical discharges that produce electrons with a distribution of energy, typically, between 1 electron volt (eV) and 10 eV. The electrons that are produced during electric discharge in a gas are known to interact with the gas to yield active species in the form of free radicals and ions (as well as additional electrons through electron impact ionization, excitation, and ionization of background gas molecules). These active species (the free radicals and ions) oxidise, reduce, or decompose molecules (which in some circumstances are pollutants), such as methane, that are present in the gas.

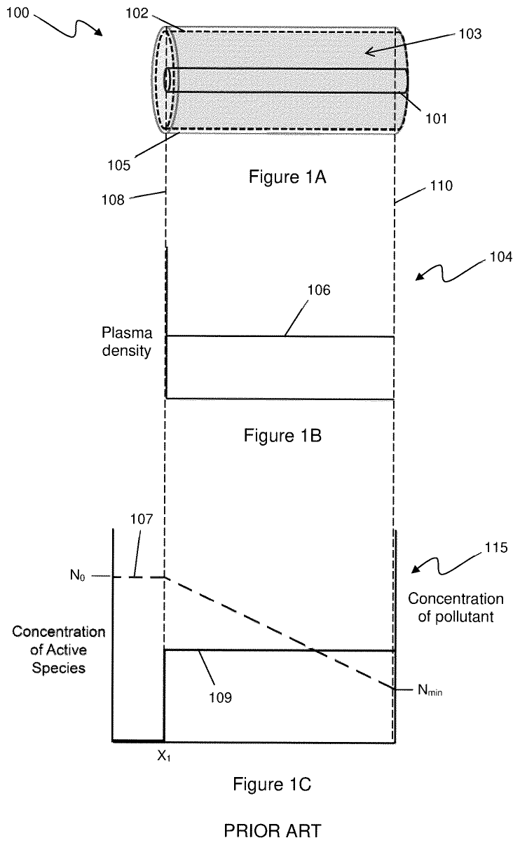

An example of such a known electric discharge device is the DBD device generally illustrated at 100 in FIG. 1A. This shows a known uniformly distributed electrical discharge device.

The device 100 shown in FIG. 1A comprises a first electrode 101, a second, opposing, electrode 105, and a dielectric barrier 102. In use, an electric field is applied between the first electrode and the second electrode. In the right conditions, discharge occurs between the first electrode and the second electrode. The presence of the electric field and discharge generates (non-thermal, low-temperature) plasma 103 between the first electrode and the dielectric barrier.

As shown by the chart 104 of FIG. 1B, the plasma is uniformly distributed throughout the device 100. Line 106 on the graph represents plasma density across the length of the device with the plasma density being level from a first position 108 aligned with the upstream end of the device and a second position 110 aligned with the downstream end of the device.

In terms of what this achieves, FIG. 1C shows a chart 115 which provides a representation of the concentration of active species (measured on the left Y-axis) in the device 100. The concentration of active species is indicated by the solid line 109 FIG. 1C, and the concentration of, for example, pollutant (measured on the right Y-axis) is indicated by the dashed line 107. The concentration of active species is shown to be negligible until a first location X₁, which is aligned with the first position 108. During use of the device, at location X₁, the concentration of active species steps up to a first concentration, which is constant throughout the rest of the device to the second position 110. As for the concentration of pollutants, it can be seen from FIG. 1C that the concentration starts at a first concentration No, and remains constant upstream of the first location X1. The concentration of active pollutants then declines linearly to a minimum concentration Nₘᵢₙ at the second position. This decline is caused by interaction of the gas containing the pollutants with the plasma as the gas passes through the device. It can therefore be understood that, in use, the known discharge device 100 removes pollutants along its length.

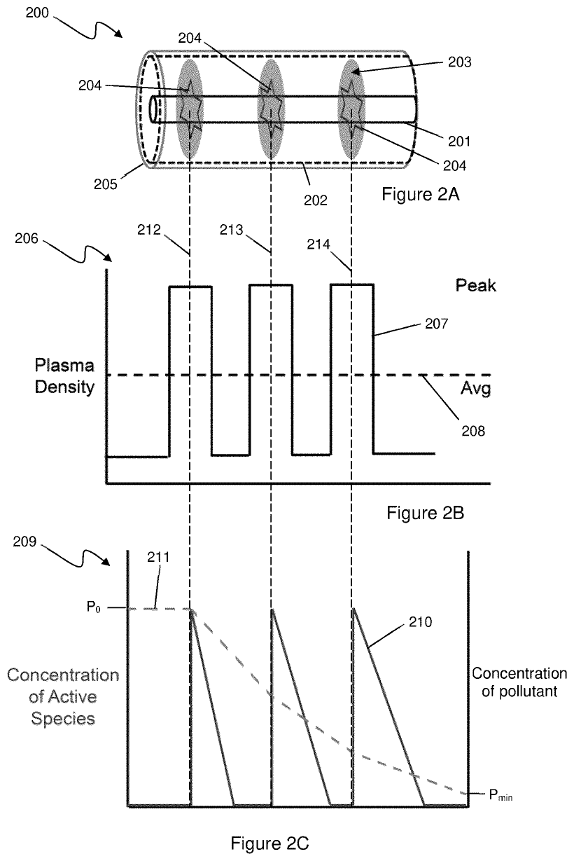

In contrast, as a demonstration of a device according to an aspect disclosed herein, FIG. 2 shows corresponding details for a staged DBD device generally illustrated at 200 in FIG. 2A. The staged DBD device has a first electrode 201, a second, opposing, electrode 205 and a dielectric barrier 202 in the same arrangement as the DBD device 100 shown in FIG. 1A.

The example staged DBD device shown in FIG. 2A also has the plurality of discharge nodes 204 in the form of electric field intensifying structures. The discharge nodes are arranged along the length of the first electrode 201 with separations between adjacent nodes. In the example shown in FIG. 2A, the discharge nodes are shown evenly spaced along the first electrode. In other examples, the spacing may be different and/or may be uneven.

Similarly to the DBD device 100 of FIG. 1A, in use, an electric field is applied in the staged DBD device 200 between the first electrode 201 and the second electrode 205. In the right conditions, discharge occurs between the first electrode and the second electrode. The presence of the electric field and discharge generates (non-thermal, low-temperature) plasma 203 between the first electrode and the dielectric barrier 202.

FIG. 2B shows an illustrative chart 206 of plasma density distribution in the staged DBD device 200 of FIG. 2A. The solid line 207 in the chart shows the plasma density along the length of the staged DBD device and the dashed line 208 shows the average plasma density in the staged discharge device.

In FIG. 2B, the solid line 207 has three peaks. The centre of each of the three peaks aligns with a centre line 212, 213, 214 of each of the discharge nodes 204. This shows that the plasma 203 is highly concentrated around each discharge node. In the regions between the discharge nodes (and between the discharge nodes and the ends of the staged DBD device 200) plasma is only present at low levels.

The chart 206 shows the density of the plasma 203 has a step change at a small distance upstream and downstream of each discharge node centre line 212, 213, 214. In reality, instead of a step change, the plasma density is likely to be smooth or curved distribution with its centre and/or peak aligning with the centre line of the discharge nodes 204. Regardless, as shown by dashed line 208, this provides an average plasma density that is approximately the same as the average plasma density of the DBD device 100 shown in FIG. 1A.

The fluctuation of the density of the plasma 203 along the length of the staged DBD device 200 affects the concentration of active species and concentration of constituents, such as pollutant, along the length of the staged DBD device. FIG. 2C shows a chart 209 illustrating the concentration of active species (measured on the left Y-axis) and concentration of pollutants (measured on the right Y-axis) in the staged DBD device shown in FIG. 2A.

In FIG. 2C, the solid line 210 represents the concentration of active species, and the dashed line 211 represents the concentration of pollutants. It can be seen that the concentration of active species spikes in the vicinity of the centre lines 212, 213, 214 of each of the discharge nodes 204. In the example shown in FIG. 2C, the peak of each spike in active species concentration is aligned with the centre line of a respective discharge node. In other examples, this peak is slightly upstream or slightly downstream of the respective centre line.

The solid line 210 and dashed line 211 in the chart 209 of FIG. 2C show the concentration of pollutants starts at some initial concentration P₀ and is constant until a first discharge node 204 is reached, coinciding with the peak in plasma density. The concentration of pollutants then decays sharply (in a linear manner in this example). When the second discharge node along the length of the staged DBD device 200 is reached, the plasma density peaks again, raising the concentration of active species again. At this point the concentration of pollutants continues to decrease, but at a less steep rate due to the concentration already being lower than the initial concentration. On passing the third discharge node, the increase in plasma density and concentration of active species causes a further decrease in the concentration of pollutants, but at a still shallower rate (i.e. less steep, less sharp decay). This decay continues until the concentration of pollutant reaches its lowest level of Pₘᵢₙ.

It has been observed that the rate at which pollutant is removed from a staged DBD device, such as the example staged DBD device shown in FIG. 2A, is greater than the rate at which pollutant is removed from a conventional discharge device, such as the known DBD device 100 of FIG. 1A. This is apparent from the fact that, with the discharge nodes 204, the rate at which pollutants are removed is greater than that of a conventional device. Further, the concentration of pollutants Pₘᵢₙ is lower than can be achieved by the conventional device Nₘᵢₙ.

The reason for this is that an enhanced concentration of active species in the gas is known to increase the removal efficiency of pollutants in the gas. In addition, producing electrical discharge only at periodic points along the length of the staged DBD device 200 allows for ionisation regions (i.e. where active species are produced) and recombination regions (i.e. where active species react with pollutants, or, in other words, the species generated in the ionisation regions react with each other or with other present gas components lowering the amount of (remaining) ionisation). The repeating ionisation regions can be viewed as “topping-up” or “regenerating” the concentration of active species in a staged electrical discharge device. In the absence of these staged ionisation regions, the concentration of active species that are generated uniformly, as is established in known electric discharge devices, can be lower in comparison. This is because the active species can suffer from non-specific reactions or thermal degradation. Re-establishing a high concentration of active species in an electrical discharge device is, therefore, beneficial for pollutant removal efficiency.

In view of this staged DBD device concept we have developed, we have further developed a method to generate a large number of high-energy electrons, atoms and free radicals to remove pollutant molecules from gases. This is achieved using electrical discharge techniques that have been found to remove pollutant molecules, including but not limited to, particulate matter, SOx, NOx, CO2, mercury (Hg), volatile organic compounds (VOCs) and Hydrocarbons (HCs) from gases.

As a general outline, an apparatus and method suitable for electrical discharge removing CH4 from gas have been developed. The same ability to remove gas constituents also applies to other gas constituents, such as SOx and CO2. A gas flow containing harmful, or pollutant, gas (such as CH4) is introduced into the apparatus. The apparatus is provided with a plurality of electrodes (typically pairs of anodes and cathodes). The electrodes are separated by a gas space and a dielectric barrier.

Where cathodes and anodes are referred to herein, reference is intended to be made to two electrodes opposing one another across an air or gas gap with no other intervening electrodes.

In the presence of an electric field between the electrodes, when gas passes between the electrodes, the gas is instantaneously ionised to form high-energy electrons, atoms and free radicals. When a gas flow is introduced from a gas inlet at an end of the apparatus passes through this discharge reaction zone (i.e. between an electrode pair), taking CH4 as an example, a portion of the CH4 present in the gas is converted to carbon monoxide (CO) and water (H2O, H₂O). This is achievable due to the electric field established between the electrodes.

Once passed between the electrode pairs, the gas flow is discharged through an outlet provided at an opposing end of the apparatus to the gas inlet. The composition of the gas after the apparatus contains a fraction of the original CH4 and CO and H2O.

In using staged electrical discharge, high voltage alternating current is able to be applied to electrodes that are typically separated by a gas space and a dielectric barrier or insulator. Other types of electrical discharge apparatuses include, but are not limited to, pulse, corona, and electron beam discharge and radio frequency, microwave, and ultraviolet light radiation sources. Of discharge devices available, at least high temperature, staged barrier electrical discharge and a number of the other named energy sources are not known to be used for removal of CH4 from air or point sources of CH4 (such as flue or exhaust gas from engines and industrial plants) before. That these parameters are useful in these applications is surprising and unexpected.

Using a dielectric barrier allows sufficient energy to be provided to convert CH4 into CO and H2O. The dielectric material is applied over the whole of the surface of either or both the cathode and anode. In various examples, the dielectric portion uses quartz as the dielectric material, but other materials, such as alumina can also be used.

In some examples, the anodes are metallic meshes. When the anodes are metallic meshes, in various examples, the dielectric portion is coated on to the mesh so as to maintain the mesh structure. In other words, the dielectric coating is provided with apertures that align with apertures in the mesh.

There are examples where the anode(s) and cathode(s) are flat plates that face one another with a dielectric material between them (such as coated on each anode). In some of those examples, the plates are able to be mounted in an upright (such as vertical) position to prevent plugging with particulate matter. The rows of plates are supported by a mechanical structure and suspended by insulators from the top of the casing so that the plane of the plates is able to be parallel to the flow direction of the flue gas within a casing in which the plates are located. In this manner, a maximum amount of the flue gas is treated by the electrical discharge with a minimum pressure drop across the apparatus. In some examples, a plurality of rows of plates are mechanically fastened together, one on top of the other, to form a stack that reaches substantially from the top to the bottom of the casing.

Although flat plate anodes and cathodes configuration can be a preferred arrangement in some examples, different arrangements are also possible. Such arrangements include cylindrical cathode electrodes and flat plate anode electrodes, and cylindrical cathode electrodes centred in the middle of cylindrical anode electrodes. In various of these example arrangements, the cathode electrodes and anode electrodes have identical construction (with, for example, one set of electrodes having one or more electric field intensifying structures thereon and the other set of electrodes having dielectric portions thereon).

In some examples, a coaxial tube-style reactor arrangement is used. In several examples using a coaxial tube-style reactor arrangement, one electrode is provided by a conductive tube, a centre electrode is secured inside along the central longitudinal axis of the conductive tube, and a dielectric material is disposed between them within the tube. In various examples, the tubes are arranged in tube bundles.

When there are multiple tubes or tube bundles, the actual number of bundles stacked on top of each other and side by side is, typically, an engineering decision made dependent on the requirements of the system for which apparatus is to be used. In some of those examples, a plurality of coaxial electrode tubes is secured in a spaced relationship to each other typically using a rectangular structure. Various examples include wire electrodes secured inside the coaxial electrodes along the central longitudinal axes of the tubes. Although the term “wire” is used, these electrodes can instead be rods, or other shaped material smaller than the inside diameter of the tubes.

Coaxial reactors have improved performance of dielectric barrier electrical discharge over flat plate electrodes. This is because it is typically easier to establish a barrier discharge within the whole discharge area in a coaxial reactor than flat plate reactor. Additionally, temperature gradients between the top and bottom of a flat plate reactor often provide inhomogeneous reactions, which decrease reactor efficiency. This is because in flat plate reactors the discharge causes the top of a plate to be hotter than the bottoms and the middle is hotter than the sides. Coaxial reactors, on the other hand, tend to “light off” (i.e. generate discharge) more evenly throughout the whole tube as soon as temperature and power requirements reach the threshold for the particular reactor geometry. This makes the reaction more homogenous. The result of this is that more gas is exposed to the barrier discharge, meaning more gas is treated.

Before passing through the apparatus, the gas may be pre-treated. For example, the gas may pass through an electrostatic precipitator to remove particulate material. The gas may also be cooled, for example using a heat exchanger or by spraying or atomising cold water or another liquid or solution through it.

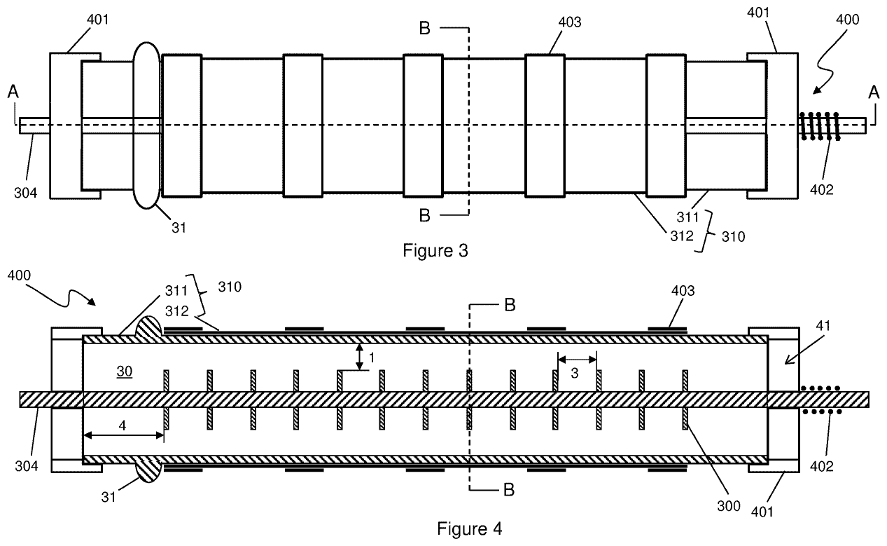

FIGS. 3 and 4 show an example device, generally illustrated at 400, according to an aspect disclosed herein. This provides a staged DBD device in the form of a coaxial reactor.

The example staged DBD device 400 includes a first electrode 304 and a second electrode 310, which has a dielectric barrier 311 and conducting material 312. In the example shown in FIGS. 3 and 4, the dielectric barrier is a cylinder, specifically, in this example, a straight, hollow, circular cylinder that is open at opposing ends. This provides a chamber 30 inside the dielectric barrier. In use, a gas or gas stream is able to pass into and/or through the cylinder. In other examples, the cylinder may be a different shape and may be non-straight and/or at least partially filled.

The conducting material 312 is provided around the outside of a portion of the dielectric barrier cylinder 311. In some examples, this is provided around the whole circumference of the cylinder. In other examples, the conducting material is able to be provided around only a portion of the circumference of the cylinder.

In some examples, the conductive material 312 extends along the whole length of the dielectric barrier cylinder 311. However, in the example shown in FIGS. 3 and 4, the conductive material is located along only a portion of the length of the dielectric barrier cylinder. This portion is approximately in the middle of the cylinder.

For various examples, the conductive material 312 is a coating on the dielectric barrier cylinder 311. This is therefore intended to be irremovably attached to the cylinder. In the example shown in FIGS. 3 and 4, the conductive material 312 is a separable component. In order to hold the conductive material in place, a plurality (in the case of the example shown in FIGS. 3 and 4, five) constant force springs 403 in the form of rings are located around the conductive material with one at each end of the conductive material and the others evenly distributed along the length of the conductive material.

In the example shown in FIGS. 3 and 4, the first electrode 304 is an elongate rod. The rod has a circular cross-section in this example and is located through the chamber 30 of the dielectric barrier cylinder 311. This means that at least a portion of each of the first electrode and conductive material 312 are aligned along the length of the cylinder.

The first electrode 304 has a plurality of discharge nodes 300 arranged along at least a portion of its length. In the example shown in FIGS. 3 and 4, the discharge nodes are arranged along the portion of the length of the first electrode that is aligned with the conductive material 312.

In addition to the first electrode 304, associated discharge nodes 300, dielectric barrier cylinder 311, conductive layer 312 and constant force springs 403, the example staged DBD device shown in FIGS. 3 and 4 includes end cups 401. There is an end cup fit to each end of the cylinder. In the example shown in FIGS. 3 and 4, the end cups are also circular with an interior of the rim 42 of each cup fitting around the outside of the cylinder.

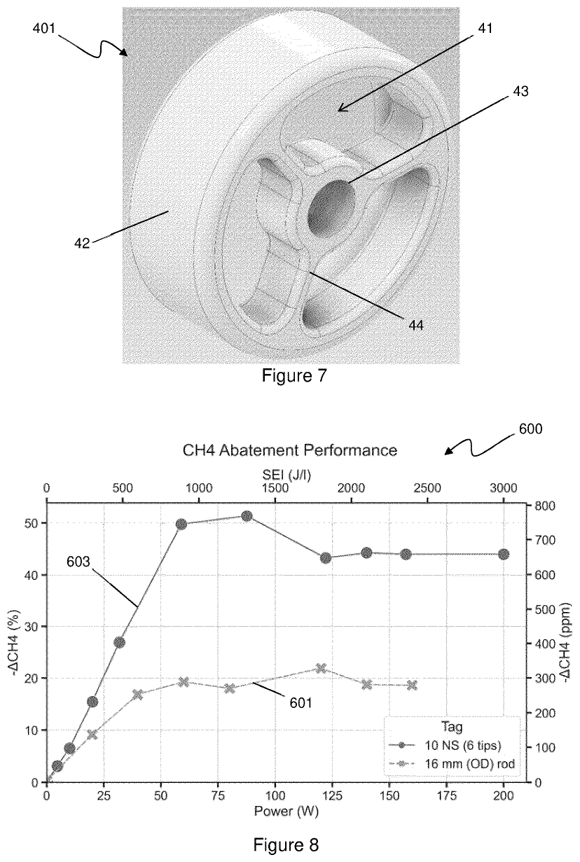

As set out in more detail below in relation to FIG. 7, between the rim 42 and hub 43 of each end cup 401, there are passages 41. The passages are intended to allow gas to flow through the end cups.

The end cups 401 are included to provide a component to hold the first electrode 304 in position relative to the dielectric barrier cylinder 311 and conductive material 312. This is achieved by the first electrode being at a hub 43 of each end cup. The hub is located at the centre of each end cup. As such, the first electrode is held in the centre of the cylinder by the end cups. This causes the longitudinal axis of each of the first electrode, cylinder and conductive material to align, and, indeed, to be coaxial.

In the example shown in FIGS. 3 and 4, one end of the first electrode 304 is in direct contact with one end cup 401. In FIGS. 3 and 4, this end of the first electrode is shown extending beyond the end cup. In other examples, the end of the first electrode is aligned with or located at this end cup. Regardless of the relative placement of this end of the first electrode and end cup, in some examples, the contact is a fixed contact with this end of the electrode being held in place by the end cup.

At the opposite end of the first electrode 304, there is a connection with the other end cup 401. Instead of direct contact between the first electrode and end cup, the connection at this end of the first electrode is provided by indirect contact. This is due to a compression spring 402 being connected between the first electrode and the end cup. Other types of springs are used in other examples.

The compression spring 402 connecting one end of the first electrode 304 and one end cup allows for the length of the first electrode to change relative to the length of the dielectric barrier cylinder due to, for example, thermal expansion. This lowers the likelihood of one or both end cups being pulled off the cylinder due to thermal expansion of the first electrode.

In the example shown in FIGS. 3 and 4, there is a collar 31 forming part of the dielectric barrier cylinder 311. This collar is located adjacent an end of the conductive material 312. As such, the collar is offset from the proximal end of the cylinder. The collar provides a ring projecting radially outwardly from the cylinder and having a larger outer diameter that the rest of the cylinder.

The collar 31 is located at an opposite end of the dielectric barrier cylinder 311 to the end at which the compression spring 402 is provided in some examples. In various examples, as shown in FIGS. 3 and 4, the collar is located at an axial offset from the end of the cylinder to which it is closest.

In several examples, the staged DBD device 400 is arranged in an upright orientation with the length of the first electrode 304 aligning a vertical or upright axis. In some such examples, the collar 31 is located at a lower end of the dielectric barrier cylinder 311. The example staged DBD device is held in position by passing a lower end through a circular hole in a plate or grill. In these examples, the collar rests against the plate stopping movement of the staged DBD device through the hole under gravity. In various examples, the opposing end of the staged DBD device is placed through a similar hole to help secure the position of the staged DBD device. In use, a number of staged DBD devices are able to be arranged next to each other to form a cartridge of staged DBD devices.

In an upright orientation, the collar 31 provides a surface against which the conductive material 312 and at least one constant force spring 403 are able to rest. This also helps hold the conductive material in place.

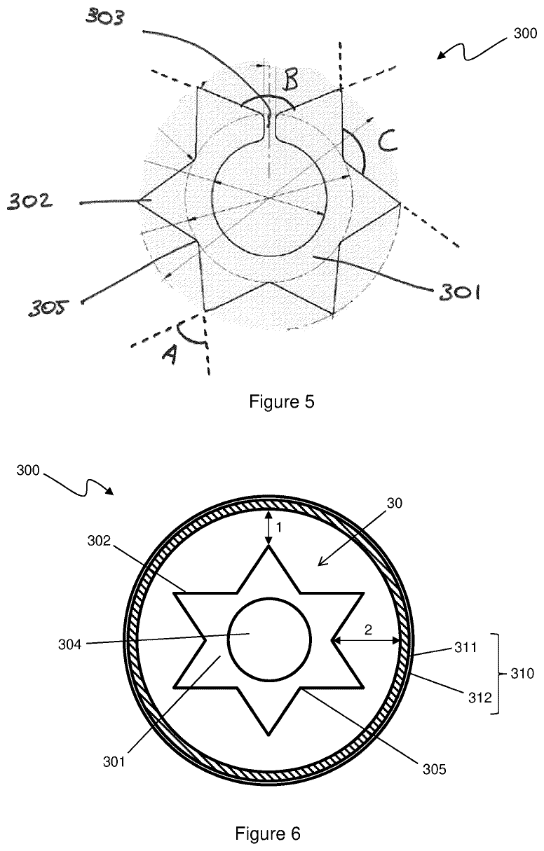

The staged DBD device 400 is able to be connected to a power source, such as a drive circuit as disclosed in WO 2022/106622, including specifically as disclosed in the claims or any one of FIGS. 5 to 7 of WO 2022/106622. When connected to a power source, one of the first electrode 304 and the second electrode 310 is a high voltage electrode and the other is a low voltage electrode. In various examples, the first electrode is the high voltage electrode and the second electrode is the low voltage electrode. As set out in more detail below, discharge occurs between the electrodes under suitable circumstances. This discharge is intended to only occur at the discharge nodes 300 arranged along a portion of the first electrode.

As shown in FIG. 4, in various examples a creepage distance 4 is provided between the end most discharge node 300 at each end of the portion along which the discharge nodes are located and the end of the dielectric barrier cylinder 311 nearest the respective discharge node. This is provided to minimise discharge in this region to limit shorting that this would cause.

Turning to details of an example discharge node, an example discharge node is generally illustrated at 300 in FIG. 5 in the form of an electric field intensifying structure. This example electric field intensifying structure comprises a ring 301 and at least one tip 302. It will be understood that although six tips are shown in FIG. 5, the structure requires only one tip to operate.

In use, the ring 301 is arranged around a first electrode 304. This may be achieved by means of a slot or channel 303 which allows the electric field intensifying structure 300 to be deformed to fit securely around a first electrode. Other means of arranging the ring around the first electrode are possible. For example, the first electrode may be integral with the structure. Such a structure could be formed for example by cutting or milling a material.

It can be seen that the at least one tip 302 extends along a radial axis passing through the centre of the structure 300. In use, and as set out below, the tip limits the minimum distance between the structure and an opposing electrode. That is, the tip effectively creates a region where the distance between the opposing electrode and the structure is smaller than it would be in the absence of the tip. In practice, this is can be achieved by using a cylindrical opposing electrode.

In some examples, such as the ones shown in the Figures, the discharge nodes 300 comprise a plurality of tips 302 arranged on an (radially) outer edge of the ring 301. The plurality of tips could be distributed on the outer ring in any suitable way. However, it may be advantageous for each of the plurality of tips 302 to extend along a respective radial axis. By this, we intend to mean that each of the tips 302 extends in a unique radial direction (radial directions separated by 180 degrees of rotation still being considered unique to each other). Typically, none of the tips 302 will extend along the same radial axis as the channel 303, since the channel 303 creates a break in the material of the ring 301.

The plurality of tips 302 of the example discharge node shown in FIG. 5 are uniformly distributed on the outer edge of the ring 301. By this, we intend to mean that the plurality of tips 302 is uniformly distributed on the material of the outer edge of the ring. This may therefore exclude the channel 303. A uniform distribution of tips 302 is effective for ensuring that as much of the gas passing through a discharge device has a chance of being treated. In other words, uniformly distributed tips may overcome issues that arise from tips being crowded together.

As set out above, in various examples, the channel 303 allows the structure 300 to be fitted on a first electrode in use, and counters issues that may arise due to thermal expansion or contraction. The channel extends from the centre of the ring 301 to the exterior of the ring 301 along a second radial axis. The second radial axis is not aligned with the at least one tip 302. When the structure 300 comprises a plurality of tips, the channel 303 is not aligned with any of the tips' respective axes. That is to say, the channel 303 does not overlap any of the tips.

In some examples, the channel 303 has a width of 1 mm, and, typically, the channel 303 has a width of 0.8 mm. As regards the ring 301, in various examples, the ring 301 has a main body to which the at least one tip 302 is connected to. It follows that in the multi-tip case, each of the tips will be connected to the main body. The main body has a radial thickness, which, in several examples is 3.6 mm. In other examples, the radial thickness of the main body of the ring 301 is 3.56 mm or 3.46 mm, or is any value in the range between 3.46 mm and 3.56 mm.

Further, the surface of the ring may be continuous. By this, we intend to mean that the material forming the ring is solid, without any gaps passing through the ring in the axial direction. For completeness, in examples where the structure includes a channel, then the channel is separate to the ring and does not form part of the solid surface of the ring.

The radial thickness of the main body may also be expressed as a percentage of the radius from the centre of the ring 301 to the outer edge of the ring. In some examples, the radial thickness of the main body accounts for between 55% to 65% of the radius from the centre of the ring to the outer edge of the ring. A more specific range is the radial thickness of the main body accounts for between 60.2% to 62.2% of the radius of the ring.

The inner diameter of the ring 301, in various examples is 7.9 mm, such as 7.90 mm, and, in some examples, has a tolerance of negative 0.1 mm, such as 0.10 mm. In combination with the radial thickness of the main body, the main body then has an outer diameter of 11.5 mm, such as 11.46 mm, in a number of examples.

In some examples, each tip 302 extends the outer diameter of the ring at the point of each tip to 18.0 mm, such as 18.00 mm. This means that each tip, typically, has a height in a radial direction between its point and its radial closest point on the main body of the ring of 6.5 mm, such as 6.54 mm. These sizes can vary between examples, but typically the ratios of these dimensions or similar ratios may continue to be applicable.

As can be seen from the example shown in FIG. 5, at least one tip, and typically more than one tip, such as all the tips, comprises two (typically straight) sides which meet at a point. The point is a sharp point in some examples. The sharpness of the point may be understood in terms of the angle at which the two sides meet. In various examples, the two sides of the at least one tip 302 meet at a first angle, marked as A in FIG. 5, of 68.9 degrees (°), such as at an angle of 68.89°.

It has been discussed that a plurality of tips may be especially effective in neutralising a pollutant. In some examples, the plurality of tips is six tips. The 6 tips may be uniformly distributed, as discussed above.

By stating that the plurality of tips is 6 tips, this could mean that the plurality of tips comprises 6 tips. That is, there are at least 6 tips.

However, other examples are envisioned in which the plurality of tips consists of 6 tips. That is, the ring 301 of structure 300 may have exactly 6 tips, only 6 tips, or 6 tips only.

In examples where the discharge nodes 300 include a plurality of tips and a channel 303, then the second radial axis, that is, the axis along which the channel 303 extends, bisects a second angle being measured between adjacent sides of two adjacent tips on either side of the channel 303. The second angle, marked as B in FIG. 3, is measured between the two adjacent sides of the two adjacent tips. In various examples, the second angle is 135.6°, such as 135.63°.

In the case where the discharge nodes 300 comprise a plurality of tips 302, then a third angle measured between adjacent tips, except for the second angle already discussed, is, in some examples, 127.6°, such as 127.55°. This is shown as angle C in FIG. 5.

In some examples, such as is shown in FIG. 5, the space between adjacent tips 305 is rounded. This can assist in avoiding creation of additional breakdown sites. This region 305 between adjacent tips has a radius of curvature, and the radius of curvature is 0.5 mm in a number of examples. The space between the channel 303 is also rounded for the same reason in various examples.

The discharge nodes 300 also have a thickness in the axial direction. The axial thickness is 1 mm in some examples, such as 1.0 mm. The competing factors in determining the axial thickness of the structure are structural integrity and manufacturing cost. A 1 mm thick structure meets a requirement of structural integrity without leading to excessive manufacturing costs. Further, this allows for the number of discharge nodes to be maximised for the space available in the staged DBD device 400.

Turning to FIG. 6, an example discharge node 300, in form of an electric field intensifying structure, is shown together with a first electrode 304 and an opposing, second, electrode 310. The ring 301 is arranged around the first electrode 304, and the first electrode 304 has a circular cross-section. As set out above, the dielectric barrier cylinder 311 provides a support that is surrounded by the conducting material 312.

FIG. 4 illustrates that the presence of at least one tip 302 limits the minimum gap between the discharge node 300 and the opposing electrode 310. It can be seen that the minimum distance 1 (also identified in FIG. 4), between the end of the tip and the opposing electrode 310 is smaller than the maximum distance 2 between the opposing electrode 310 and a location on the discharge node which is devoid of a tip.

In some examples, the size of the minimum distance 1, which is the gap between the sharp point of a tip 302 and the opposing electrode 310, is 8 mm.

Now considering the end cups, one of which is generally illustrated at 401 in FIG. 7. As set out above, this has a rim 42 and a hub 43. The hub is held in place in the centre of the rim by spokes 44.

In the example shown in FIG. 7, there are three spokes. While in other examples there may be a different number of spokes, we have found that three spokes provide a balance between providing the largest possible space for the passages 41 (i.e. minimising area blockage), being structurally sound in view of vibrations the end cups can experience in use and minimising the amount of material used.

The three spokes 44 are evenly spread around the rim 42 and hub 43. This allows loads to be evenly distributed between the spokes.

To allow the first electrode 304 to pass through the hub 43, in various example, the hub has a bore (such as a through-bore) in it. In some examples, the bore in one end cup is a blind bore. The bore typically has a diameter of 8.1 mm, such as 8.10 mm.

The end cups, in several examples, have a depth (so a distance between opposing faces) of 18 mm, such as 18.0 mm or 18.00 mm. One face has a recess which is encircled by a thin section of rim 42. The recess has a depth of about 8 mm, such as 8.0 mm or 8.00 mm. The recess is provided as a portion of the end cup into which an end of the dielectric barrier cylinder 311 is able to be positioned when the staged DBD device 400 is assembled.

In some examples, the end cups are made of green alumina. This material is used because it is electrically insulating to some degree and has a similar thermal expansion coefficient to the dielectric barrier cylinder 311.

The end cups 401 are typically machined. However, these can be fabricated by some other means.

In various examples, the dielectric barrier is a quartz glass, which is typically transparent. In some examples, the first electrode 304 is stainless steel, such as 316L stainless steel. In several examples, the conducting material 312 is a foil, such as a machined foil. This may be an aluminium foil or stainless steel foil. Should the conducting material be provided as stainless steel, this is typically 316L stainless steel. Some example electric field intensifying structures 300 are stainless steel, such as 316L stainless steel. The constant force springs are a nickel-chromium based alloy such as Inconel®, for example, Inconel® X750 (and alloy containing Al, C, Co, Cr, Cu, Fe, Mn, Nb, Ni, S, Si and Ti).

In some examples, the first electrode 304 is about 875 mm long and has a diameter of about 8 mm. The material and dimensions of the first electrode 304 and how the first electrode is held by the end cups 401, mean that the bend radius of the first electrode is maintained within tolerance over its length. In various examples, this tolerance is a bend causing a maximum deviation in the rod of up to 1 mm from a straight line.

There are examples where the dielectric barrier cylinder 311 is about 800 mm long and has an outer diameter of about 38 mm with an inner diameter providing the wall(s) of the chamber 30 of about 34 mm. In various examples, the collar 31 has a side proximal to the nearest end of the cylinder located about 45 mm from the nearest end of the cylinder. The opposite side of the collar is at about 51 mm from the nearest end of the cylinder.

Typically, the conductive material 312 is about 690 mm long. In some examples, this is a ground foil, which has been found to be more reliable than a mesh material or coating. Only five constant force springs are used as a balance between what is manufacturable from the material from which these are made, the additional weight extra material provides and the ability to hold the conductive material in place, such as against the dielectric barrier cylinder 311.

As set out above, with the discharge nodes 300 typically having a maximum diameter of about 18 mm, in some examples, that provides a minimum distance 1 of about 8 mm from the closest point of each electric field intensifying structure to the dielectric barrier cylinder. As set out below, we have found that a discharge node separation distance 3, as indicated in FIG. 4 as the distance between two adjacent discharge nodes, of about 15 mm, such as 15.0 mm or 15.00 mm is optimal.

The creepage distance 4 as referred to above, is between about 50 mm and 60 mm, such as 58 mm (including 58.0 mm or 58.00 mm) or 51 mm (including 51.0 mm and 51.00 mm). The creepage distance can be different for the two ends, such as being 58 mm at one end and 51 mm at the other end.

Turning to the use and functionality of staged DBD device 400, it is intended that gas is passed through the staged DBD device. On application of an electric field between the first electrode 304 and the conductive material 312, an intention is to remove constituents of the gas being passed through the staged DBD device. This is achieved by providing an electric field at or above a threshold strength and/or providing a potential difference at or above a threshold value between the first electrode and conductive material, to instigate dielectric barrier electrical discharge. The threshold is achieved in some examples by providing a pulsed signal, such as the pulsed power disclosed in WO 2022/106622, and as set out in more detail below. Once the threshold is reached, the one or more discharge nodes cause electrical discharges to be produced only at one or more of these staged points in the device.

The specific threshold values to cause discharge are determined by the particular geometry and dimensions of the staged DBD device 400 being implemented. However, by having a staged DBD device, with the stages provided by the discharge nodes 300, electrical discharge is focused at the discharge nodes, meaning electrical discharge is produced only at intervals along the device. The reason for this is that the discharge nodes cause inhomogeneity in the electric field by providing locations where the electric field is intensified, lowering the power needed to initiate discharge. In other words, the discharge nodes produce a heterogenous volumetric distribution of electrical discharge. This results in peak plasma densities at these periodic points in the device. This provides ionisation regions.

As set out above, plasma is generated in the ionisation regions. Between the ionisation regions, and adjacent ionisation regions where there is no discharge node 300 adjacent another ionisation region, such as at an end of the portion of the first electrode 301 along which the discharge nodes are arranged, there are recombination regions.

As gas passes through the staged DBD device 400, the active species in the plasma in the ionisation regions cause constituents in the gas to break down. These reactions continue in the recombination regions where the plasma also recombines over the length of the recombination regions.

Since the discharge nodes 300 project radially outward into the chamber 30 from the surface of the first electrode 301, they provide a partial blockage along the dielectric barrier cylinder 311. This induces back pressure in the gas, slowing the flow of gas. However, we have found that by applying the ratios of discharge node outer diameter, tip shape and arrangement and inner diameter of the cylinder, an optimal balance is struck between back pressure and gas constituent removal.

We have tested the performance of a staged DBD device according to an aspect disclosed herein against other comparable configurations. The results of this testing are set out in FIGS. 8 to 13. Using a replicated composition of exhaust gas from an LNG-fueled engine with multiple pollutants, multiple tests were run.

The composition included approximately:
Methane (CH4): 1500 ppmv
Sulphur dioxide (SO2): 20 ppmv
Carbon monoxide (CO): 185 ppmv
Nitrous oxides (NOX): 165 ppmv
Carbon dioxide (CO₂): 4%-vol
Oxygen (O2): 14%-vol
Water steam (H2O): 10%-vol
Nitrogen (N2): Remaining balance to provide 100%

This composition, while representative of exhaust gas from an LNG-fueled engine, has a significantly lower concentration of methane (due to it being in a ppmv range, such as up to 10,000 ppmv, up to 5,000 ppmv, 2,500 ppmv or 2,000 ppmv). This means removal of methane at such a low starting level is not be expected or even attempted using known techniques and systems. First considering FIG. 8, however, this provides a chart 600 illustrating methane abatement achieved in a discharge device with different configurations using the power supply disclosed in WO 2022/106622 as a power source. This power supply is also used for generating the data for the later plots, and, unless stated otherwise, the same setup and conditions were used when generating the results for each plot Graph 600, in FIG. 8, shows three data sets relating to variations in methane abatement versus power and specific energy input (SEI) for different configurations of the first electrode discussed above. In the graph shown in FIG. 8, the line 601 marked by crosses shows how methane abatement varies with power when the first electrode is formed as a rod with a diameter of 16 mm. It will be noted that this is twice the typical size of diameter of the first electrode as discussed above in relation to FIG. 4, however the size of the gap between the first electrode and the opposing electrode is the same as in the configuration with electrode with electric field intensifying structures.

Line 603 shows how methane abatement varies when a discharge device is provided with 10 discharge nodes, each with 6 tips as set out above in relation to FIG. 5. It can be seen that the electric field intensifying structures outperform the rod with 16 mm diameter by having a higher methane abatement at the same power and SEI.

Chart 600 demonstrates a proof of the concept that the electric field intensifying structures can outperform alternative configurations. This is because methane, which is an important component to remove, can be effectively removed from the gas composition by applying this arrangement.

Using the same gas mix and power supply parameters as set out above, different diameters of the dielectric barrier cylinder 311 were also tested. The distance between the discharge nodes 300 and the interior diameter of the cylinder was maintained using discharge nodes with 12 tips.

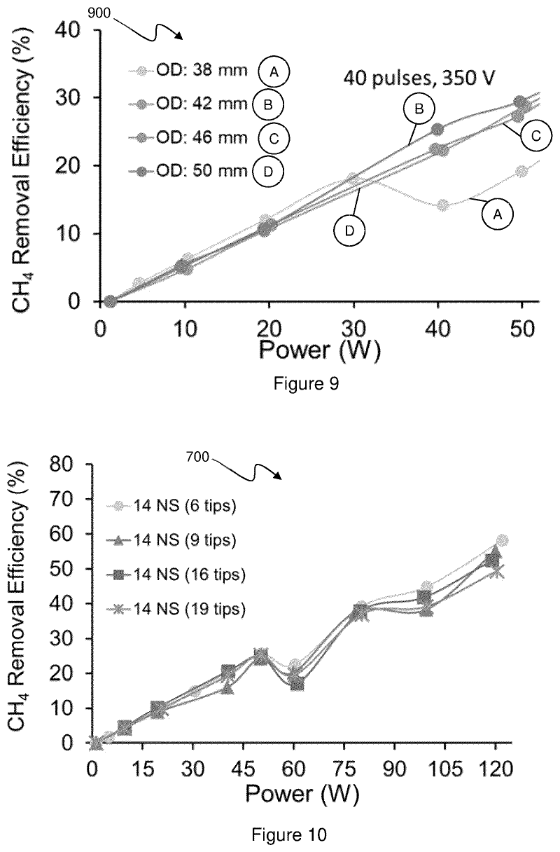

FIG. 9 shows a chart 900 shows four data sets relating to variations in methane removal efficiency versus power. The four data sets are different outer diameters (ODs) of 38 mm (marked “A”), 42 mm (marked “B”), 46 mm (marked “C”) and 50 mm (marked “D”) of the dielectric barrier cylinder. From the chart, it can be seen that at a power of 30 W and lower, all the cylinder sizes perform similarly. In this power range, the OD 38 mm cylinder performed marginally better than the other diameters investigated. However, at powers larger than 30 W, this slight enhanced performance drops with the OD 38 mm cylinder performing noticeably worse than the other OD diameters tested.

Considering number of tips on each discharge node 300, FIG. 10 shows chart 700. The efficiency of methane removal for variants of the discharge nodes with differing numbers of tips is shown in FIG. 10. The same gas mix and power supply parameters as applied for the test for which the results are shown in FIG. 9 were used for the test for which the results are shown in FIG. 10.

FIG. 10 shows chart 700 of how methane abatement efficiency varies with power for discharge nodes with varying numbers of tips. In particular, discharge nodes with 6, 9, 16 and 19 tips were tested. Notably, the 6-tip variant outperforms all other variants from about 50 W and more noticeably from 100 W. The 6-tip variant exhibits particularly high efficiency at around 120 W, achieving a methane removal efficiency of about 60%, which is about 5% higher than the next most efficient variant. Below 50 W all varieties of discharge node have a relatively similar performance, except for the 9 tip variety, which drops below the performance of the others at about 40 W.

In sum, FIG. 10 show that, at most operating powers tested, the number of tips the discharge node provides little difference to the efficiency of methane abatement, but at powers between 80 W and 120 W, the 6-tip variant outperforms all other variants.

Based on the results shown in FIG. 10 for the 6-tip variant it was anticipated higher plasma energy per streamer in this variant was proposed to trigger higher methane removal efficiency. To test this, a 6-tip variant was compared to a 3-tip variant using the same gas mix as set out above and power supply parameters the same as set out above in relation to FIG. 8.

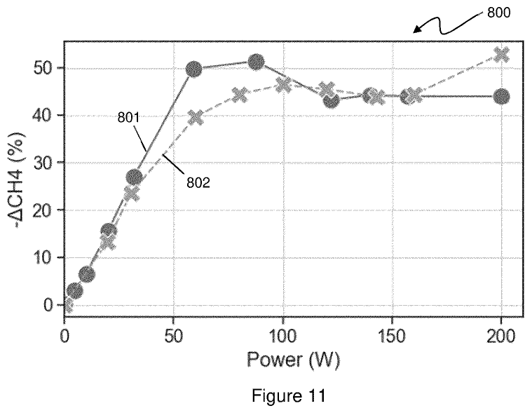

The results of this test are shown in chart 800 of FIG. 11. The chart 800 illustrates how methane abatement performance varies with power for structures with 6-tips and structures with 3-tips. It can be seen that the 6-tip variant, represented by line 801, outperforms the 3-tip variant, represented by line 802, between 0 Watts and 100 Watts. Between 100 Watts and 160 Watts they perform approximately equally, and between 160 Watts to 200 Watts, the 3-tip variant outperforms the 6-tip variant.

Chart 800 show that increasing the energy of the formed streamers doesn't necessarily affect methane removal. As such, the amount of methane removal is higher for 6-tip ninja stars. Further, we found that the sharpness of the tips has no significant influence on the performance under the conditions applied during the tests.

In addition to assessing the optimum number of tips on each discharge node, the number and separation of discharge nodes over a set length were also considered. First considering separation of discharge nodes over a set length, discharge nodes were arranged on a first electrode 304 with distances of 8 mm, 16 mm and 32 mm between adjacent discharge nodes. The discharge nodes were arranged over an electrode length of 224 mm.

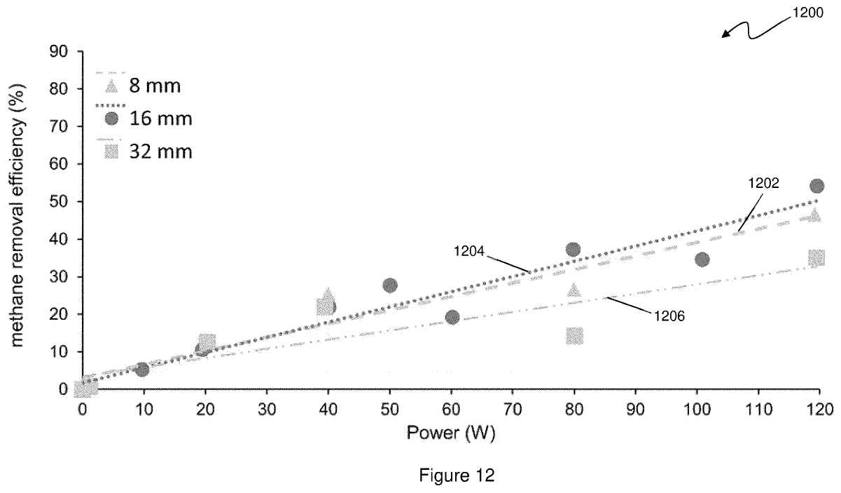

The 6-tip variant of the discharge node was used. FIG. 12 shows a chart 1200 showing the results of this assessment in terms of power against methane removal efficiency. The discharge nodes with an 8 mm separation are represented by line 1202, discharge nodes with a 16 mm separation are represented by line 1204, and discharge nodes with a 32 mm separation are represented by line 1206. Generally, it can be seen from FIG. 12 that the 16 mm and 8 mm separations are the most effective. However, there is not a noticeable difference in performance by changing the distance between the discharge nodes, since the standard deviation on all points in chart 1200 of FIG. 12 is less than 5%. With that noted though, the distance of 16 mm between the discharge nodes results in slightly higher methane removal and the production of less nitrogen-containing products (NOx and N2O). These assessments were repeated at different power supply parameters and 330C and a similar trend was observed, confirming that there is no interaction between the discharge node separation distance and temperature or power supply parameter.

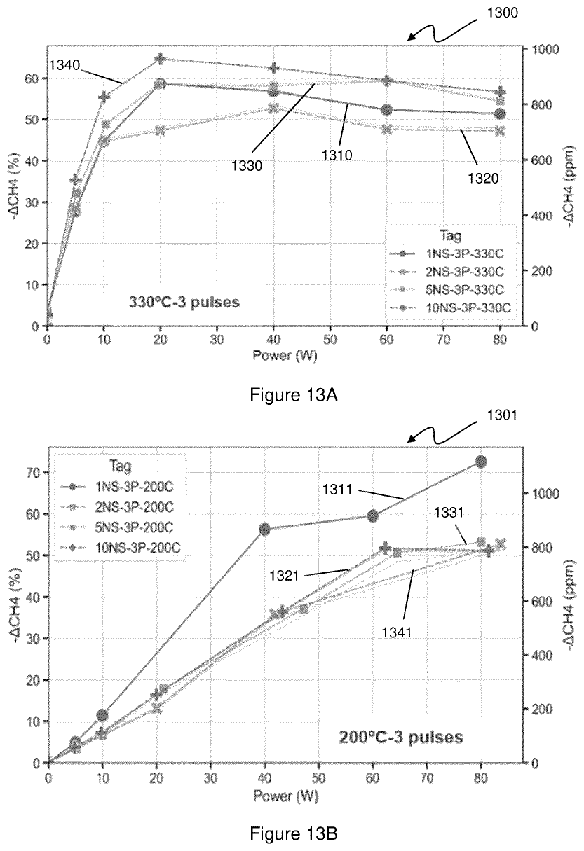

The volume of the region over which the discharge nodes are arranged and the gas residence time is anticipated as being two important parameters which are expected to affect the lifetime and number of active species for methane removal. This is particularly relevant in larger scales where the gas flow rates are significantly high, and the role of gas residence time is critical. To simulate the conditions at larger scales, we decreased the number of discharge nodes to have lower gas residence times in an ionisation zone and to investigate its impact on methane removal. This was assessed at two different temperatures (200° C. and 330° C.) to cover the temperature range in which the device may operate in some examples, and the results are shown in charts 1300 and 1301 in FIGS. 13A and 13B.

The charts 1300 and 1301 in FIGS. 13A and 13B show power against methane removal efficiency in percentage and ppm. The charts show results of four variations of the assessment set-up. These are, in each chart, a line 1310, 1311 for one discharge node, a line 1320, 1321 for two discharge nodes, a line 1330, 1331 for five discharge nodes and a line 1340, 1341 for ten discharge nodes. Each assessment is run using the same power supply parameters and with the chart of FIG. 13A showing the results for runs conducted at 330° C. and the chart of FIG. 13B showing the results for runs conducted at 220° C. using discharge nodes with 6 tips.

With a standard deviation of less than 5% on each point in the charts 1300, 1301 in FIGS. 13A and 13B, these show methane removal is highly dependent on temperature and slightly on the number of discharge nodes. Higher temperatures trigger almost double methane removal at powers lower than 30 W across all discharge node numbers. Generally speaking, the larger number of discharge nodes slightly improves the methane removal at 330° C. but does not influence the performance at 200° C. except in relation to a single ninja star. The charts reveal an exceptional behaviour which needs to be studied further. However, a possible explanation is the formation of high-energy plasma streamers on the tips of a single discharge node. Regarding the standard behaviour, at 330° C., the methane removal is generally flat across all discharge node numbers at powers above 20 W with the removal efficiency having increased between 0 Wand 20 W. This chart also shows that, across the whole power range, the larger the number of discharge nodes, the higher the efficiency rate. At 200° C., the removal efficiency for all the single discharge node arrangements is grouped together across the approximately 80 W power range assessed. This removal efficiency is generally linear and has an upwards gradient between 0 W and 80 W. The single discharge node at 200° C. has a steeper gradient and peaks at an efficiency difference between the single discharge node and the other numbers of discharge nodes of more than about 20% difference with a removal efficiency of above 55% for the single discharge node and less than 35% for the other discharge node numbers.

From the assessments conducted, optimum conditions allow the staged DBD device to be operated at low powers while still being effective at methane removal. These conditions are a gas temperature of about 330° C., six tips per discharge node and as many discharge nodes as possible in the length available.

These are the optimum conditions without the use of any catalyst. In some examples, the staged DBD device is used together with a catalyst. The catalyst may take various positions in relation to, or within, the staged DBD device. For example, the catalyst can be positioned upstream (“pre-plasma”) of the staged DBD device, downstream (“post-plasma”) of the staged DBD device, or within (“in-plasma”) the staged DBD device. When the catalyst is positioned within the staged DBD device, the catalyst may be positioned in the ionisation region(s) and/or in the recombination region(s).

It is thought that by using the staged DBD device together with a catalyst, further improvements are achieved. For example, lowering the power and voltage needed to establish electrical discharge while allowing CH4 to be removed from gas. Furthermore, when the staged DBD device is used together with a catalyst, the overall efficiency is increased.

The staged DBD devices is compatible with a variety of different catalysts, and there is familiarity with suitable catalysts. These may include constituents such as one or more of cobalt, rhodium, iridium, nickel (such as nickel oxide), copper, palladium, platinum, silver, gold, manganese, aluminium, vanadium (such as vanadium oxide), chromium (such as chromium trioxide), zinc (such as zinc oxide), titanium (such as titanium dioxide) and tungsten (such as tungsten trioxide). The catalyst may be a composite material comprising CuO and MnO, or, Al2O3 and CuZnO.

Typically, if used or present, the catalyst is palladium or platinum on account of these displaying particular efficiencies with methane removal.

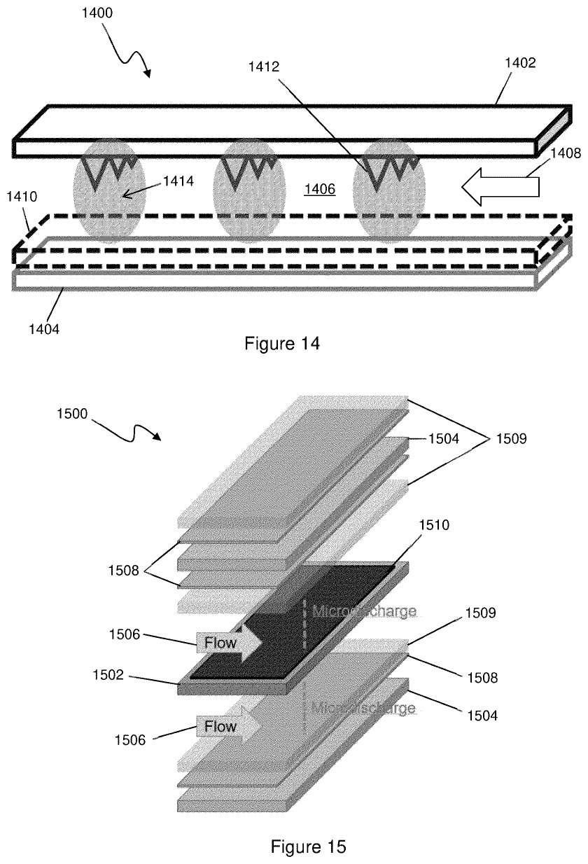

FIGS. 2 to 7 generally discuss a coaxial staged DBD device. The principles of that also apply to other forms of staged DBD devices. One such form those principles apply to is plate based staged DBD devices. FIGS. 14 to 17 generally relate to such plate based staged DBD devices.

Generally illustrated at 1400 in FIG. 14 is a staged DBD device based on plates. This has a first plate electrode 1402 and a second plate electrode 1404 separated by a chamber 1406. The chamber provides a gas flow path 1408 along which gas is able to pass in use.

A dielectric barrier 1410 is located on the second plate electrode 1404 on the chamber side of the second plate electrode. The first electrode has discharge nodes 1412 spaced at regular intervals along the length of the gas flow path 1408. These are typically (micro) needles in an array.

In use, the first electrode 1402 is arranged, in the example shown in FIG. 14, to be the high voltage electrode, and the second electrode 1404 is arranged to be the corresponding low voltage electrode. Under suitable conditions when an electric field is established between the electrodes, dielectric barrier electrical discharge occurs. Due to the positioning of the discharge nodes, ionisation regions 1414 are generated at the discharge nodes and there are recombination regions adjacent to each ionisation region.

The staged DBD device 1400 of the example shown in FIG. 14 is able to be connected to a power supply in a similar manner to how the examples above are connected to a power supply. This is typically what establishes the electric field between the electrodes and provides the appropriate conditions for discharge to occur.

FIG. 15 shows a second example plate based staged DBD device 1500. Instead of having two electrodes as shown in the example of FIG. 14, this has a first plate electrode 1502 located between two second plate electrodes 1504. The first plate electrode is separated from the second plate electrodes providing a chamber therebetween, through which is provided a gas flow path 1506.

The second electrodes 1504, in the example shown in FIG. 15, have a first dielectric layer 1508 and second dielectric layer 1509 located in a stack thereon between the respective second electrode and the first electrode 1502. The first electrode has discharge nodes 1510 arranged thereon.

In use, the second example plate based staged DBD device 1500 is able to be provided with power from a power supply as set out above in order to establish an electric field between a high voltage electrode and a low voltage electrode. In the example shown in FIG. 15, these are respectively provided by the first plate electrode 1502 and the second plate electrodes 1504. In suitable conditions, dielectric barrier discharge is establishable between the electrodes. This creates ionisation regions where discharge is generated and recombination regions therebetween to allow plasma with active species to be established and for that plasma to recombine. When gas is passed along the gas flow paths 1408, 1506 of the example plate based staged DBD devices 1400, 1500 of FIGS. 14 and 15, as with the examples described above, constituents of the gas are removed from the gas due to reactions being driven by the active species present. These examples are able to achieve the same general effect as those set out above in relation to coaxial staged DBD devices.

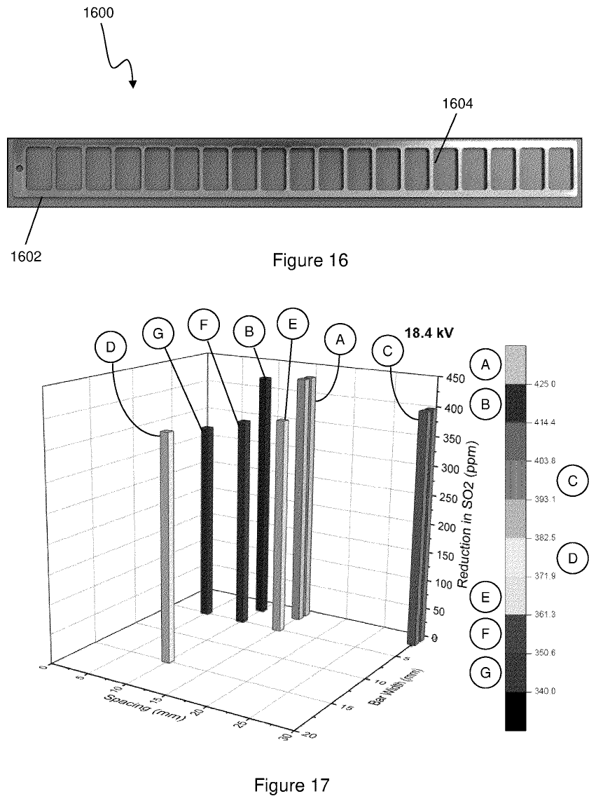

FIG. 16 shows an example high voltage electrode 1600 for a plate-based staged DBD device, such as those described in relation to FIGS. 14 and 15. This electrode has a ladder-like shape with side rails 1602 running the entire length of the electrode and bars 1604 spaced at regular intervals along the length of the electrode and attached to the side rails. In some examples discharge nodes are included on the bars, and in other examples, the bars provide the discharge nodes.

We have found that the width of the bars 1604 in the direction parallel to the length of the electrode 1600 and the spacing between the bars affects the quantity of constituents that can be removed from gas through use of the electrode in a plate-based staged DBD device. This can be seen from FIG. 17, which shows a chart 1700 indicating spacing between bars and bar width against a measure of the reduction of SO2 in ppm from gas passing through a staged DBD device including an electrode meeting the parameters shown.

It can be seen from FIG. 17, that minimising bar width to about 2 mm optimises the bar width for gas constituent removal. Further bar spacing of about 15 mm also optimises the bar spacing. In combination, this removes most SO2 with more than a 2.5% increase in SO2 removal over the next best bar width-bar spacing combination of 2 mm bar width and 10 mm bar spacing. Other combinations are shown in FIG. 17, with bar widths (bw) and bar spacing (bs) of 1 mm bw, 30 mm bs; 2 mm bw, 30 mm bs; 15 mm bw, 10 mm bs; 5 mm bw, 10 mm bs; and 5 mm bw, 5 mm bs. Between the most and least constituent removal, there is a 25% increase in the amount of constituent removal from the least to the most removal. This test was carried out using an electrode of 33 cm in length and 3.3 cm in width and a potential difference of 18.4 kiloVolts (kV) applied to establish an electrical field between the electrode and a low voltage electrode.

For purposes of identification, due to the colour originally being included in FIG. 17, the various bars on the plot are identified individually by letters “A” to “G”, which are identified against the scale on the right side of the plot.

Regarding the provision of a pulsed signal, such as the pulsed power disclosed in WO 2022/106622, in some examples and as set out above, when using the staged DBD device described above, a pulsed system is able to be used. This is intended to ignite dielectric barrier electrical discharge between electrodes in the device.

High-voltage pulsed-power equipment for industrial-scale DBD systems typically employ a low-voltage pulse generation unit with a 400 V to 1000 V peak output pulse voltage and a subsequent step-up transformer with 1:20 to 1:40 turns ratio to meet the required dielectric barrier electrical discharge voltage levels.

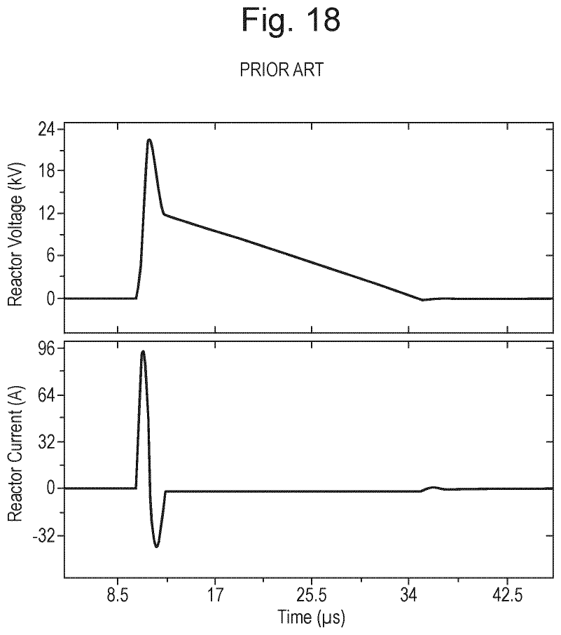

Characteristic voltage and current waveforms of a single pulse with a conventional high voltage pulse generator are shown in FIG. 18. This shows two plots, one of voltage against time and the other of current against time, for a prior art single pulse generated using a high voltage pulse modulator system used to charge a large DBD device.

The voltage plot can be seen to start at 0 V, then for the pulse to elevate to a peak of around 22 kV over around 1 microsecond (μs). The voltage then drops from the peak to a level of about 12 KV over the course of around a further 1.5 μs. The decrease in the voltage then slows to a linear decrease to OV over around 21 μs.

The drop from the peak is caused by a natural resonance between the DBD device and transformer parasitics. The resonance causes an oscillation to start, which is what can be seen to be occurring in the drop from the peak. The resonance is then stopped by the pulse stopping, cutting the voltage being provided. As such, from that point, there is a linear discharge that occurs. If the pulse was not stopped, a cyclical waveform would be visible instead.

The corresponding current plot shows an increase in current from 0 A to a peak of around 90 A over around 0.5 μs. This then drops to around −40 A (negative 40 A) over around 1 μs and back to 0 A over about a further 1 μs.

The change in current occurs over the same time period it takes for the voltage to pass through its peak and back to 12 kV. The dielectric barrier electrical discharge initiates at about the point when the voltage reaches its peak and ends when the voltage returns to 12 kV from the peak. The linear slope back to 0 V from this point is due to energy dissipation in the pulse generation unit from the energy stored in the capacitance of the DBD device after the dielectric barrier electrical discharge occurs.

As set out above, due to the low power factor PF determined from the ratio of real power to apparent power in a DBD device, i.e. the large amount of reactive power needed to repeatedly cycle the voltage at the reactor and the comparably low amount of real power actually being transferred to the plasma imposes a fundamental challenge to achieve a high power transfer efficiency.

$$i = c \frac{Δ v}{Δ t} \qquad Eq . 3$$

As an example, a DBD device with equivalent capacitance of 5 nF and a 20 kV ignition voltage, in accordance with Eq. 3, in order to achieve a voltage rise-time of at least 1 μs, a charging/discharging current of 100 A is required. If a 1:20 step-up transformer is used, a 2 kA peak input current is required and must be handled by the various electronic components and pulse-generation unit prior to passing through the transformer.

In order to overcome the negative aspects of this, we have developed the examples devices, systems and methods set out in detail below. Such devices are able to be used in scrubbing exhaust gas, such as the apparatus disclosed above or in GB 2593786, which is incorporated herein by reference. This apparatus makes use of functionalised electrodes with one or more electric field intensification structures, such as sub-macroscopic features, and a dielectric portion. The electric field intensification structure(s) is/are exposed to an electric field, resulting in the field-emission of electrons from the electric field intensification structures and dielectric barrier electrical discharge between the dielectric and opposing electrode. Gas to be scrubbed is then exposed to those electrons.

By the phrase “functionalised electrodes”, we intend to mean electrodes that have a structure or structures, such as a coating, on it that has/have a functional aspect in addition to acting as an electrode (i.e. as an anode and/or cathode).

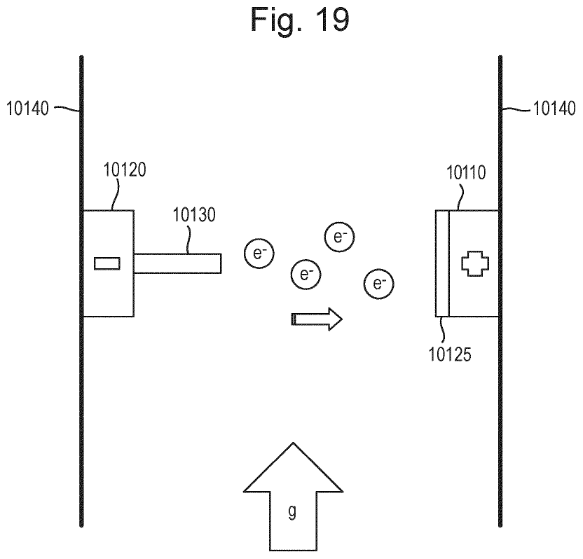

FIG. 19 schematically shows, as an illustrative example, the principle of this electron irradiation and dielectric barrier electrical discharge scrubbing technology. Two electrodes, an anode 10110 and a cathode 10120, are located so that they facing each other. In this example, a dielectric portion 10125 is located on the anode. This dielectric portion provides a coating on the entire surface of the anode.

The example in FIG. 19 also includes an electric field intensification structure 10130 located between the anode 10110 and the cathode 10120. In this example, the electric field intensification structure is electrically connected to the cathode.

In some examples, the electric field intensification structure the electric field intensification structure described above or a part thereof. The electric field intensification structure may also include or be a form of (other) sub-macroscopic features, such as a micro-needle, micro-needle array, and/or one or more CNTs. These are able to function and operate in the same or similar manner to how the electric field intensification structure is described as functioning below.

In use, the electric field intensification structure 10130 and/or other sub-macroscopic feature field-emits electrons (e−, e⁻) in response to the presence of an electric field between the anode 10110 and cathode 10120 when a potential difference is established between them. The electric field between the anode and cathode also causes dielectric barrier electrical discharge (in the form of dielectric barrier electrical discharge) between the dielectric portion 10125 and cathode 10120.

The electrodes are coupled to a housing in order to locate the dielectric portion 10125 and electric field intensification structure 10130 in the vicinity of a container 10140 containing gas (g) to be scrubbed such that an interior of the container can be exposed to the field-emitted electrons and dielectric barrier electrical discharge.

For a compact arrangement, the anode 10110 and/or cathode 10120 can be attached to the interior of the container (such as a chimney) such that each of the dielectric portion 10125, electric field intensification structure 10130 and a surface of the cathode extends into the chimney and the dielectric barrier electrical discharge and electrons traverse a cross-section of it. Many other arrangements could be envisaged however. For example, the dielectric portion and/or electric field intensification structure and surface of the cathode could be located outside of, but close to, the container with a window (aperture) in the container side permitting electron access and a surface at which the dielectric barrier electrical discharge is able to initiate/terminate. Such an arrangement may for example be chosen to make retrofitting of the apparatus to an existing chimney easier, or for ease of maintenance of the dielectric portion and/or electric field intensification structure part of the apparatus. The cathode and housing need not be co-located.

It may be more practical, such as in an industrial setting, to use arrays of electric field intensification structures rather than individual electric field intensification structures. It may also be beneficial to provide multiple sets of anode-dielectric-cathode-electric field intensification structure apparatuses. Such a larger scale arrangement may be in a chimney, and could also be envisaged with multiple sets of anode-dielectric-cathode-single electric field intensification structures, or in which there is a single set of anode-dielectric-cathode-electric field intensification structure array.

When using a DBD device, such as one implementing the apparatus shown in FIG. 19, we have developed a process that implements a high frequency sinusoidal waveform with varying amplitude, resembling a wavelet-type waveform. In various examples, the wavelet is generated by connecting an inductor in series with a DBD device, which provides a capacitance. This forms a series resonance circuit, also referred to as a series resonant tank, which is capable of being excited at a resonance frequency. When excited at a resonance frequency repeatedly for several cycles using bipolar voltage pulses, this allows the DBD device to be excited with a high voltage slew rate while substantially reducing current stress, and which lowers the peak power processed by the power electronics. As such, voltage gain achieved in the resonant tank provides the high ignition voltage levels for the DBD device, instead of using a pulse-transformer with a high turns ratio to provide the voltage gain. Relevant attributes of the resonant tank are therefore the achievable voltage gain and the ability to compensate for the reactive power of the DBD device.

Applying several consecutive bipolar voltage pulses to form a pulse-train allows low power loss (demonstrated by the high efficiency noted below) and a higher pulse repetition frequency to be applied, and therefore the capability of average power transfer is substantially increased over a system using a single pulse. As an example, by applying this process, the pulse repetition frequency is able to be increased by at least ten times over such a system. This is achievable in combination with the use of silicon carbide semiconductor technology as described in more detail below.

Repetition frequency of pulse-trains is limited by a maximum operating temperature of power electronics. In general, pulse-power converter designs take advantage of the slow thermal response. This means that if a high pulse repetition frequency were used in a conventional pulsed system, dissipated peak power would be too large to stay within safer operating temperatures of the power electronics. This is avoided in the examples described herein by using the pulse-train modulation described below. Additionally, this is avoided by limiting the maximum number of discharge ignition events produced from a single pulse-train and then having a period that allows cooling to occur before the next pulse-train.

By implementing a pulse-train of several consecutive bipolar voltage pulses as described in relation to the examples set out herein, even if the number of discharge ignition events is limited to between one and five, this is achieved while providing energy transfer at very high efficiency, such as at about 90% efficiency or greater.

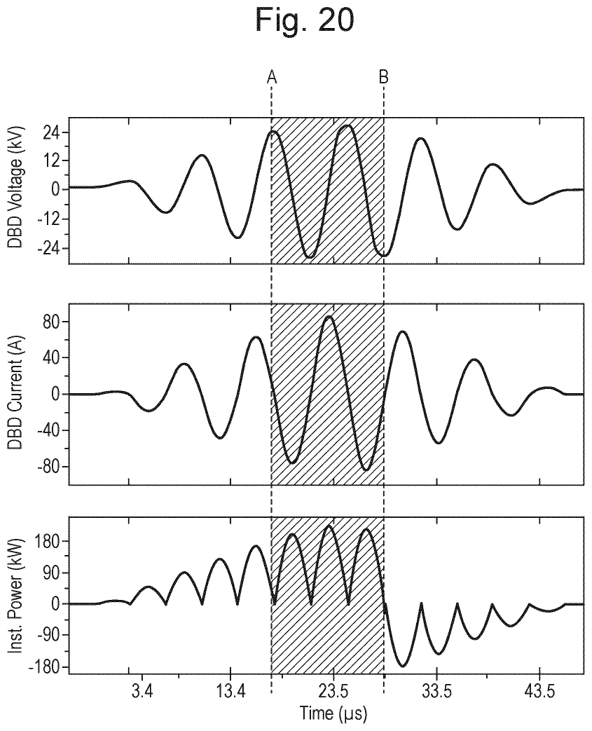

As shown in FIG. 20, the use of consecutive bipolar voltage pulses creates three modes of operation induced at the DBD device. The first mode, which occurs between 0 μs and time A in FIG. 20, is the charging of the resonance circuit. This builds up the potential difference across the electrodes in the DBD device. As set out above, this is achieved by applying consecutive bipolar voltage pulses at the resonant frequency of the resonant tank.

In the plots shown in FIG. 20 this can be seen to be a sinusoidal wave at consistent frequency that steadily increases in amplitude for both voltage and current. This results in an instantaneous power level of a rectified sine wave (as the multiplication of rectangular voltage and sinusoidal inductor current) with a steadily increasing amplitude. The duration of the mode in the example shown in FIG. 20 is around 2.5 voltage cycles, 2.5 current cycles and 5 power cycles (one power cycle being the transition from zero to a peak and back to zero). In this example, the current waveform leads the voltage waveform by about 90°.

The second mode takes place between time A and time B in the example plots of FIG. 20. This mode is reached when the voltage reaches the ignition or breakdown voltage (Vₜₕ) causing dielectric barrier electrical discharge between the electrodes of the DBD. This delivers power to the plasma and should last only a few discharge cycles for most efficient pollutant reduction. During this mode the voltage amplitude remains above the Vₜₕ level due to continued excitation of the resonant tank at the resonant frequency. In the plots it can be seen that the voltage and current continue in a sinusoidal wave with consistent frequency. The amplitude of the waves varies slightly over the duration of this period (increasing to approximately the half way point of the mode's duration and then begins to decrease).

The example shown in FIG. 20 is based on the DBD device having a capacitance of approximately 3.0 nF. The voltage has a peak at about ±24 KV (positive-negative 24 kV) and a current of ±80 A. In other examples the capacitance of approximately 1.0 nF, but could also be approximately 45.0 nF or higher.

The voltage and current amplitude pattern is the same for the instantaneous power, which continues to be the rectified sine wave. The peak instantaneous power is about 180 kilo-Watts (KW) in the example shown in FIG. 20.

The duration of the second mode is about 1.5 voltage cycles, about 1.5 current cycles and about 3 power cycles.

During the first and second mode the resonant tank is excited by having power provided to it. During the third mode the excitation is stopped and the resonant tank discharges by draining. In some examples the tank is actively discharged by recovering the energy from the tank. A passive discharge is also possible.

Due to the excitation being stopped and a discharge path being provided, in the third mode the voltage, current and power reduce to zero. In the example plots in FIG. 20, the third mode is shown from time B onwards. The voltage and current follow a sinusoidal waveform with a consistent frequency as in the first and second modes. The power continues to be a rectified sine wave. The amplitude of the voltage and current decrease towards zero over the period of about 2.5 cycles for the voltage and about 2.5 cycles for the current.

The power plot shown in FIG. 20 is consistent with an example in which the resonant tank is passively discharged. This can be seen by the instantaneous power being inverted so as to be the rectified sine wave, but with the peaks being negative values instead of positive as in the first and second mode. The amplitude of the power decreases to zero over about five cycles.

The three modes form a wavelet pulsed power process in the form of a pulse-train implemented by excitation of the resonant tank. The duration of the power transfer achieved using this process is determined by the length of time over which this excitation pulse-train is provided to the resonant tank. This is just one parameter of the excitation pulse-train that is determined by circuit by which the pulse-train is implemented. FIGS. 22, 23 and 24 show example circuits capable of being used to implement one or more pulse-trains.

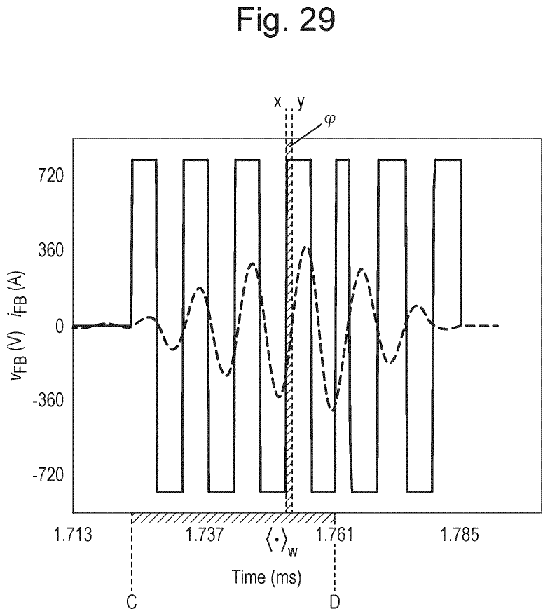

An example of the excitation applied to the resonant tank is shown in FIG. 29 below. As can be seen in that figure, in various examples, the excitation takes the form of a square wave voltage waveform, the waveform comprising multiple consecutive individual pulses that together form a pulse-train. This induces a sinusoidal current in a resonant tank (the current waveform shown in FIG. 29), and provides the waveforms at the DBD device shown in FIG. 20.

While FIG. 29 does not show the dielectric barrier electrical discharge threshold, or specific include markings separating the first, second and third modes, it is possible to see in these figures where the third mode begins. At time D in FIG. 29, it can be seen that the voltage waveform has a peak at a maximum positive value that has a shorter duration than the other peaks in the waveform. This occurs due to the transition from the second mode to the third mode. At this point, the excitation is stopped, meaning voltage is no longer actively provided to the resonant tank and DBD device.

Depending on the action taken at that stage, such as whether active or passive energy recovery is used, this causes a phase shift in the voltage waveform. Passive energy recovery is used in the simulation used to produce FIG. 29, and as such, the change in the applied waveform is caused by means of freewheeling of current in H-bridge diodes. An alternate active energy recovery means applied in some examples is 180 degree phase shift causing power to be drained instead. These processes are described in more detail below along with an example inverter providing the H-bridge.

In various examples, the transition to the third mode in examples according to an aspect disclosed herein is applied after a maximum number of discharge ignition events. A number of examples limit the maximum number of discharge ignition events to only a single discharge ignition event, or to up to about five discharge ignition events. When only a single discharge ignition event is used as the maximum number, or after the last discharge ignition event at a larger maximum number, the third mode is transitioned to directly after (such as immediately after) the maximum number of discharge ignition events have occurred.

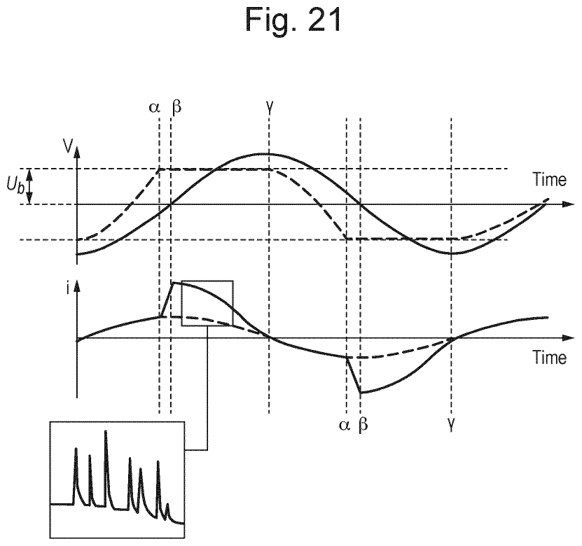

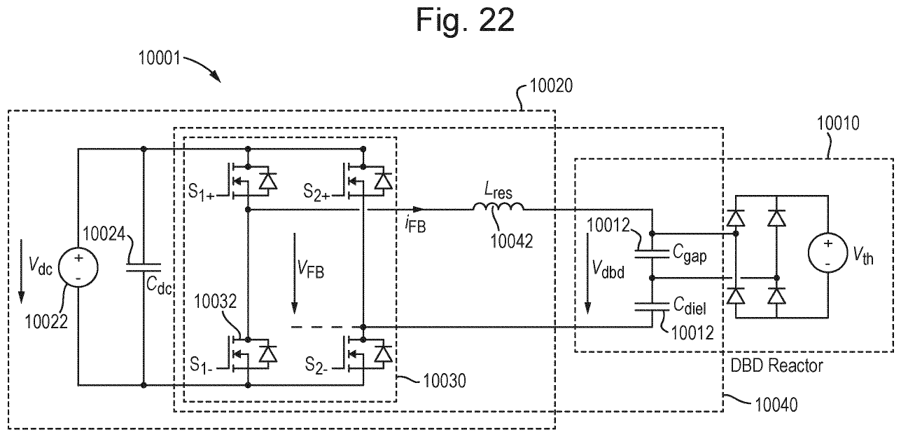

In terms of how an example excitation applied to the DBD device translates into discharge, this is demonstrated by the plots shown in FIG. 21. This shows an upper plot and a lower plot. The upper plot is a plot of voltage against time and the lower plot is a plot of current against time.

The upper plot of FIG. 21 shows a solid line and a dashed line. The solid line is in the form of a sinusoidal wave that is at a minimum at time zero. In this example, this line corresponds to a voltage applied across a DBD device. The dashed line is in the form of a sinusoidal wave with its maximum and minimum peaks truncated to a plateau. As with the applied voltage curve, this is at a minimum at time zero, and, in this example, corresponds to a voltage across the discharge gap.

The amplitude of the gap voltage is less than the applied voltage amplitude. As the applied voltage transitions towards positive, the gap voltage increases. After about an eighth of a cycle of the applied voltage, the gap voltage turns positive. Just before the end of a second eighth of said cycle, the amplitude of the gap voltage reaches a threshold. In FIG. 21 this occurs at time α. This plateau is maintained until the applied voltage reaches a maximum, at time γ, in FIG. 21. At time γ, the process repeats itself, but with the polarities reversed, and continues to switch between movements in the positive and negative directions as long as the applied voltage continues.

As a comparison to the first, second and third modes set out above, the rise in the gap voltage corresponds, for example, to the rise in voltage during the second mode after the first fall in voltage during the second mode. From this it can be understood that discharge is able to occur during this period, and as such, the plateau in the gap voltage curve is due to the threshold voltage being reached.

The current plot of FIG. 21 shows the current at the gap induced by gap voltage. At time zero this has an amplitude of approximately zero. This increases in the form of a sinusoidal wave. Should the gap voltage not reach the threshold voltage (such as if the plots of FIG. 21 represented voltage and current during the first or third modes), then, as shown by the dashed line in the current plot in FIG. 21, the sinusoidal wave would proceed uninterrupted. However, at time α, due to the threshold voltage having been reached, ignition occurs. This causes ionisation of the medium in the discharge gap and electrical discharge to begin.

From time α, the gap current rapidly increases to a peak at time β, which corresponds to the zero-cross point of the applied voltage. Since time α is almost at the end of a quarter cycle of the applied voltage cycle, this is a very short period relative to the cycle of the current curve. From time β, the current then, in a sinusoidal manner, decreases to zero at time γ, at which point it returns to its original form and amplitude range. This cycle continues in parallel with the gap voltage and applied voltage.

As can be seen from this, the amplitude of the current is simply increased to an amplified level.

The main current plot of FIG. 21 shows a continuous curve between time α and time γ. As noted above this is the time during which discharge occurs. This period is therefore able to be considered to be a macro-discharge period, and time α is when a discharge ignition event occurs. As is shown by the magnified section of the current plot of FIG. 21, the current curve does not have a continuous form however. Instead, the curve is made up of many current spikes that are so close together that they cause the curve to appear continuous. Each spike represents a micro-discharge or transient filament, which is initiated from a single point on one of the electrodes (such as from a electric field intensification structure 10130 on the electrode 10120 shown in FIG. 19). It is the connection each of these filaments provide between the opposing electrodes (one electrode 10110 of course having the dielectric layer 10125 thereon as shown in FIG. 19) that causes the current spike because the filament provides a current path across the discharge gap. Due to these micro-discharges ionising the medium in the gap and passing high energy electrons into the medium, enough energy is present to drive chemical reactions that, for example, breakdown pollutants in the medium.

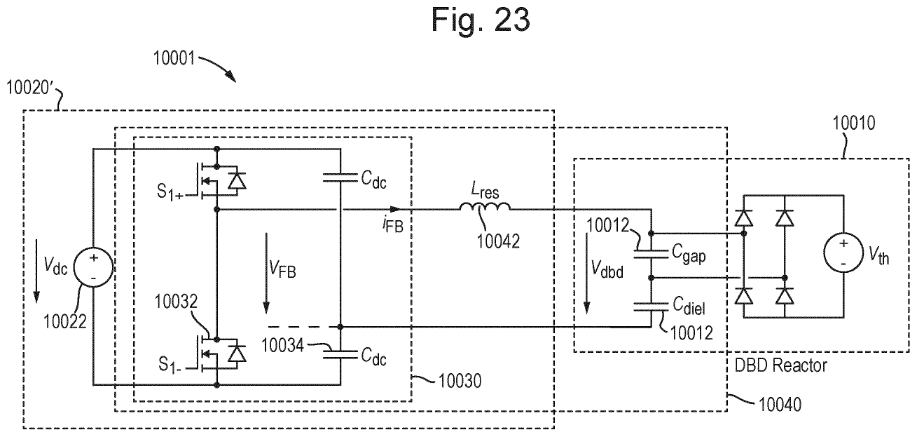

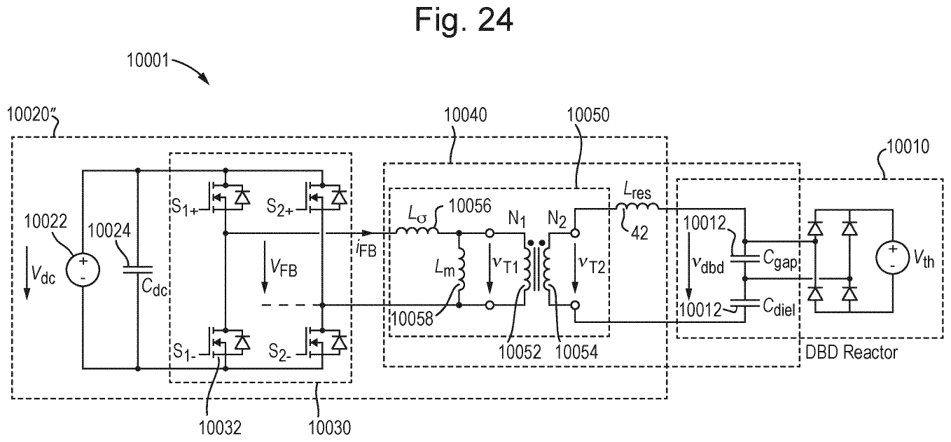

Generally illustrated at 10001 in each of FIG. 22, FIG. 23 and FIG. 24 is a circuit diagram of an example system suitable for providing dielectric barrier discharge. This system includes a DBD device 10010, also referred to as a DBD reactor.

The DBD reactor 10010 is represented in each of FIGS. 22, 23 and 24 by a model. The model is a diode bridge with a power input (also referred to as a power source) providing a voltage of Vₜₕ in use. The electrodes of the DBD device are shown in the model as being connected across the diode bridge.

The electrodes (specifically the gap between the electrodes, which may be referred to as a “dielectric discharge gap”) and the dielectric barrier mounted to one of the electrodes are represented in FIGS. 22, 23 and 24 by capacitors 10012. This is because the electrical functionality the gap and dielectric barrier provide to the system when represented as a circuit is capacitance.

The capacitance provided by the dielectric discharge gap is shown as being connected directly across the diode bridge. The capacitance provided by the dielectric barrier itself is shown as being connected at one end to the diode bridge in parallel with the capacitance provided by the gap. The other end of the capacitance provided by the dielectric barrier is not connected to the diode bridge. This is instead connected to a drive circuit arranged to drive dielectric barrier electrical discharge across the gap between the electrodes.

While represented by a model in FIGS. 22, 23 and 24, the DBD device 10010 capacitance is determined predominantly by the capacitance of the medium (typically gas, such as air) in the dielectric discharge gap. This is typically due to the dielectric constant of the medium being about 1 and the dielectric material being significantly higher than 1, such as between about 3 and 6 (when measured at about 20 degrees Celsius at about 1 kHz). As the medium and dielectric are connected in series, it is the smaller capacitance that is dominant, and therefore, due to these relative dielectric constants, the effective capacitance of the DBD device is governed by the medium.

Further, the contribution from the capacitance of the medium in the gap, this is approximately constant and does not depend on temperature of composition of the medium in the gap. This “air-gap” capacitance is therefore approximately constant because, as explained in more detail below, the pulse-trains used in examples according to an aspect disclosed herein limit the number of discharge ignition events to the extent that minimal change occurs to this capacitance. The same cannot be said however for known resonant systems. This is either due to the extended nature of the discharge causing a shift in the capacitance of the medium, or the medium is of a different nature, such as when surface dielectric barrier discharge devices are used.

The drive circuit is illustrated respectively at 10020, 10020′ and 10020″ in FIGS. 22, 23 and 24. The drive circuit has a power source 10022 connected to an inverter 10030. The power source is provided by a DC power supply in the examples of these figures. This is a DC link voltage supply, V_{dc}, in the examples shown.

In the examples shown in FIGS. 22 and 23, the inverter 10030 has a circuit loop connected across it. This circuit loop has a connection to the electrodes of the DBD device 10010 connecting in series across the capacitance provided by the dielectric discharge gap and dielectric barrier. This closes the circuit loop connected across the inverter.

The example shown in FIG. 24 the inverter 10030 has a transformer 10050 connected across it. In this arrangement it is the primary side 10052 of a transformer that is connected across the inverter. The secondary side 10054 of the transformer has a connection to the electrodes of the DBD device 10010 connecting in series across the capacitance provided by the dielectric discharge gap and dielectric barrier.

The connection across the capacitance of the DBD device 10010, and the ability to connect across this capacitance in the examples of each of FIGS. 22, 23 and 24 causes the drive circuit 10020 to be a separate, and in some examples separable, circuit from the DBD device.

In the examples shown in FIGS. 22 and 23, when the drive circuit 10020, 10020′ is connected as set out above to the DBD device 10010, a resonant tank 10040 is formed between the inverter 10030 and the capacitors 10012 provided by the dielectric discharge gap and the dielectric barrier. The inductance of the resonant tank is provided in this example by an inductor 10042 connected in series with the capacitance. Some inductance will also be provided by the wiring of the resonant tank. The inverter provides the power source for the resonant tank.

In the example shown in FIG. 24, when the drive circuit 10020″ is connected, as set out above, to the DBD device 10010, a resonant tank 10040 is formed between the transformer 10050 and the capacitance 10012 provided by the dielectric discharge gap and the dielectric barrier. The inductance of the resonant tank is provided by an inductor 10042 connected in series with the secondary side 10054 of the transformer and the capacitance in combination with stray/leakage inductance of the transformer represented in FIG. 24 by inductor Lo at reference numeral 10056. This is shown in FIG. 24 as being connected in series with the transformer between the output from the inverter 10030 and the input to the primary side 10052 of the transformer.

The transformer 10050 shown in the example of FIG. 24 also has magnetisation induction represented in the figure by inductor Lₘ at reference numeral 10058, connected in parallel with the primary side 10052 of the transformer.

In addition to providing a step change in voltage and current based on the turns ratio in the transformer 10050, the transformer also provides galvanic isolation. This suppresses electromagnetic interference across the transformer from the inverter 10030 to the resonant tank. A conventional magnetic core transformer is able to be used in various examples. In other examples, an Air-Core Transformer (ACT) is able to be used. Compared to a regular (i.e. magnetic core) transformer, an ACT can have a very low coupling (such as 40% instead of 98% as would typically in a magnetic core transformer) between the windings. This results in higher leakage inductance than in a regular transformer. However, this is desirable in some examples, since it allows several desirable functions for the drive circuit as a whole to be incorporated in a single component, namely galvanic isolation for safety and EMI suppression (since the transformer provides a noise barrier), voltage step-up and resonance inductance (as is discussed in more detail below). These functions are also able to be provided by a regular transformer but to a lesser extend in some examples.

Turning to the inverter 10030 in more detail, in the examples shown in FIGS. 22 and 24, the inverter is provided by an H-bridge. The H-bridge has four switches 10032 providing two high-side switches, S₁₊ and S₂₊, and two low-side switches, S₁₋ and S₂₋. In the example shown in FIG. 23, the inverter is provided by a half bridge. This has two switches 10032 and two capacitors 10034, with the switches providing one high-side, S₁₊, and one low-side, S₁₋, switch.

The switches 10032 of the inverter 10030 are, in the examples shown in FIGS. 22 to 24 provided by transistors. These are silicon carbide MOSFETs in the examples shown in these figures. In other examples, each switch is able to be provided by a MOSFET, such as an n-type MOSFET, silicon MOSFET; or other types of electronic switches, such as Insulated Gate Bipolar Transistors (IGBTs), such as a silicon IGBT, Junction Field Effect Transistors (IFETs), Bipolar Junction Transistors (BJTs), or High Electron-Mobility Transistors (HEMTs), such as gallium nitride (GaN) HEMTs.

In the examples shown in FIGS. 22 and 24 a capacitor 10024 is connected in parallel with the inverter 10030 and voltage supply 10022. This provides a DC link capacitance for the drive circuit 10020. In the example shown in FIG. 23, this capacitance is provided by the capacitors 10034 of the half-bridge inverter.

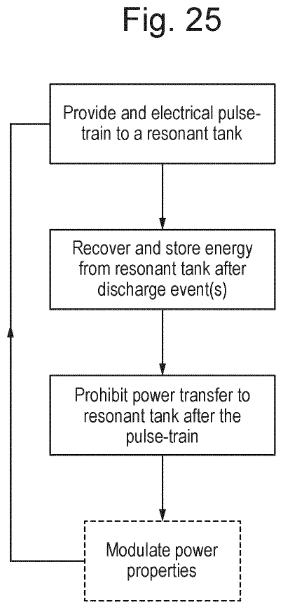

As shown in FIG. 25, the system is used to provide an electrical pulse-train to the resonant tank and to prohibit power transfer to the resonant tank after the pulse-train. There are also steps of modulating power properties in order to modify the pulse-train before a further pulse-train is provided and to recover energy from the resonant tank after the discharge ignition event(s) and store the energy. While there are examples where energy recovery is not included in this process, typically energy recovery is included in this process. The step of modulating power properties is optional however. The details of the process are set out in more detail below along with further details of power modulation and energy recovery processes.

During use of the system 10001, the power supplied to the DBD device 10010 needs to reach at least the dielectric barrier electrical discharge voltage level (Vₜₕ). This is needed in order to stimulate dielectric barrier electrical discharge across the discharge gap. The model circuit shown in FIGS. 22, 23 and 24 for the DBD device shows the ability of the device to accept power and voltage clamping across the gap when Vₜₕ is reached. The power absorbed by the DBD voltage source shown in these figures is given by the product of Vₜₕ and the current impressed in the resonant tank (when the diodes are conducting). As such, when the voltage across the gap exceeds Vₜₕ, the corresponding pair of diodes in the model circuit of the DBD device are conducting, and power is being transferred to the (model) Vₜₕ voltage source depicted in the figures, representing a power transfer to the plasma. In this model, the voltage across the gap is clamped to Vₜₕ whenever dielectric barrier electrical discharge occurs.

The power to provide the dielectric barrier electrical discharge voltage is provided by the drive circuit 10020 as a pulse-train. The power provided by the pulse-train is drawn from the DC link voltage source 10022 at a level of about 800 V. This is fed to the inverter 10030. In other examples, the voltage provided by the DC link voltage source is up to 900 V when using a silicon carbide MOSFET, and can be higher, such as 1.2 KV to 1.3 kV when using a 1.7 kV rated silicon carbide transistor.

To initiate the pulse-train, when using the system in the example shown in FIG. 22, as power is drawn from the DC link voltage source 10022, the H-bridge is then used to excite the resonant tank 10040. In this example this is achieved by the H-bridge outputting a 100% duty-cycle square wave voltage over the duration of the first two modes of the pulse-train (as set out above in relation to FIG. 20).

The switches 10032 of the H-bridge are arranged to provide output at a switching frequency tuned to excite the resonant tank 10040 at the resonance frequency of the tank. This causes only real power to be processed by the H-bridge. In order to minimize switching losses, operation slightly above the resonance frequency is feasible to achieve ZVS of the switches.

As set out above in relation to FIG. 20, the excitation of the resonant tank 10040 causes dielectric barrier electrical discharge once the voltage level in the resonant tank 10040 reaches Vₜₕ. This transfers power into the plasma between the electrodes in the DBD device 10010.

When the second mode of the pulse-train is to be ended, the switches 10032 are turned off. When using transistors as in the examples shown in FIGS. 22 to 24, this is achieved either by turning the transistors off apart from the transistor body diodes (or external anti-parallel diodes), which are left active, or the bridge voltage (v_{FB}) across the inverter 10030 is phase-shifted by 180 degrees (°) in order to respectively passively or actively recover the remaining energy stored in the resonant tank 10040.

The recovered energy is transferred to the DC link capacitor 10024 (this corresponds to the capacitors 10034 of the inverter 10030 when the example drive circuit 10020′ shown in FIG. 23 is used instead of the example drive circuit 10020 shown in FIG. 22 or the example drive circuit 10020″ shown in FIG. 24). This is achieved by the reversal of the power flow through the passive or active recovery described in the previous paragraph. This allows this energy to contribute to the energy used for the next pulse-train.

Passive power recovery is achieved by the transistors in the inverter 10030 simply being switched off at the end of the second mode (i.e. when dielectric barrier electrical discharge is to be ended), as referred to above. Due to the arrangement of the circuit in an H-bridge or half bridge, this removes all circuit paths through the transistors and leaves a path through the transistor body diodes (which, as shown in FIGS. 22, 23 and 24 provide a connection across the transistors). The connection of the resonant tank across the inverter as shown in FIGS. 22, 23 and 24 relative to the diodes allows energy to flow through the diodes and into the DC link capacitor 10024, 10034 when the transistors are switched off.

Active power recover is instead achieved by making use of the transistors to provide a 180° phase shift in the output of the inverter 10030 from the phase of the output in the second mode. Instead of allowing energy to flow into the DC link capacitor 10024, 10034, as occurs during passive power recovery, this drives the energy into the DC link capacitor.

The quality factor (Q) of the resonant tank equates to the voltage gain of voltage across the dielectric discharge gap (V_{dbd}) to the bridge voltage (i.e. Q=V_{dbd}/v_{FB}) at the resonance frequency (without transformer or unity turns-ratio, which would make the quality factor as Q=v_{dbd}/(v_{FB}/n), where n is the turns ratio of the transformer; the total gain when using a transformer would also be determined from the transformer step-up plus the resonance gain). The effective voltage gain of the resonant tank is determined by the power losses imposed by the parasitic resistances of the magnetic components and the wires connecting the electrodes of the DBD device which provide damping to the circuit. Unlike known systems that use resonant converters, in examples according to an aspect disclosed herein the effective voltage gain is not determined by the actual power being delivered to the plasma since there is no discharge occurring during charging of the resonant tank. For this reason, practical values of Q of greater than 40 allow dielectric barrier electrical discharge voltages above 30 KV from the 800 V DC link input voltage without the explicit need of a step-up transformer.

It can therefore be appreciated that once power is being absorbed by the onset of discharge ignition events in the DBD device, a lower voltage gain may cause a self-quenching effect due to the damping this causes and the Q value shift. However, since only a few discharge ignition events are wanted from each pulse-train (such as between one and about five discharge ignition events) and because there is enough momentum in the resonant tank (stored energy much larger than energy absorbed by electric discharges), this does not impose any practical challenges for the examples according to an aspect disclosed herein. On the other hand, known resonant converters are configures for comparably low voltage gains resulting from continuous power absorption by the plasma and therefore need, and are designed with, high step-up transformer turns-ratios.

The voltage across the dielectric discharge gap is determined by the capacitance of the dielectric discharge gap. This is made up of the capacitance of the dielectric and the capacitance of the gap itself. In the examples in FIGS. 22, 23 and 24, the capacitance of the dielectric (C_{diel}) is typically much larger than the capacitance of the gap (C_{gap}). For example, C_{diel} is typically at least ten times larger than C_{gap}. This also gives a voltage ratio of voltage across the gap (V_{gap}) compared to the voltage across the dielectric (V_{diel}) of at least 10.

The process of recovering energy can be applied in a corresponding manner using the drive circuit 10020′ of the example shown in FIG. 23. When using the drive circuit 10020″ of the example shown in FIG. 24, the same process as is able to be applied for the drive circuit 10020 of the example shown in FIG. 22 can be used.

The power being provided by the DC link power supply is the power provided to the drive circuit averaged over the pulse-train repetition interval. The energy exchanged between the DC-link capacitor and the resonant tank during resonant tank charging, power transfer during dielectric barrier electrical discharge, and resonant tank discharging typically causes a voltage ripple across the DC link capacitors. The interval where power is transferred to the plasma by dielectric barrier electrical discharge also contributes to the DC-link voltage ripple.

In the example shown in FIG. 24, the transformer 10050 provides a step up ratio of between about 1:1 and 1:10. This lower step up ratio that those of conventional pulsed-power circuits (example step-up ratios of which are set out above), allows the current passing through the primary side 10052 of the transformer to be limited. When a ratio of 1:1 is used, this only provides galvanic isolation instead of providing galvanic isolation and step up in voltage when a higher step-up ratio, such as a step up ration of 1:10, is used.

The inductor 10042 used in the drive circuit 10020″ of FIG. 24 can be located on either the primary side or secondary side of the transformer 10050. However, by locating the inductor on the secondary side (and therefore high voltage side), as mentioned above, the kVA rating of the transformer is able to be reduced. The reactive power of the DBD device 10010 can then be directly compensated. Under such a reactive load matching condition, only the real power is processed by the transformer.

The galvanic isolation imposed by the transformer 10050 reduces ground currents, which are currents flowing in the parasitic capacitance between electrodes of the DBD device 10010 and any surrounding metallic housing. This assists in meeting electromagnetic compatibility (EMC) limits.

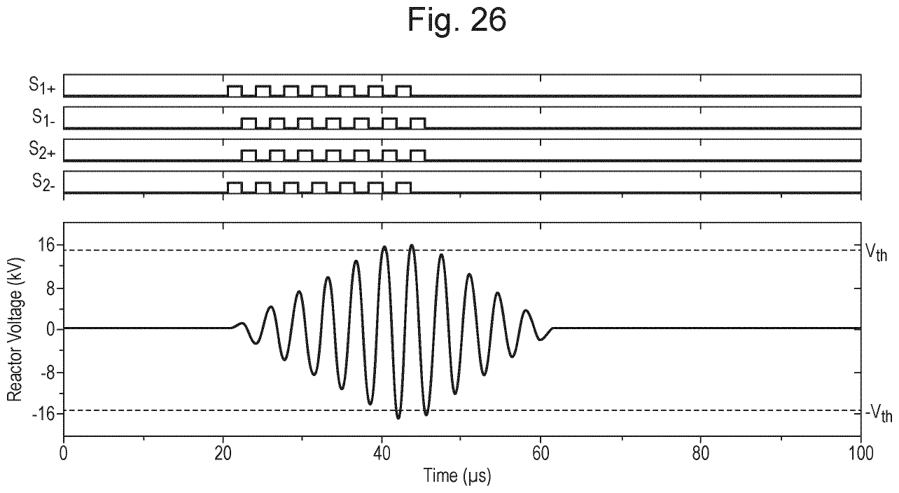

The duration of each wavelet pulse-train determines the number of dielectric barrier electrical discharge ignition events. As can be seen from FIG. 26, for a given V_{dc}, the number of excitation periods nₚ (i.e. frequency cycles) defines the effective duration of the wavelet pulse-train and the number of dielectric barrier electrical discharge ignition events once Vₜₕ has been reached in the resonant tank. This therefore determines the amount of energy transferred to the plasma per pulse-train.

The real power is adjusted by moving the bridge-leg switching frequency away from the resonance frequency. This can be achieved by increasing the switching frequency above the resonance frequency or lowering the switching frequency below the resonance frequency. This causes a phase-shift between the v_{FB} and the bridge current i_{FB}, and thus lowers the real power being transferred to the DBD reactor.

By taking this approach the high voltage gain is lowered and processing of reactive power increases. In order to maintain the high voltage gain and minimise the processing of reactive power, instead, in accordance with aspects of the present disclosure, the inverter 10030 is able to be arranged in use to provide excitation close to the resonance frequency. This is achieved by keeping the phase shift between v_{FB} and i_{FB} close to zero. The average power is adjusted by varying the repetition frequency of the wavelet pulse-trains (i.e. how frequently a wavelet pulse-train is used to excite the resonant tank to cause dielectric barrier electrical discharge). This allows very high partial load efficiency to be achieved since the resonant tank is always operated at its resonance and therefore there is little to no processing of reactive power.

As mentioned above, the length of a pulse-train is variable. A pulse-train of one durations can be seen in FIG. 26. The pulse-train illustrated in FIG. 26 is a short pulse-train, such as one that is able to be used with an example according to an aspect disclosed herein due to it producing between two and four discharge ignition events.

In FIG. 26 the pulse-train is generated by an example drive circuit such as those shown in FIG. 22 or FIG. 24. Of the two plots shown in this figure, one plot shows the state of the switches 10032 within the H-bridge inverter 10030. These are either in an off state (a “0” state) or an on state (a “1” state). By operating these switches in pairs, the wave pattern shown in the lower plot of Figures is producible at the DBD device.

The switch pairs are the S₁₊ switch paired with the S₂₋ switch, and the S₁₋ switch paired with the S₂₊ switch. During the first two modes of a pulse-train, the switches of each pair (i.e. the two switches within the respective pairs) are operated in phase, causing each switch to be in the same state as the other switch of the pair. In the first two modes of a pulse-train, the pairs are operated out of phase, meaning that when the switches of one pair are in one state, the switches of the other pair are in the other state.

As is conventional with an inverter, there is a “dead-time” or “interlocking time” between the switches S₁₊ and S₁₋ being switched from one state to the opposing state. This dead-time is a period of time where both the switches are turned off. This period is typically several hundred nanoseconds. This period is provided as a safety interval to avoid the DC-link power supply being accidentally shorted, since this would cause a catastrophic failure within the system.

By having the switch pair S₁₊ and S₂₋ in the on state and the switch pair S₁₋ and S₂₊ in the off state, this causes a positive voltage increase. By reversing the states, so having the switch pair S₁₊ and S₂₋ in the off state and the switch pair S₁₋ and S₂₊ in the on state, this causes a negative voltage increase. By alternating this arrangement, a sinusoidal waveform as shown in the lower plot of FIG. 26 is produced with the frequency of the waveform being determined by the length of time each switch pair is in an on and off state.

In FIG. 26 each switch pair is operated for seven on-off cycles, with the S₁₊ and S₂₋ pair being the first pair to be in the on state. This generates a pulse-train with a duration of around 40 μs and a voltage of at least Vₜₕ for about 1.75 cycles. When the switch pair on-off cycles are stopped, the third mode of the pulse-train occurs until the voltage returns to 0 V. Additionally, in the pulse-trains illustrated in FIG. 26 the first mode and third mode of each pulse-train have approximately the same duration.

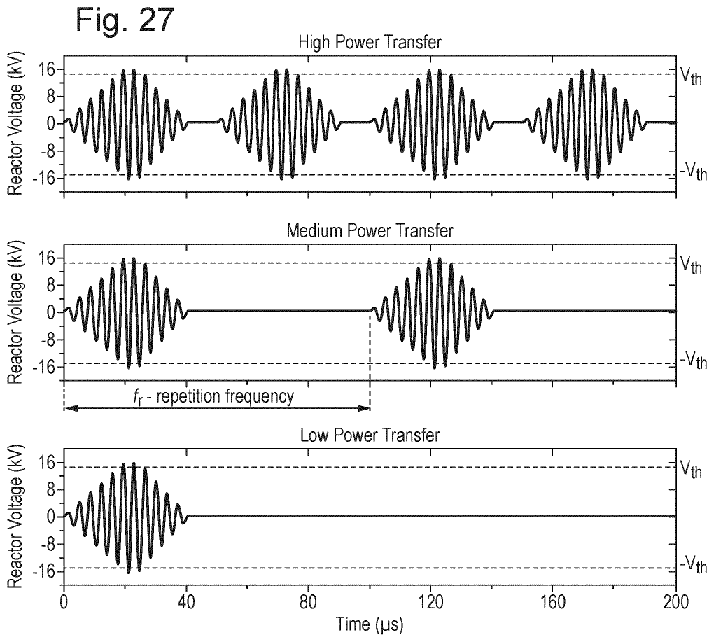

FIG. 27 shows a mechanism for varying the amount of power transferred to the plasma. As mentioned above, a further mechanism for altering the amount of power transferred to the plasma is to vary the frequency of pulse-trains (i.e. the number of pulse-trains per unit of time). This is referred to as the repetition frequency (fᵣ). Three different power transfer levels are shown in the three plots of FIG. 27.

Each plot in FIG. 27 illustrates about a 200 μs period. At a low power transfer rate, such as in the bottom plot of FIG. 27, there may be one pulse-trains thereby defining an fᵣ of about 5 kHz (equivalent to the reciprocal of 200 μs) with each pulse-train having a duration of about 40 μs. In the plot above this in FIG. 27, the fᵣ is about 10 kHz (equivalent to the reciprocal of 100 μs) with a pulse-train duration of about 40 μs. This second plot provides a medium power transfer rate. A (very) high power transfer rate is exemplified by the plot at the top of FIG. 27 (a third plot). In this third plot the fᵣ is about 18 kHz (equivalent to the reciprocal of 55 μs) with a pulse-train duration of about 40 μs. In each of these three plots the pulse-trains are distinguishable from each other due to the increase and then decrease in voltage amplitude of each pulse-train being determinable. With each pulse-train, dielectric barrier electrical discharge occurs when the voltage increases to at least Vₜₕ. Dielectric barrier electrical discharge then stops as the voltage decreases below Vₜₕ.

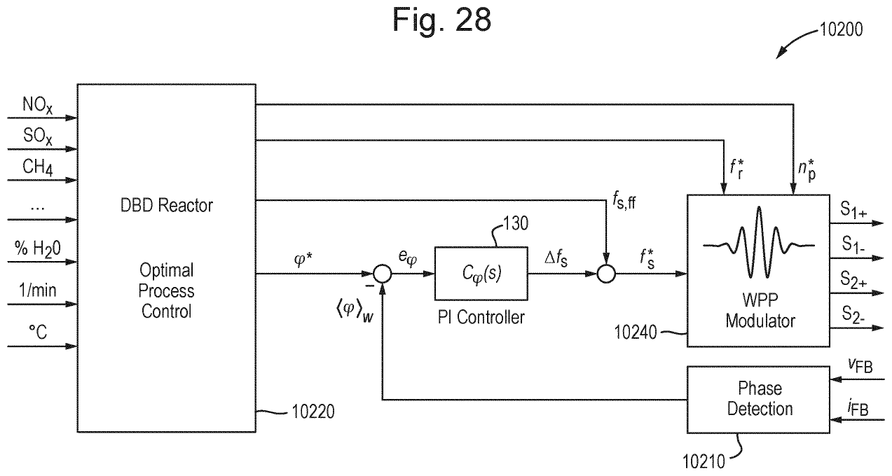

Parameters within the system 10001 may vary over time and/or during use. For example, the effective capacitance of the reactor is influenced by the process parameters (such as temperature, humidity, gas flow rate and other properties). Accordingly, a feedback mechanism to monitor and respond is used in conjunction with the DBD reactor 10010 and drive circuit 10020, 10020′, 10020″. This is provided in the form of a controller as generally illustrated at 10200 in FIG. 28, which is connected in use to the drive circuit.

According to various examples, the controller is able to adjust average power delivered to the DBD reactor 10010. This can be achieved by varying the number of pulses in a pulse-train and/or pulse repetition frequency (i.e. repetition frequency of pulses within a pulse-train) and/or pulse-train repetition frequency. In some examples the controller is able to track the resonance frequency of the resonant tank. As noted, the resonance frequency can change due to the conditions of the fluid passing through the reactor and also changes when power is being transferred to the gas. The natural frequency can also be a damped or un-damped natural frequency, which affects any frequency to which the tracked frequency may be compared. There are examples in which the frequency of the input to the resonant tank is able to be adjusted within the duration of a pulse-train, such as to update the frequency after each individual pulse of the pulse-train. The frequency of the input to the resonant tank is also able to be kept constant within a pulse-train and adjusted only between consecutive pulse-trains.

An example monitoring and response process using the controller 10200 is set out below. The controller 10200 has a phase detection unit 10210. The phase detection unit is connected to an output of the inverter 10030. This allows the phase detection unit to measure the v_{FB} and i_{FB}, thereby obtaining feedback by monitoring these parameters. From these measurements a phase angle (φ) is able to be calculated by the phase detection unit. The unit can then average the phase angle over the nₚ excitation periods of a pulse-train to provide an output of a pulse-train averaged phase [symbol] φ [symbol] _{w}).

In some examples, the measurement of φ is achieved by detecting the point (such as a time) of the zero-crossing (ZC) of the current, i_{FB}, relative to the point of the voltage, v_{FB}, switching from negative to positive. While it would be possible to use the ZC for the voltage relative to the current, since the voltage is produced by a switching action in the inverter 10030, that is determined by the controller 10200, such a voltage ZC measurement may not be needed since it can be reconstructed. There are other methods, closely related to this and the use of current ZC, which can be used directly as a means of feedback. As such, a phase control approach, such as is set out herein is able to, but not required to, rely on ZC detection.

As shown in FIG. 29, φ is calculable from the difference in start time at time X of the zero cross point of v_{FB}, represented by the square waveform, and the time of zero cross point at time Y of current i_{FB}. The pulse-train averaging window ( [symbol] _{w}) indicated in FIG. 29 by the time window between time C and time D is the time period over which the phase angle is averaged. The time period from time C to time D starts at the start of the beginning of the pulse-train (i.e. when the excitation of the resonant tank is started. This period extends through the period during which the resonant tank is charging to the point at which the ignition voltage amplitude (Vₜₕ) is reached (i.e. when dielectric barrier electrical discharge begins) allowing power transfer to occur. This time period ends at the time the excitation is stopped.

Excitation is stopped in order to stop discharge ignition events occurring. This limits the number of discharge ignition events to the maximum number of wanted discharge ignition events. In some examples the point at which to stop the excitation is determined based on the number of pulses in a pulse-train compared to a pre-set number of pulses for an excitation period during the pulse-train. In a number of other examples however, instead of operating based on a number of pulses arrangement, an arrangement that detects when discharge ignition events occur is used. Detection of the first (and potentially of subsequent discharge ignition events) occurs allows the number of discharge ignition events occurring over the following period to be known, calculated or predicted, and once. This allows excitation to be stopped when a maximum number of discharge ignition events has been reached, whether that be one, two, three, four, five or another number of discharge ignition events.

To detect when a discharge ignition event occurs, detection of a phase shift occurs. In various examples, this is detection on the instantaneous phase, instead of an averaged phase as is typically used when modulating the frequency of pulses in a pulse train for tracking the resonance frequency as set out above and below in relation to FIG. 28. This detected phase shift is a voltage-current phase-shift measured at the H-bridge terminal. During charging of the resonance tank there is close to zero phase difference between the voltage and current at the terminals. However, once a discharge ignition event occurs (i.e. the plasma ignited) there is a shift in the resonance frequency because of the increase in capacitance imposed by the “ignited” DBD device. This resonance frequency shift can be detected immediately by monitoring for a corresponding phase-shift.

This monitoring is able to be conducted, in a number of examples, using the controller 10200, such as by using the phase detection unit 10210. As noted above, in such examples, this is connected to the inverter terminals.

In examples where the maximum number of discharge ignition events is one discharge ignition event, the excitation is stopped once the first discharge ignition event is detected. In examples where the maximum number of discharge ignition events is higher (such as up to about five), the excitation is able to be stopped by then counting the number of subsequent pulses and equating each pulse to, for example, one discharge ignition event. Alternatively, identifying further discharge ignition events is able to be achieved by continuing to monitor the phase and identifying when each discharge ignition event occurs by its effect on the voltage-current phase at the inverter terminals.

In various examples, the phase detection unit 10210 is provided by analogue circuitry. In other examples the phase detection unit is digitally implemented using a Field Programmable Gate Array (FPGA).

Using an FPGA, or another (such) digital implementation of the phase detection unit 10210, greater flexibility is able to be achieved than if an analogue circuit is used, such flexibility includes changing the controller by upgrading software and not needing to design a new physical circuit and replace an existing circuit when an upgrade is wanted.

The use of an FPGA or analogue circuit also allows the phase angle to be calculated and fed through the controller 10200 after each pulse cycle in the pulse-train. Using FIG. 29 as an example, such a cycle is a single cycle of the v_{FB} square wave and/or single cycle of the i_{FB} wave. This provides a higher performance system since it allows the PI controller 230, shown in FIG. 28 and on which more detail is provided below, to determine a new frequency set point, allowing adjustments to be made to a pulse-train during the duration of the pulse-train. As a contrast, by using a pulse-train averaging window, it is only possible for the PI controller to provide an input for an adjustment a property of the next pulse-train, not the pulse-train that is currently in progress.

Once the [symbol] φ [symbol] _{w} is calculated, this is compared by the controller 10200 to a phase reference value (φ*). The φ* is provided from a process control unit shown at 10220 in FIG. 28 of the controller 10200. This is derived from the properties of the gas passing through the DBD device 10010. The properties shown in FIG. 28 are quantity of NOx, quantity of SOx, quantity of CH₄, percentage humidity (% H₂O), flow rate (litres per minute, l/min) and temperature (° C.), which, in this example, are provided as inputs to the process control unit. This provides further feedback by monitoring the properties and content of the gas passing through the DBD device. Although not shown in FIG. 28, quantity of nitrous oxide (N₂O) may also be included as an input to the process control unit.

Quantity inputs (such as quantity of NOx, SOx, CH4 and/or N₂O) to the process control unit 10220 in FIG. 28, in this example, are provided in parts per million (ppm). Different units for the measurements are able to be used in other examples.

As indicated by the “ . . . ” notation as an input to the process control unit in FIG. 28, quantities of other constituents in the gas are also able to be monitored and provided as an input.

The desired quantities of some or each of the constituent chemicals expected to be present in the gas are provided to the process control unit 10200. This allows the quantity inputs to be compared to desired quantities of each of the relevant chemicals. Any difference between quantity input and desired quantities and/or quantity inputs and/or one or more of the other gas properties are then used to determine an output of the process control unit.

In the example shown in FIG. 28, the output includes φ*, which represents an optimum phase angle. This is typically close to zero (such as at about 0°), or, if zero voltage switching (ZVS) is being applied, an phase angle of about +5° to about +15°.

The output of the comparison between <φ>_{w} and φ* is an error (e_{φ}) in the phase angle calculated from the monitored output from the inverter 10030. This error is input to a compensator, shown as Proportional Integral (PI) controller 230 in FIG. 28. The PI controller calculates a frequency variation (Δfₛ) based on the e_{φ}.

A contributing factor able to be used in determining the e_{φ} is the gain attainable based on the phase angle and how the inverter output frequency relative to the resonant frequency is shifting the phase angle.

In a drive system according to various examples described herein, the gain factor (a simple multiple) that is achieved is typically between about 30 and about 50 times. This corresponds to a gain from about 800 V input at the DC-link power supply 10022 to about 30 KV for the dielectric barrier electrical discharge threshold at the dielectric discharge gap. This corresponds to a gain of about 30 to about 34 decibels (dB).

The controller 10200 adds the Δfₛ to a nominal resonance frequency feedforward term (f_{s,ff}) output from the process control unit 10120 based on the inputs to that unit. This provides a frequency set point

$$( {f}_{s}^{*} ) .$$

The process control unit 10220 also outputs an fᵣ set point

$$( {f}_{r}^{*} )$$

and an nₚ set point (nₚ*) based on the unit inputs and processing conducted by the process control unit. The

$${f}_{s}^{*} , {f}_{r}^{*}$$

and nₚ* are provided by the controller 10200 to a modulator unit 10240. The modulator unit uses these to generate switching signals for the switches of the inverter 10030 to modulate the excitation provided to the resonant tank 10040. When the inverter is an H-bridge, these are switching signals for each of the four switches (as shown in the example controller of FIG. 28). When the inverter is a half bridge, these are switching signals for each of the two switches.

The switching frequency that is typically applied in example systems is between about 100 KHz and about 10 MHz. The

$${f}_{r}^{*}$$

is typically in the range of about 100 Hz to 50 KHz. This latter parameter is also, in various examples, the rate at which the controller 10200 is operated (i.e. the rate at which the various parameters used and updated by the controller). This lowers the performance requirements for the controller than if a higher operation rate were used.

The system 10001 is able to be used with a number of different size gas flows, such as various sizes of engines and boilers. As such, there are examples in which an exhaust gas purification system or other system applying the drive circuit 10020, 10020′, 10020″ and controller 10200 described above are implemented in a modular manner.

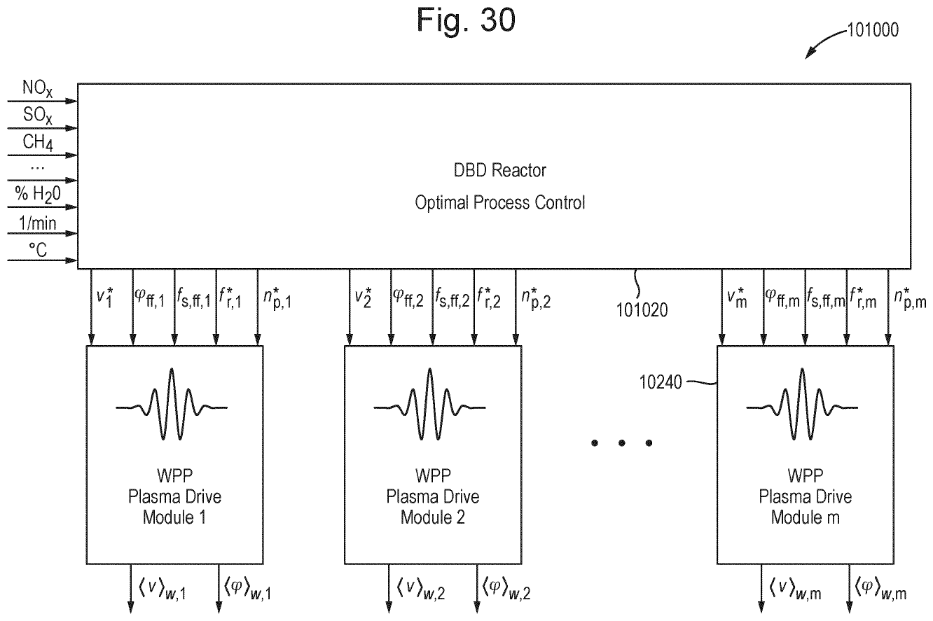

In such examples, there are a plurality of DBD devices 10010, connected in series along a gas flow. A drive circuit 10020, 10020′, 10020″ is typically provided for each DBD device. As shown in FIG. 30, a global controller 101000 is able to be implemented. This applies the same process as the controller 10200 as described in relation to FIG. 28 and uses the same components. The inputs for the phase detection are provided from each drive circuit. The properties of the gas are input into a global process control unit 101020. A modulator unit 10240 is provided for each drive circuit to drive the switches for the inverter of each drive circuit. As such, individual set points of the same types as provided to the modulator unit 10240 shown in FIG. 28 are provided to the respective drive circuits from the global controller. This provides tailored control of each drive circuit. The number of modulator units 10240 is determined by the number of drive circuits. As such, the number varies depending on the size of gas flow being processed.

When multiple drive circuits are used, there are examples where a single DC power supply is arranged to provide power to all the drive circuits. In other examples each drive circuit has its own DC power supply. In examples with a single DC power supply, a single AC/DC rectifier is able to supply DC power to each of the individual drives, thereby providing one DC-link power supply. As an example implementation of each drive circuit having its own DC power supply, each drive circuit is able to be equipped with an individual AC/DC rectifier and a 3-phase AC voltage supply. In such examples, the DBD devices 10010 are typically electrically connected in parallel while still being connected, in the gas flow, in series (i.e. sequentially along the gas flow path).

Of course, by having multiple drive circuits, various examples have multiple DBD devices. Since these are arranged in parallel, this causes the overall capacitance of the system 10001 to increase as the sum of the capacitance of each DBD device. This allows capacitances of, for example, up to 45.0 nF to be achieved, and possibly 1.0 nF.

When a system 10001 is used applying an example using a step up transformer, such in the example shown in FIG. 24, ringing can occur between the magnetising inductance 10058 of the transformer 10050 and the DBD device 10010.

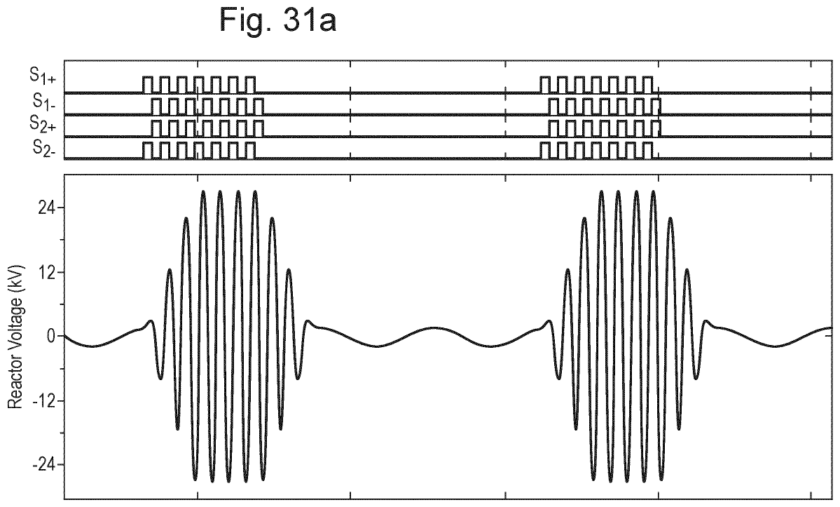

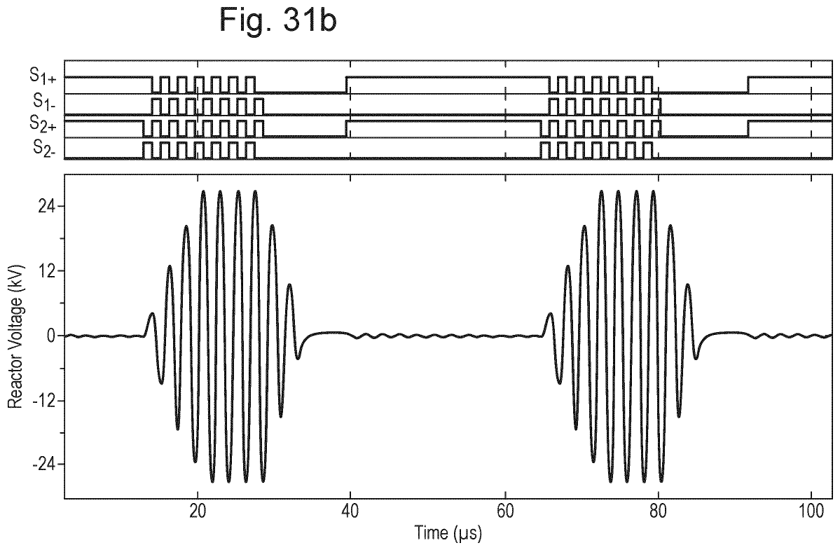

The ringing occurs in the timer interval between pulse-trains. This can be seen in FIG. 31a as the wave between the two pulses in the lower plot. This is due to a standing wave that can become established within the circuit.

In order to minimise ringing, instead of having all the switches in the off state between the end of the second mode of a pulse-train and the start of the next pulse-train, a “freewheeling” interval is introduced in some examples.

Such a freewheeling interval is shown in the upper plot in FIG. 31b. In this plot it can be seen that the high side switches, S₁₊ and S₂₊ are placed in the on state after the end of the third mode (i.e. the mode during which the resonant tank is discharged) of the first pulse-train shown in the lower plot of FIG. 31b until the start of the next pulse. This shorts the transformer winding (i.e. applies a voltage of approximately 0 V). The response to this in the system 10001 is that the ringing is minimised/attenuated as can be seen by there being no ringing between the two pulses shown in the lower plot of FIG. 31b where there is a ringing between the two pulses shown in the lower plot of FIG. 31a.

The freewheeling interval is started after the resonant tank has been de-energised (i.e. after the remaining energy in the resonant tank after a pulse-train occurs has been transferred away from the resonant tank). As set out above, this is achieved by placing the high side switches in the on state while having the low side switches, S₁₋ and S₂₋, in the off stage. The same result can be achieved by placing the low side switches in the on state and the high side switches in the off stage instead.

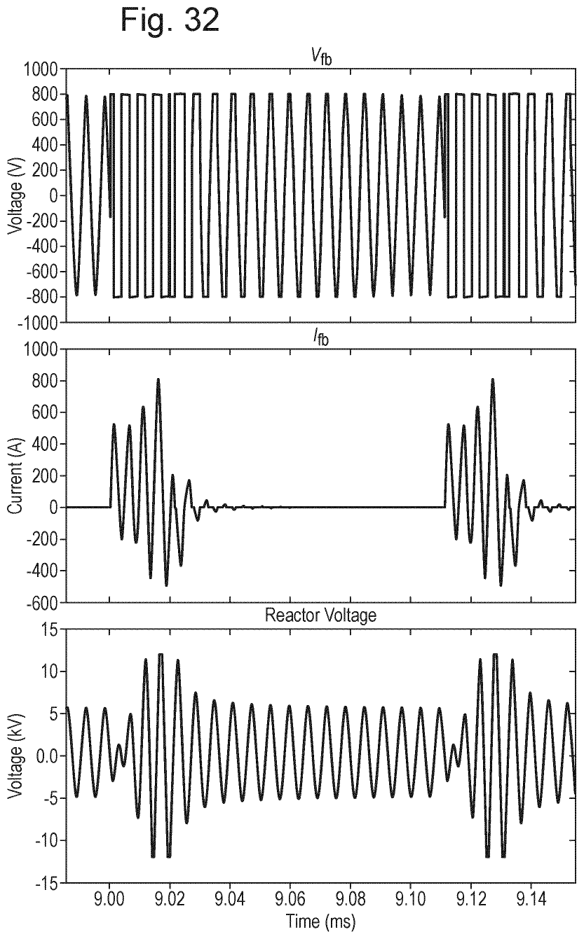

In examples where an air-core transformer is used, when active energy recovery is not applied, ringing also occurs. This can be seen, for example, from the plots shown in FIG. 32.

In FIG. 32, three plots are shown. All the plots have time in milliseconds as their x-axis. The top plot shows voltage at the inverter terminals, V_{fb}, (i.e. the terminals connected to the transformer primary windings) against time. The middle plot shows the corresponding current at the inverter terminals, I_{fb}, against time. The bottom plot shows the voltage across the discharge gap that results from the voltage and current shown in the two other plots of the figure against time.

FIG. 32 shows two pulse-trains being provided by the inverter. The first pulse-train starts at about 9.00 ms. The pulse-train is provided (as is typical of examples according to an aspect disclosed herein) in the form of a square V_{fb} waveform excitation. The initiation of the pulse-train causes charging in the resonant tank as can be seen by the ramping up of the amplitude in the inverter terminal current and the discharge gap voltage.

Once the resonant tank has charged to the threshold voltage, a discharge ignition event occurs at the discharge gap. This threshold in the example shown in FIG. 32 is about 10 kV.

The excitation is stopped shortly after this depending on the maximum number of discharge ignition events wanted. In the example shown in FIG. 32, this number is between one and three discharge ignition events. The time the excitation is stopped can be seen most clearly from the inverter terminal current plot. This shows a sudden drop in current amplitude from about 800 A during the discharge ignition event(s) to about 200 A at the maximum peak of the next cycle. This occurs at about time 9.02 ms, with the charging to the threshold voltage taking until about time 9.01 ms.

As can be seen from the inverter terminal voltage and current plots, the next pulse-train then starts at about time 9.11 ms. However, the voltage at the inverter terminals and the discharge gap can be seen in FIG. 32 as continuing to oscillate. Indeed, the amplitude of the voltage at the discharge gap is only reduced to about half the amplitude of the discharge threshold, so about 5 kV. However, this diminishes by about 1 to 2 KV in the period between the end of the excitation of the first pulse-train and the beginning of the next pulse-train.

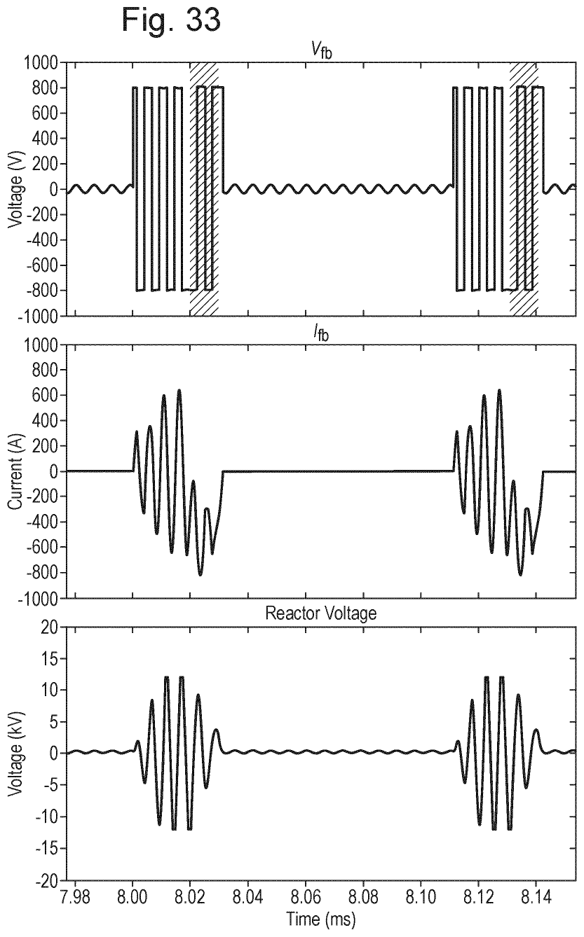

Turning to FIG. 33, this shows the same three plots as in FIG. 32 of inverter terminal voltage, inverter terminal current and discharge gap voltage against time. In the example shown in FIG. 33, it can be seen from the inverter terminal plot that a pulse-train starts at time 8.00 ms. As can be seen from the inverter terminal current and discharge gap plots, the resonant tank is charged from this time to about time 8.01 ms. At about this time the discharge threshold is reached and a discharge ignition event occurs.

After the maximum number of discharge ignition events has occurred, which in the example of FIG. 33 is again between one and three discharge ignition events, the excitation is stopped. This occurs at about time 8.02 ms. At this point a phase shift of 180° is applied to the inverter terminal voltage for a period of about 0.01 ms until about time 8.03 ms. This drives the energy in the charged resonant tank out of the resonant tank. As noted above, in various examples, this energy is then stored. The driving of the energy out of the resonant tank can also be seen from the inverter terminal current plot, which instead of showing a current with a sinusoidal wave (of varying amplitude) centred on 0 A, the current wave shifts negative until the end of the voltage phase shift period.

Due to this active energy recovery when using an air-core transformer, it can be seen in FIG. 33 that the ringing between the end of the phase shift period at about time 8.03 ms and the beginning of the next pulse train at about time 8.11 ms is reduced. This reduction is to an amplitude of about 1 kV at the discharge gap and to about 50 V at the inverter terminals.

1. A dielectric barrier discharge device for removing constituents of a gas, comprising:
a first electrode and a second electrode with a dielectric barrier therebetween, an electric field being establishable between the first and second electrodes in use; and
a gas flow path passing between the first and second electrodes, at least one of the electrodes having one or more discharge nodes positioned along the gas flow path, each location along the gas flow path at which at least one discharge node is positioned being an ionization region and having an adjacent recombination region downstream of the respective ionization region.

2. The dielectric barrier discharge device according to claim 1, wherein each discharge node is at least one projection from the respective electrode with at least a component orientated towards the other electrode.

3. The dielectric barrier discharge device according to claim 2, wherein the at least one projection is a plurality of projections from the respective electrode, each projection of each discharge node having at least a component orientated towards the other electrode.

4. The dielectric barrier discharge device according to claim 1, wherein the one or more discharge nodes is a plurality of discharge nodes positioned along the gas flow path.

5. (canceled)

6. The dielectric barrier discharge device according to claim 2, wherein the first electrode and a proximal side of a dielectric barrier are separated by a first distance and the second electrode is abutting a distal side of the dielectric barrier to the first electrode, and each projection has a height of between 10% and 50% of the first distance.

7. The dielectric barrier discharge device according to claim 2, wherein each discharge node is a structure for electric field intensification for use in a dielectric barrier discharge device.

8. The dielectric barrier discharge device according to claim 7, wherein the structure comprises: a ring including at least one tip, the tip extending along a first radial axis passing through the center of the ring, wherein in use, the ring is arranged around a first electrode of a discharge device, there being a gap between the structure and an opposing electrode of the discharge device, the at least one tip limiting a minimum gap between the structure and the opposing electrode, thereby increasing a probability of an electric breakdown occurring at the tip when an electric field is applied between the first electrode and the opposing electrode.

9. The dielectric barrier discharge device according to claim 1, wherein the first electrode and second electrode are arranged concentrically with parallel longitudinal axes, the second electrode being located at least partially around the first electrode.

10. The dielectric barrier discharge device according to claim 9, wherein the dielectric barrier is arranged concentrically with the first and second electrode and has a longitudinal axis parallel to the longitudinal axes of the first electrode and second electrode, the second electrode being mounted on a distal side of the dielectric barrier to the first electrode and at least partially encircles the dielectric barrier around its circumference.

11. The dielectric barrier discharge device according to claim 10, the second electrode is a foil.

12-13. (canceled)

14. The dielectric barrier discharge device according to claim 9, wherein the first electrode is held apart from the second electrode and dielectric barrier by connectors, the connectors providing an insulated connection to the dielectric barrier and second electrode, the connectors being located at opposing ends of the dielectric barrier and the gas flow path passing through the connectors.

15. The dielectric barrier discharge device according to claim 14, wherein a join between the first electrode and at least one connector is provided by a spring.

16. The dielectric barrier discharge device according to claim 8, wherein the first electrode is arranged, in use, to be a cathode, and the second electrode is arranged to be an anode.

17. The dielectric barrier discharge device according to claim 1, wherein the device is arranged in use to operate at a temperature between 160 degrees centigrade (° C.) and 500° C.

18. The dielectric barrier discharge device according to claim 1, further comprising a drive circuit, the drive circuit comprising:
a power supply connected to the first electrode and second electrode thereby across a dielectric discharge gap, the dielectric discharge gap providing a capacitance; and
an inductance between the power supply and the dielectric discharge gap thereby establishing a resonant tank in use, wherein
power is provided in use to the tank in pulse-trains and only during a pulse-train, a pulse frequency of each pulse-train being tuneable in use to a resonant frequency of the tank, power provided by each pulse-train charging and maintaining the tank to a threshold at which discharge ignition occurs, discharge ignition events per pulse-train being limited to a maximum number based on the drive circuit being arranged in use to prohibit each pulse-train transferring power to the resonant tank after the maximum number has occurred.

19. The dielectric barrier discharge device according to claim 18, wherein the maximum number of discharge ignition events is between 1 and 5 events.

20. (canceled)

21. The dielectric barrier discharge device according to claim 18, wherein the drive circuit further comprises a power storage device connected across the power supply and arranged in use to accept and store power discharge from the tank after each pulse-train, and wherein the drive circuit is arranged in use to shift the phase of the pulse-train by 180 degrees (°) after the maximum number of discharge ignition events has occurred.

22-40. (canceled)

41. A system for providing dielectric barrier discharge, wherein the system comprises:
a plurality of dielectric barrier discharge devices according to claim 18; and
a controller connected to each drive circuit, the controller being arranged in use to adjust the power supplied to the tank of each drive circuit based on input provided to the controller.

42-48. (canceled)

49. A method of controlling discharge in a dielectric discharge device according to claim 1, the method comprising:
providing power to a resonant tank with a series of electrical pulse-trains, the pulse frequency of each pulse-train being tuned to a resonance frequency of the tank, the resonant tank being connected across a gap between electrodes in a dielectric discharge device, a capacitance of the tank being provided by the dielectric discharge device, power provided by each pulse-train charging and maintaining the tank to a threshold at which discharge ignition occurs; providing a maximum number of discharge ignition events per pulse-train by prohibiting each pulse-train transferring power to the resonant tank after the maximum number of discharge ignition events has occurred; and
prohibiting power transfer to the tank between pulse-trains.

50-58. (canceled)

59. A method of removing constituents of a gas, the method comprising:
passing a gas with up to 10,000 ppmv of methane along a gas flow path between a first electrode and a second electrode, wherein the first electrode and the second electrode have a dielectric barrier therebetween;
establishing an electric field between the first and second electrodes, at least one of the electrodes having one or more discharge nodes positioned along the gas flow path, each location along the gas flow path at which at least one discharge node is positioned being an ionization region and having an adjacent recombination region downstream of the respective ionization region.

60-61. (canceled)
